(19) United States
(12) Patent Application Publication
(10) Pub. No.: US 2017/0205669 A1
(43) Pub. Date: Jul. 20, 2017

(54) IMAGE DISPLAY DEVICE AND ORIENTED MATERIAL USED IN SAME

(71) Applicant: DIC Corporation, Tokyo (JP)

(72) Inventors: Yoshiyuki Ono, Kita-adachi-gun (JP); Kunihiko Kotani, Kita-adachi-gun (JP); Kazunori Maruyama, Kita-adachi-gun (JP); Hiroshi Hasebe, Kita-adachi-gun (JP); Masanao Takashima, Kita-adachi-gun (JP); Shirou Taniguchi, Kita-adachi-gun (JP); Fumiaki Kodera, Kita-adachi-gun (JP)

(73) Assignee: DIC Corporation, Tokyo (JP)

(21) Appl. No.: 15/313,859

(22) PCT Filed: May 21, 2015
(86) PCT No.: PCT/JP2015/064579

§ 371 Date: Nov. 23, 2016

(30) Foreign Application Priority Data
May 23, 2014 (JP) 2014-107095
Feb. 2, 2015 (JP) 2015-018483

(51) Int. Cl. G02F 1/1337; G02F 1/1333; G02F 1/1368; G02F 1/1335

(52) U.S. Cl. CPC G02F 1/133788; G02F 1/133528; G02F 1/133514; G02F 1/133345; G02F 1/1368; G02F 2202/023; G02F 2201/123; G02F 2201/121; G02F 2001/133738; G02F 2201/124

(57) ABSTRACT

The present inventors have made earnest investigations for enhancing the alignment regulation force of the alignment film, and as a result, it has been found that the alignment regulation force can be easily achieved by controlling the yellowness index (YI) of the alignment film to a certain value or more, and thus has been found that the problems can be solved by the following invention. An image display device containing an image display part containing a liquid crystal layer containing a liquid crystal compound regulating a phase or a velocity of transmitted light, and in contact with the liquid crystal layer, a photo alignment layer regulating alignment of liquid crystal molecules contained in the liquid crystal compound, the alignment layer having a yellowness index (YI) of 0.001<YI<100.

### TECHNICAL FIELD

The present invention relates to an image display device and an aligned material used in the same.

### BACKGROUND ART

Image display devices for displaying a two-dimensional image or a three-dimensional image include various devices including a liquid crystal display device and an inorganic or organic EL (electroluminescent) device. The alignment treatment for aligning molecules of an optical material, for example, a retardation film used in an image display device, such as a liquid crystal display device and an EL device, and a liquid crystal material used in a liquid crystal display device, is generally classified roughly into a rubbing method, in which a polymer film, such as a polyimide, is formed on a surface of a substrate, such as glass, and then rubbed in one direction with a cloth or the like, and a photo-alignment method, in which a coated film provided on a substrate is irradiated with light having anisotropy to create a liquid crystal alignment function. The former rubbing method has a problem that an alignment defect occurs due to a flaw or a dust formed on the surface of the aligned film in the production process, and a problem that associated with the increase of the size of the substrate, the rubbing device for providing homogeneous alignment over the entire substrate for a prolonged period of time becomes difficult to design and manage.

In the latter photo-alignment method, on the other hand, the molecules are reacted selectively in the alignment direction by irradiating the aligned film with light (such as a polarized ultraviolet ray), so as to create anisotropy, and thereby an alignment function is exhibited for the molecules, and therefore, the method has advantages that the problems in the rubbing method, i.e., the alignment defect due to a flaw or a dust and the homogeneous alignment provided over the entire substrate for a prolonged period of time, can be solved, and thus is being actively developed.

However, a polyimide aligned film that is currently used often in the photo-aligned film and a rubbing aligned film is generally constituted by an aromatic monomer, and is good in heat resistance, alignment characteristics, and the like. However, as described in PTL 1, the property of coloration in brownish yellow to brown inherent to polyimide provides a problem that the liquid crystal display itself is colored yellow. Accordingly, there is the coloration problem remaining in the case where the aforementioned aligned film is utilized for the alignment of molecules constituting a retardation film, a lenticular lens, and the like.

In a liquid crystal display device displaying not only a two-dimensional image but also a three-dimensional image, a higher definition image is generally demanded, but in a stereoscopic display device displaying a three-dimensional image, the degree of definition is decreased by half due to the necessity of displaying both an image for the left eye and an image for the right eye. Therefore, for enhancing the degree of definition, the pixel size is necessarily decreased more than the case of the two-dimensional display device. For example, PTL 2 proposes an alignment control structure provided on a pixel electrode for achieving a high definition image by a liquid crystal display device.

The image display devices displaying a three-dimensional image are roughly classified into a system using so-called dedicated glasses, in which a pattern retarder providing different phase states is provided at positions corresponding to the left eye image and the right eye image of an image display device (such as a liquid crystal display device and an organic EL device), thereby displaying the left eye image and the right eye image separately, for example, into right circular polarization and left circular polarization, respectively, and the images are viewed with the dedicated glasses for recognizing the stereoscopic image, and a system using no dedicated glasses, which is represented by a lenticular lens system, and a parallax barrier system, and the like. In these systems, plural images with a parallax therebetween are simultaneously displayed, and the viewed images are differentiated by the relative positional relationship (angle) of the display device and the view location of the observer.

Examples of the technique relating to the former pattern retarder include PTL 3. According to PTL 3, against the problem of occurrence of crosstalk, in which the left and right images are mixed into each other since the pattern retarder is changed in dimension due to the increase of the temperature, humidity or the like, and the patterns for the left and right eyes of the pattern retarder do not correspond to the patterns of the liquid crystal display device, PTL 3 proposes the particular protective layer and adhesive layer provided for suppressing the dimensional change of the pattern retarder.

Examples of the technique relating to the latter lenticular lens include PTL 4. According to PTL 4, there is a problem that the optimum operation state is deviated due to the change of the focusing angle caused by change of the refractive index by temperature, and PTL 4 proposes the production of the lenticular lens with a liquid crystal polymer for avoiding the problem.

### CITATION LIST

### Patent Literatures

PTL 1: JP-A-2010-101999

PTL 2: WO 2011-129177

PTL 3: JP-A-2012-123040

PTL 4: JP-A-2004-538529

### SUMMARY OF INVENTION

### Technical Problem

As represented by PTL 1, it has been proposed that an aligned film material having a small yellowness index is used to increase the light transmittance and to decrease the color change, but there is a problem remaining that the molecules cannot be aligned in the particular direction due to the low alignment regulation force. Furthermore, there is another new problem that not only the aligned film of the liquid crystal display device, but also the liquid crystal layer thereof continuously receive light from the outside, and are deteriorated by an ultraviolet ray and the like with the lapse of time, and thereby the alignment regulation force aligning the liquid crystal molecules and the liquid crystal characteristics are deteriorated. When the pixel size is decreased as in PTL 2, there is a problem that the fiber width of the cloth used in the rubbing method becomes larger than the size of one pixel, thereby failing to perform rubbing properly.

Furthermore, the characteristics of the device using a polymerizable liquid crystal compound having been aligned, such as a retardation film and a lenticular lens, directly depend on the alignment degree and the homogeneity of alignment, which also largely influences the characteristics of the device, such as the blur, resolution, coloration and the like of the three-dimensional image. This point is common irrespective of the kind of display devices, such as a liquid crystal display device and an EL display device.

In an image (liquid crystal or EL) display device displaying a three-dimensional image, the dedicated glasses are annoying for the observer, and a system that does not require the dedicated glasses is demanded. However, irrespective of the necessity of the dedicated glasses, the inventions described in PTLs 3 and 4 are the device combining the pattern retarder of the optical device or the device combining the liquid crystal display device and the lenticular lens of the optical device, and there is a description that the quality of the stereoscopic image can be enhanced by increasing the definition of the devices. However, the proposals of improvement of the definition having been made are not still insufficient. Specifically, the three-dimensional image display device displays the left eye image and the right eye image having a parallax therebetween (different in view location), and the observer views the images with the left and right eyes respectively to recognize the stereoscopic image with depth. There is a display device developed that is capable of providing a more natural stereoscopic image for the observer by displaying three or more images with a parallax among them. In this case, not only the alignment disorder of the liquid crystal in the liquid crystal device becomes a large failure in providing the natural stereoscopic image, but also in the pattern retarder, there are problems including the decrease of the polarization degree of the circular polarization for the left eye and the right eye different in alignment direction, the crosstalk due to the disorder of the alignment of the liquid crystal in the boundary region of the retarder adjacent to each other, and the like, and in the lenticular lens, there are problems that the alignment degree in the vicinity of the alignment layer in the lens and the alignment disorder of the liquid crystal in the region apart from the alignment layer create a deviation of the focusing direction of the light passing through the lens, thereby deteriorating the image quality of the natural stereoscopic image and the definition of the image.

The compensation film used for the compensation of the viewing angle and the retardation film for the pattern retarder or the like often have a thickness of from 0.1 μm to several micrometers, and the thickness of the lenticular lens from the flat surface to the apex is often from 1 to several hundred micrometers, which is currently from 10 to 100 mu, depending on the definition of the liquid crystal display device used. In the case where the lenticular lens is produced with a liquid crystal material, the alignment direction is controlled with an (photo) alignment layer, or a physical shape, such as a frame, instead. Due to the influence of the relatively large film thickness of the lenticular lens, the disorder on the surface of the alignment layer or the like, by which the alignment direction is controlled, is enhanced by the film thickness. The disorder of the alignment direction creates the disorder of the refractive index of the lenticular lens, and the direction of the refracted light passing through the lens is deviated to deteriorate the stereoscopic view function. Accordingly, for providing a lenticular lens for naked eye stereoscopic view having a highly homogeneous alignment state, it is necessary to control the alignment direction of the liquid crystal molecules in the alignment layer with high accuracy, and therefor it is important to enhance the alignment regulation force of the alignment layer.

The alignment defect in the compensation film, the influence of the width of the alignment disorder occurring in the boundary region of the pattern retarder, the influence of the alignment disorder due to the thickness of the lenticular lens, and the like are the problems that become conspicuous associated with the enhancement in function and the enhancement in definition demanded for the liquid crystal display device in recent years.

The definition of the liquid crystal display device can be enhanced by decreasing the pixel size, but unless the definition of the pattern retarder and the lenticular lens is sufficiently high coupled with the pixel size, a sufficient contrast cannot be obtained to fail to exhibit the designed definition. The contrast is influenced by the alignment disorder and the light leakage due to defects. In the case where the alignment layer having a sufficiently large alignment regulation force is used, the contrast can be increased to enhance the definition.

The contrast of the pattern retarder is influenced not only by the light leakage due to the alignment disorder in the retarder portion for the right eye and the retarder portion for the left eye, but also by the light leakage from the region with alignment disorder occurring in the vicinity of the boundary region between the portions, and in the case where the alignment layer having a sufficiently large alignment regulation force is used, the contrast can be increased to enhance the definition.

In the case of the lenticular lens, the alignment disorder creates a deviation of the focusing angle of the lens and influences the contrast, as similar to the pattern retarder. In the case where the alignment layer having a sufficiently large alignment regulation force is used, the distribution of the focusing angle is decreased, and consequently the contrast can be increased to enhance the definition.

The pattern retarder herein means a retardation film having regions of the retardation layer different in retardation axis that are disposed on the surface with a certain regularity, and the regions are generally disposed alternately in a stripe shape corresponding to the pixels of the display device, such as the liquid crystal or EL device. For example, two regions having retardation axes different in direction are disposed corresponding to the odd number lines and the even number lines of the pixels of the liquid crystal display device at the positions, through which the light passing through the pixels passes. The retardation layers for the odd number lines and the even number lines are different in optical axis, and it is assumed herein that the phase of the incident light is retarded by the ¼ wavelength and the −¼ wavelength, respectively. In this case, the light passing through the retardation layers is passed through the polarizing layer and then converted into two kinds of circularly polarized light different in direction, and the light of the image to be displayed in the odd number lines is converted to left circularly polarized light, whereas the light of the image to be displayed in the even number lines is converted to right circularly polarized light. By viewing the images with glasses having two filters passing only left circularly polarized light or right circularly polarized light, the three-dimensional image is displayed and recognized.

The invention has been made in view of the aforementioned problems, and an object thereof is to provide an image display device having a high definition image display part that is necessary for providing a high alignment regulation force and a high light durability, decreasing the alignment defect, and enhancing the quality of stereoscopic display.

For example, in one embodiment of the invention, a high definition liquid crystal display device that is necessary for providing a high alignment regulation force and a high light durability, decreasing the alignment defect, and enhancing the quality of stereoscopic display is provided.

In another embodiment of the invention, an object thereof is to provide, in a retardation film, a pattern retarder, and a lenticular lens, as an optical laminated material, a retardation film, such as a pattern retarder or the like, that is reduced in disorder of the liquid crystal alignment in the vicinity of the boundary region between the photo alignment layer and the optical anisotropy layer in the optical laminated material, or a refractive device, such as a lenticular lens for naked eye stereoscopic view or the like, that has a highly homogeneous alignment state, thereby achieving a high definition display device represented by a three-dimensional image display device. It is a further object thereof to provide a high definition image display device by reducing the disorder in alignment in a retardation film for an optical compensation film used for compensation of the viewing angle or the like.

In a still another aspect thereof, it is an object to provide a photoresponsive alignment agent having an enhanced alignment regulation force, which is required therefor.

### Solution to Problem

In view of the current situation, the present inventors have made earnest investigations for enhancing the alignment regulation force of the alignment layer used for aligning the liquid crystal molecules of the liquid crystal for driving a liquid crystal display device, which is an example of an image display device, and as a result, it has been found that the alignment regulation force can be easily achieved by controlling the yellowness index (YI) of the alignment film to a certain value or more, and thus has been found that the problems can be solved by the following invention.

In view of the current situation, the inventors have found that in the case where an alignment layer is used in a retardation film, such as a compensation film used for compensation of the viewing angle or the like, and a pattern retarder, or in a refractive device, such as a lenticular lens, what prevents the enhancement of the definition of the three-dimensional image display is the fact that the alignment regulation force of the alignment layer used in a liquid crystal display device, a retardation film, such as a pattern retarder, or a refractive device, such as a lenticular lens, is not sufficiently large.

Accordingly, there is provided an image display device containing an image display part containing a liquid crystal layer containing a liquid crystal compound which regulates a phase or a velocity of transmitted light, and a photo alignment layer which is in contact with the liquid crystal layer and regulates alignment of liquid crystal molecules contained in the liquid crystal compound, the alignment layer having a yellowness index (YI) of 0.001<YI<100.

In the image display device of the invention, there is provided a photoresponsive alignment agent (in a state where a photo alignment component is dissolved in a solvent) used in the alignment layer, the photoresponsive alignment agent having a yellowness index (YIS) of 0.001<YIS<500.

### Advantageous Effects of Invention

According to the image display device of the invention, by increasing the alignment regulation force of the alignment layer of a retardation film, such as a retardation film and a pattern retarder, or a refractive device, such as a lenticular lens for naked eye stereoscopic view, as an optical laminated material, the different alignment disorder in the retardation film, particularly the disorder of the liquid crystal alignment in the vicinity of the boundary region of the pattern of the pattern retarder, can be decreased, and the alignment disorder of the liquid crystal at the position apart from the alignment layer of the latter can be decreased.

According to the image display device of the invention, the disorder of the liquid crystal alignment in the high definition liquid crystal display device or in the vicinity of the boundary region between the regions different in alignment direction can be decreased.

According to the image display device of the invention, deterioration due to light with the lapse of time can be suppressed and prevented.

According to the image display device of the invention, the alignment defect, the alignment disorder, and the light leakage of the liquid crystal molecules driven by the external field can be decreased.

### BRIEF DESCRIPTION OF DRAWINGS

FIG. 1 is an illustration schematically showing a structure of an organic EL device as one example of the image display device.

FIG. 2 is an illustration schematically showing a structure of an organic EL device as one example of the image display device.

FIG. 3 is an illustration schematically showing a structure of an organic EL device as one example of the image display device.

FIG. 4 is an illustration schematically showing a structure of a liquid crystal display device as one example of the image display device.

FIG. 5 is an enlarged plan view of the region II of the electrode layer containing a thin film transistor formed on the substrate in FIG. 4.

FIG. 6 is a cross sectional view of the liquid crystal display device in FIG. 4 cut in the direction of the line III-III in FIG. 5.

FIG. 7 is an enlarged plan view of the region II of the electrode layer containing a thin film transistor formed on the substrate in FIG. 4 in another embodiment.

FIG. 8 is a cross sectional view of the liquid crystal display device cut in the direction of the line III-III in FIG. 7 in another embodiment.

FIG. 9 is an illustration schematically showing a structure of a liquid crystal display device as one example of the image display device.

FIG. 10 is an enlarged plan view of the region II of the electrode layer containing a thin film transistor formed on the substrate in FIG. 9.

FIG. 11 is a cross sectional view of the liquid crystal display device in FIG. 9 cut in the direction of the line III-III in FIG. 10.

FIG. 12 is an illustration schematically showing a structure of a liquid crystal display device as one example of the image display device.

FIG. 13 is a cross sectional view of the liquid crystal display device shown in FIG. 12 cut in the same manner as in FIG. 5.

FIG. 14 is an illustration schematically showing a structure of a liquid crystal display device as one example of the image display device.

FIG. 15 is an enlarged plan view of the region II of the electrode layer containing a thin film transistor formed on the substrate in FIG. 14.

FIG. 16 is a cross sectional view of the liquid crystal display device in FIG. 14 cut in the direction of the line III-III in FIG. 15.

FIG. 17 is an enlarged plan view of the region II of the electrode layer containing a thin film transistor formed on the substrate in FIG. 14 in another embodiment.

FIG. 18 is a cross sectional view of the liquid crystal display device cut in the direction of the line III-III in FIG. 17 in another embodiment.

FIG. 19 is an illustration schematically showing a structure of another liquid crystal display device of the invention.

FIG. 20 is an enlarged plan view of the region II of the electrode layer containing a thin film transistor formed on the substrate in FIG. 19.

FIG. 21 is a cross sectional view of the liquid crystal display device in FIG. 19 cut in the direction of the line III-III in FIG. 20.

### DESCRIPTION OF EMBODIMENTS

The image display device of the invention and the liquid crystal alignment agent used therein will be described in detail below.

The present application is based on Japanese Patent Application No. 2014-107095 filed on May 23, 2014 and Japanese Patent Application No. 2015-018483 filed on Feb. 2, 2015, the disclosures of which are incorporated herein by reference.

The first embodiment of the invention is an image display device containing an image display part containing a liquid crystal layer containing a liquid crystal compound which regulates a phase or a velocity of transmitted light and a photo alignment layer which regulates alignment of liquid crystal molecules contained in the liquid crystal compound and is in contact with the liquid crystal layer, the alignment layer having a yellowness index (YI) of 0.001<YI<100.

In the invention, by increasing the alignment regulation force of the photo alignment layer, the alignment disorder of the liquid crystal molecules in the liquid crystal compound, particularly the disorder of the liquid crystal alignment in the vicinity of the boundary region to the alignment layer, can be decreased, and the alignment disorder of the liquid crystal molecules at the position apart from the alignment layer can be decreased.

The image display part used in the image display device of the invention has a light transmission part transmitting light formed in a gap in an image display portion, and uses an electrooptical element exhibiting a luminance changed by application of voltage or the like, as an image display element, examples of which include a liquid crystal display element and an organic EL element. The image display part is a region where image information is displayed, and the thickness direction thereof is not limited.

The image display device of the invention is one example of an electronic equipment, and can be used as a monitor device constituting a personal computer, a monitor device of a notebook type personal computer, a monitor device of a portable telephone, such as a smartphone, a portable information terminal, or a gaming machine, and a television receiver.

In a preferred embodiment of the image display device of the invention, the image display device has an optical laminated material which is light transmissive and is provided in an image display part, the optical laminated material contains an optical anisotropy layer containing at least one of the optical anisotropy molecule regulating a phase or a velocity of light passing through the optical laminated material, and the polymer liquid crystal, and in contact with the optical anisotropy layer, the photo alignment layer aligning the optical anisotropy molecule, and the optical anisotropy layer and the alignment layer each have a yellowness index (YI) of 0.001<YI<100.

The optical laminated material functions as a retardation film or a pattern retarder, or a refractive device, such as a lenticular lens, and thereby such an image display device can be provided that the disorder of the alignment of the optical anisotropy layer in the vicinity of the boundary region between the optical anisotropy layer and the photo alignment layer is reduced. In the liquid crystal display device of the invention, the enhancement of the alignment regulation force of the (photo) alignment layer reduces the alignment defect of the optical anisotropy layer (for example, a polymerizable liquid crystal), and reduces the light leakage, thereby enhancing the contrast. The photo alignment layer according to the invention has a yellowness index within the certain range, and thus absorbs bluish violet light having relatively high energy but transmits yellow or red and green mixed light having relatively low energy, and thereby an image display device excellent in light resistance can be provided.

In the image display device of the invention, when the photoresponsive alignment agent (in a state where a photo alignment component is dissolved in a solvent) used in the photo alignment layer has a yellowness index (YIS) of 0.001<YIS<500, the alignment regulation force of the alignment layer can be enhanced, and when the retardation film or the pattern retarder, or the refractive device, such as the lenticular lens, after forming as the alignment layer has a yellowness index in a state where the alignment layer is formed on the substrate (i.e., the yellowness index (YI) obtained from the yellowness index (YIL) of the substrate and the alignment layer according to the method described later) of 0.001<YI<100, the total characteristics of the device can be enhanced.

The “alignment regulation force” in the description herein means a force of a photo alignment layer for aligning liquid crystal molecules in a given direction at the interface between the alignment layer and the liquid crystal layer. A larger alignment regulation force provides a larger force of aligning the liquid crystal molecules, and has a larger effect of suppressing the alignment disorder of the liquid crystal molecules due to thermal vibration or an external force. The potential energy of the alignment regulation force is referred to as anchoring energy, and the anchoring energy is directly used as the evaluation value of the alignment regulation force. The anchoring energy can be further divided into “azimuthal anchoring energy” and “polar anchoring energy”. The “azimuthal anchoring energy” may be a parameter of the force resisting against the force twisting the liquid crystal within the plane of the substrate, and the “polar anchoring energy” may be a parameter of the force resisting against the force raising the liquid crystal from the plane of the substrate.

For example, the “alignment regulation force” in the case where the optical anisotropy layer is a liquid crystal layer means a force of the alignment layer for aligning the optical anisotropy molecule in a given direction at the interface between the alignment layer and the optical anisotropy layer. A larger alignment regulation force provides a larger force of aligning the optical anisotropy molecule, and has a larger effect of suppressing the alignment disorder of the optical anisotropy molecule due to thermal vibration or an external force. The “azimuthal anchoring energy” may be a parameter of the force resisting against the force twisting the optical anisotropy molecule within the plane of the substrate, and the “polar anchoring energy” may be a parameter of the force resisting against the force raising the optical anisotropy molecule from the plane of the substrate.

Preferred embodiments of the image display device of the invention will be described below.

In a preferred embodiment of the image display device of the invention, the image display part of the image display device has an optical laminated material laminated directly or indirectly thereon, and may have a polarizing plate depending on necessity. The optical laminated material may be provided between the polarizing plate and the image display part, and the polarizing plate may be provided on the side of the image display part with respect to the optical laminated material.

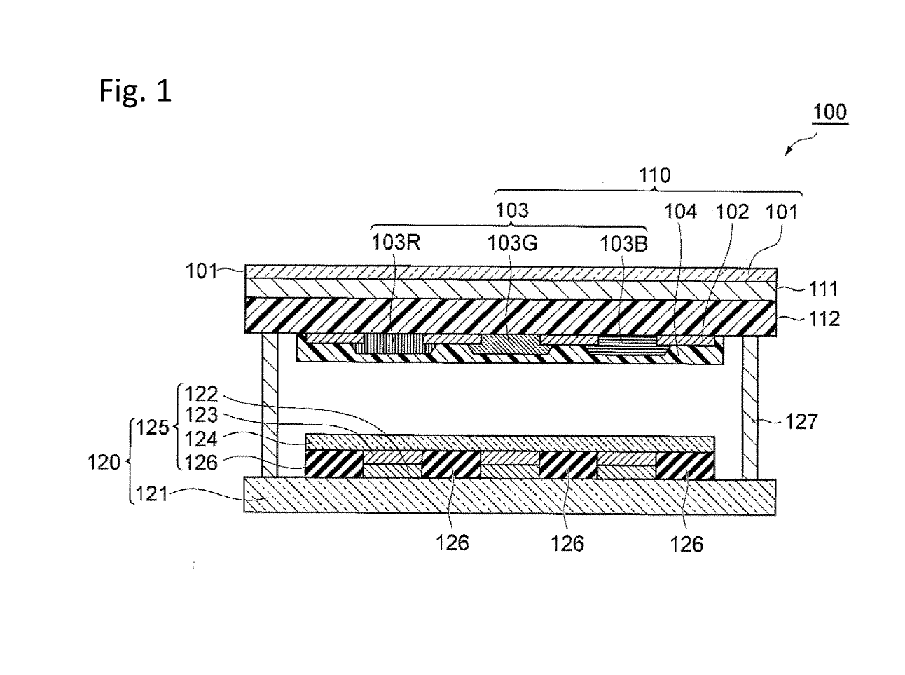

As one embodiment of the image display device of the invention, an embodiment using an organic EL display device will be described with reference to FIGS. 1 to 3. FIG. 1 is a schematic cross sectional view showing one example of the organic EL display device. As shown in FIG. 1, the organic EL display device 100 has a substrate 120 on the organic EL device side having a substrate 121 and an organic EL device 125 containing a white light emitting layer, formed on the substrate 121, a color filter 110 for an organic EL display device having a transparent substrate 101, a light shielding part 102 having an opening, formed on the transparent substrate 101, and a colored layer 103 containing a red colored layer 103R, a green colored layer 103G, and a blue colored layer 103B, formed on the opening, and a sealing agent 127 sealing the organic EL device 125, formed on the peripheral portions of the color filter 110 and the substrate 120 on the organic EL device side. The organic EL device 125 has a back electrode layer 122, an organic EL layer 123 containing a white light emitting layer, and a transparent electrode layer 124, and the substrate 120 on the organic EL device side has an insulating layer 126 formed on an opening of the back electrode layer 122. For reducing the defect formed in the production process, an overcoating layer 104 formed of a resin may be provided to cover the colored layer. An optical laminated material 112 according to the invention and a polarizing plate 111 are provided on the side of the transparent substrate 101 as the surface of the image display part. More specifically, the optical laminated material 112 is formed directly or indirectly on the transparent substrate 101 as the surface of the image display part. The optical laminated material 112 contains an alignment layer (which is not shown in the figure) and an optical anisotropy layer (which is not shown in the figure) in direct contact with the alignment layer, and in FIG. 1, the polarizing plate 111 and the optical anisotropy layer 112 are laminated in this order on the surface of the transparent substrate 101 on the side of the substrate 121. The optical laminated material of the invention contains the optical anisotropy layer and the photo alignment layer as the essential components, may have a substrate depending on necessity, and may contain a known pressure sensitive adhesive layer or adhesive layer for fixing or adhering the substrate to the image display part. The order of lamination of the photo alignment layer and the optical anisotropy layer in the optical laminated material 112 is not limited, and the photo alignment layer may be provided on the side of the substrate 121 or on the side of the substrate 101.

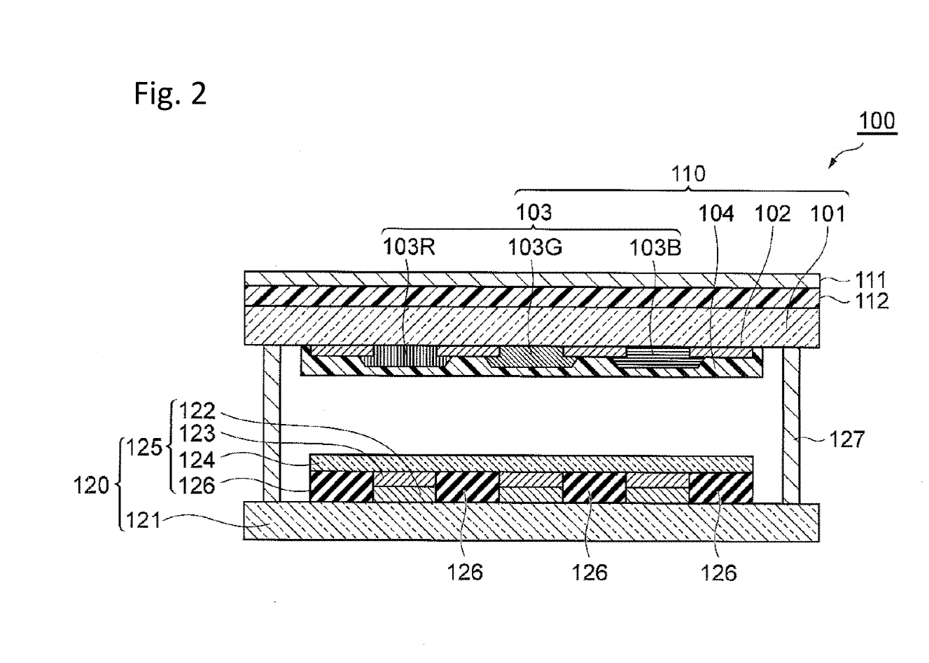

FIG. 2 is a schematic cross sectional view showing another example of the organic EL display device. In FIG. 2, the optical laminated material 112 is formed directly on the transparent substrate 101, instead of FIG. 1, in which the optical laminated material 112 and the polarizing plate 111 are provided on the side of the transparent substrate 101 as the surface of the image display part. The other structures are the same as in FIG. 1, and the description therefor is omitted herein. In FIG. 2, the optical laminated material 112 may be formed in such a manner that the photo alignment layer thereof is in contact with the transparent substrate 101, or may be formed in such a manner that the optical anisotropy layer of the optical laminated material 112 is in contact with the transparent substrate 101. As an embodiment, in which the optical laminated material 112 is provided indirectly on the transparent substrate 101, other than FIG. 1, the optical laminated material of the invention may be formed on a substrate in advance, and then the substrate having the optical laminated material formed thereon and the transparent substrate 101 may be adhered to each other with an adhesive layer or a pressure sensitive adhesive layer. More specifically, such a procedure may be performed that the photo alignment layer is formed on a substrate other than the transparent substrate 101, then the optical anisotropy layer is formed on the photo alignment layer, and the layers are transferred to the transparent substrate 101 to make the optical anisotropy layer in contact with the transparent substrate 101 (direct formation), and such a procedure may be performed that a substrate other than the transparent substrate, having the optical laminated material 112 (including (the other substrate), the alignment layer and the optical anisotropy layer) formed thereon is made in direct contact with the transparent substrate 101 (indirect formation with the other substrate remaining). Furthermore, for adhering the optical laminated material 112 and the transparent substrate 101 or for adhering the transparent substrate and the other substrate, an adhesive layer or the pressure sensitive adhesive layer may be provided therebetween.

In the image display device of the invention, a polarizing plate 111 may be further provided, and specifically may be provided as a part of the optical laminated material or may be provided separately. For example, as shown in FIG. 2, in the case where the polarizing plate is provided on the outermost side with respect to the image display part, i.e., the case where the optical laminated material is provided between the polarizing plate 111 and the image display part, the optical laminated material functions as a retardation film.

In the case where the optical laminated material 112 is a lenticular lens or a pattern retarder, the polarizing plate 111 (which may also be referred to as a polarizing layer) is provided on the side of the image display part with respect to the optical laminated material 112, i.e., the polarizing plate is provided between the optical laminated material and the image display part. In this case, the optical anisotropy layer is preferably provided at the outermost side with respect to the image display part. Specifically, in FIG. 2, such an embodiment is preferred that the polarizing plate 111 is formed on the transparent substrate 101, and the optical laminated material 112 is formed thereon.

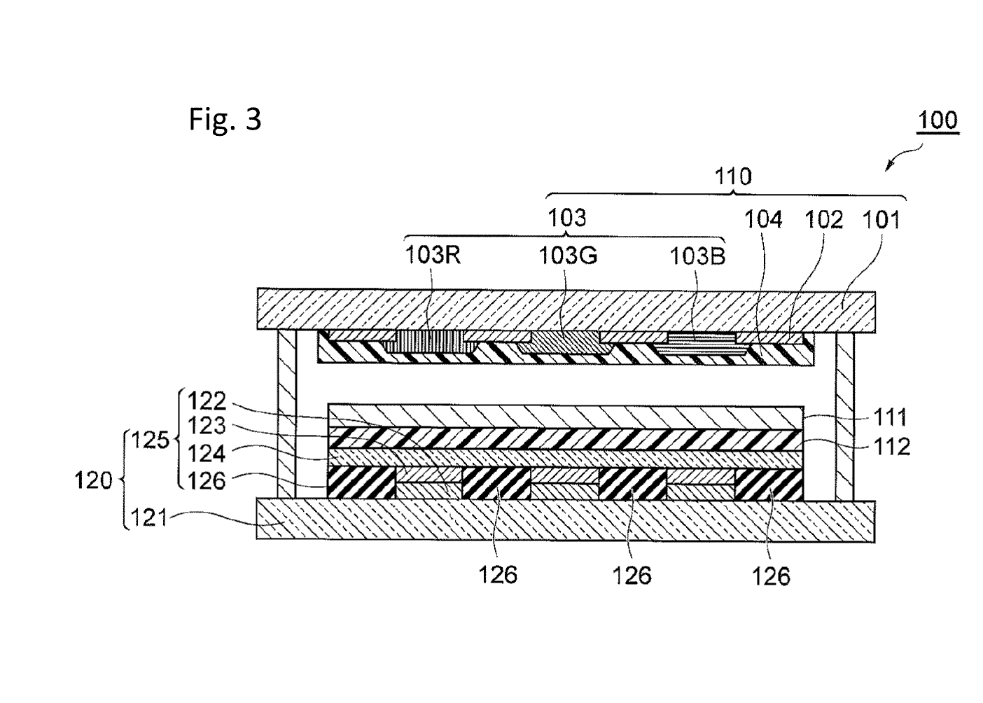

FIG. 3 is a schematic cross sectional view showing still another example of the organic EL display device. In FIG. 3, the optical laminated material 112 and the polarizing plate 111 are laminated in this order on a transparent electrode layer 124, instead of FIG. 1, in which the optical laminated material 112 and the polarizing plate 111 are provided on the side of the transparent substrate 101 as the surface of the image display part. The other structures are the same as in FIG. 1, and the description therefor is omitted herein.

The substrates 101 and 121 in the invention each are preferably a transparent substrate having high light transmissibility in the case where the substrates are used on the light emitting side. Examples thereof include transparent substrates formed of a material having high light transmissibility, such as glass, quartz, and various resins. The thickness of the substrate is generally from 0.01 to 10.0 mm. The light shielding part may be, for example, one having openings having the same shape disposed patternwise at regular intervals. The pattern shape of the light shielding part is not particularly limited, and examples thereof include a stripe shape and a matrix shape. The formation method of the light shielding part is not particularly limited as far as the light shielding part can be patterned, and the known methods may be used. For example, the light shielding part may be formed by a photolithography method using a black dispersion liquid containing a black colorant material and a curable resin composition.

The colored layer is formed in the opening of the light shielding part. The colored layer includes colored layers of each colors, and for example contains a blue colored layer, a green colored layer, and a red colored layer. In the invention, at least one of the blue colored layer, the green colored layer, and the red colored layer may contain a dye and/or an organic pigment, and preferably the blue colored layer contains a dye and/or an organic pigment. The colored layer contains a dye and/or an organic pigment. The colored layers may be formed of resin compositions for a colored layer containing known dyes and/or organic pigments of each colors. The content (total amount) of the dye and/or the pigment is preferably from 0.1 to 20% by mass based on the total amount of the resin composition for a colored layer.

The colored layer preferably contains at least one dye selected from the group consisting of a triarylmethane dye, a methine dye, an anthraquinone dye, an azo dye, a metal-containing azo dye, and a phthalocyanine dye.

Examples of the organic pigment in the invention include a phthalocyanine series, an insoluble azo series, an azo lake series, an anthraquinone series, a quinacridone series, a dioxazine series, a diketopyrrolopyrrole series, an anthrapyrimidine series, an anthanthrone series, an indanthrone series, a flavanthrone series, a perynone series, a perylene series, a thioindigo series, a triarylmethane series, an isoindolinone series, an isonidoline series, a metal complex series, a quinophthalone series, and a dye lake series.

The colored layer preferably contains a lake pigment based on at least one dye selected from the group consisting of a triarylmethane dye, a methine dye, an anthraquinone dye, an azo dye, a metal-containing azo dye, and a phthalocyanine dye. The species of the pigments may be appropriately selected corresponding to the wavelength to be transmitted.

An inorganic protective film may be further formed on the colored layer depending on necessity, for preventing the volatile gas components (such as water vapor) formed from the colored layer, from being leaked to the outside in the production process of the display device. For the purpose, the inorganic protective film is demanded to have a gas barrier property. The inorganic protective film may have a water vapor transmittance of 30 g/(m³·day) or less, preferably from 0 to 25 g/(m³·day), and more preferably from 0 to 20 g/(m³·day).

The production method of the organic EL light emitting material is not particularly limited, and may be performed according to the following preferred embodiment. Specifically, on a substrate, a reflective anode, a hole injection layer, a hole transporting layer, a light emitting layer, an electron transporting layer, and an electron injection layer are patterned in this order to form a blue light emitting layer, and then a translucent cathode and a protective film are formed solidly in this order, thereby producing an organic EL light emitting material emitting blue light.

The substrate used may be an alkali-free glass substrate having TFT as a switching device, and the thickness of the alkali-free glass substrate is preferably from 0.5 to 1.1 mm. The reflective anode used may be a reflective anode having a laminated structure of ITO/Ag/ITO, and preferably has thicknesses of the layers of the laminated structure each of from 10 to 150 nm, and the thickness of the reflective electrode is preferably from 50 to 300 nm. The hole injection layer used may be a hole injection layer formed of a co-vapor-deposited film of bis(N-(1-naphthyl-N-phenyl)benzidine) (α-NPD) and MoO₃ (volume concentration of MoO₃: 20%), and the thickness of the hole injection layer is preferably from 10 to 400 nm. The hole transporting layer used may be a hole transporting layer formed of α-NPD, and the thickness of the hole transporting layer is preferably from 5 to 200 nm. The light emitting layer used is preferably a light emitting layer containing 9,10-di-2-naphthylanthracene (DNA) as a host material and 1-tert-butylperylene (TBP) as a guest material, the thickness of the light emitting layer is preferably from 20 to 60 nm, and the mixing ratio of the host material and the guest material is preferably controlled to from 10/1 to 100/1. The electron transporting layer used may be an electron transporting layer formed of tris(8-quinolinolato) aluminum complex (Alq3), and the thickness of the electron transporting layer is preferably from 5 to 200 nm. The electron injection layer used may be an electron injection layer formed of LiF, and the thickness of the electron injection layer is preferably from 0.1 to 1 nm. The translucent cathode used may be a translucent cathode formed of MgAg, and the thickness of the translucent cathode is preferably from 1 to 100 nm. The protective layer used may be a protective layer formed of SiON, and the thickness of the protective layer is preferably from 50 to 400 nm.

In the case where the image display device of the invention is used as a 2D retardation device, the ultraviolet ray resistance of the display device is enhanced by the ultraviolet ray absorbability of the alignment layer. In the case where the image display device is used as a 3D device, a high 3D effect is exhibited by suppressing the deviation of the focusing angle or the alignment disorder in the boundary region of the pattern retarder, and the like.

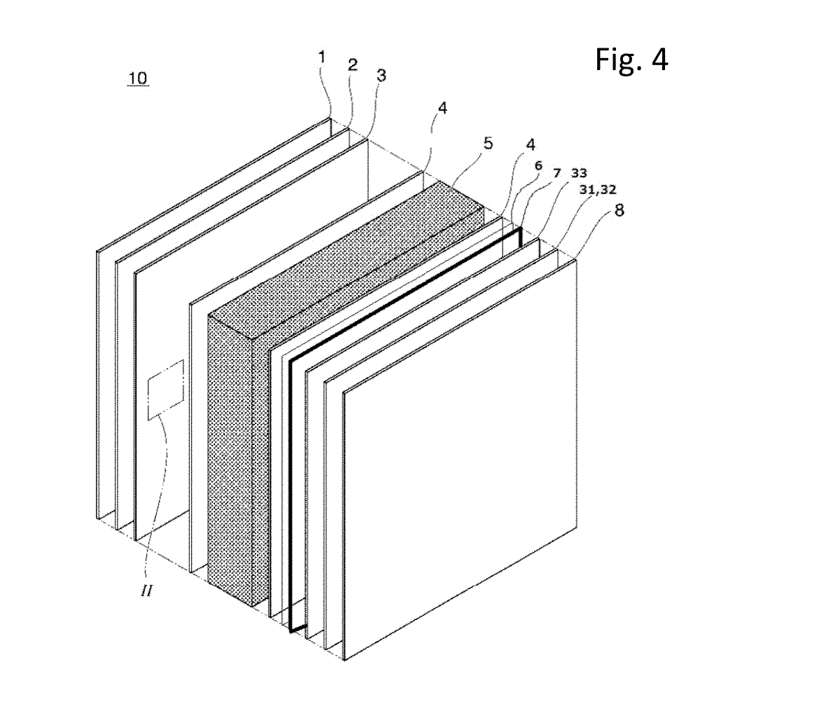

As another embodiment of the invention, an embodiment using the image display device in a liquid crystal display device will be described with reference to FIGS. 4 to 21. In the figures, FIGS. 4 to 13 are schematic illustrations showing examples of a liquid crystal display device using an optical anisotropy layer containing at least one of the optical anisotropy molecule regulating a phase or a velocity of transmitted light or the polymer liquid crystal, as a liquid crystal layer containing a liquid crystal compound regulating a phase or a velocity of transmitted light. FIGS. 14 to 21 are schematic illustrations showing examples of a liquid crystal display device using a liquid crystal medium capable of regulating the alignment thereof with an external field, as a liquid crystal layer containing a liquid crystal compound regulating a phase or a velocity of transmitted light.

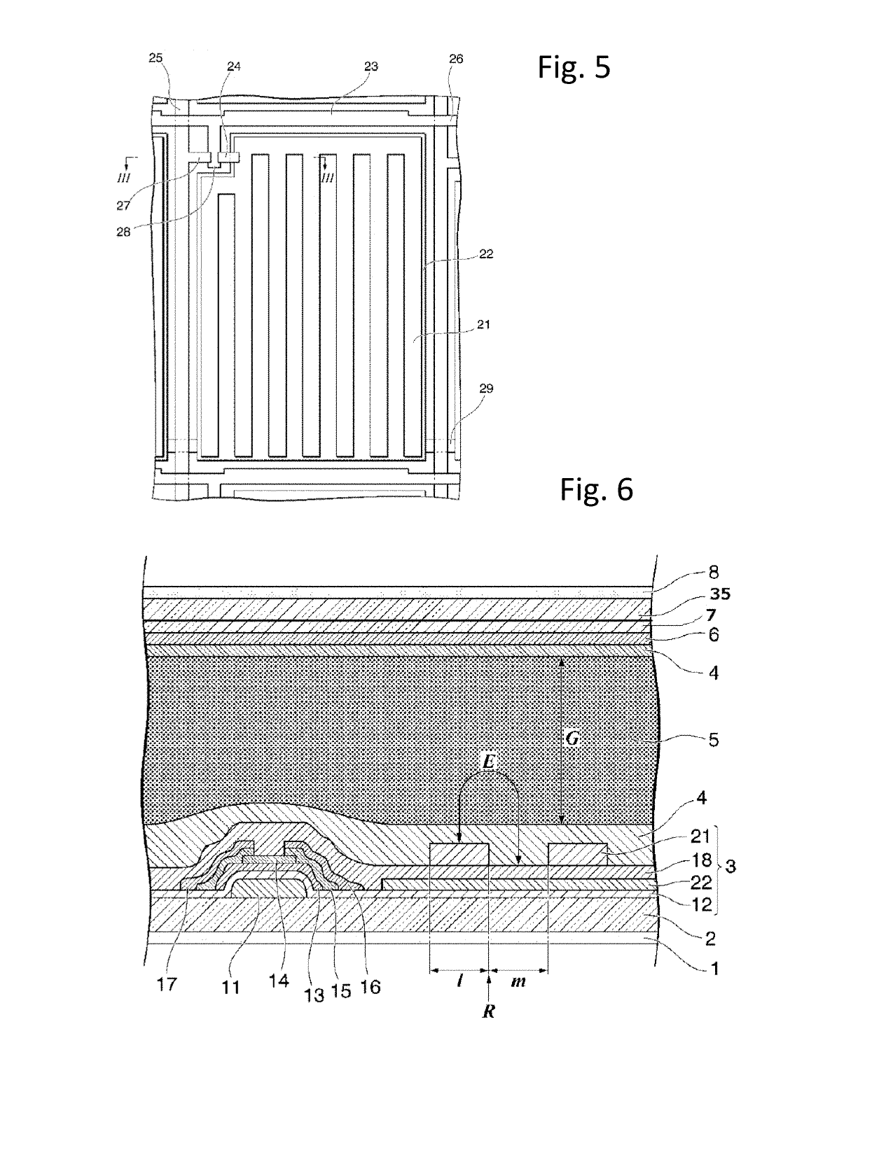

In FIGS. 5 to 7, the liquid crystal display device 10 of the invention has a first substrate 2 having a first alignment film 4a formed on the surface thereof, a second substrate 7 disposed with a space from the first substrate, having a second alignment film 4b formed on the surface thereof, and a (driving) liquid crystal layer 5 filled between the first substrate 2 and the second substrate 7, in contact with the first alignment film 4a and the second alignment film 4b, and has an electrode layer 3 having a thin film transistor as an active element, a common electrode 22, and a pixel electrode 21, between the alignment films 4 (4a and 4b) and the first substrate 2. In the liquid crystal display device 10 of the invention, the second substrate 7 has on one surface thereof the second alignment film 4b through a color filter 6, and on the other surface thereof an optical laminated material (containing an alignment layer 33, and an optical anisotropy layer 32 or a retardation film 31 as a compensation film, for example, in FIG. 4). A polarizing layer (or a polarizing plate) 8 is formed on the optical anisotropy layer 32 or the retardation film 31 as a compensation film. In FIG. 4, the alignment layer 33 and the optical anisotropy layer 32 (or the retardation film 31 as a compensation film) are formed in this order on the other surface of the second substrate 7, but the optical anisotropy layer 32 (or the retardation film 31 as a compensation film), the alignment layer 33, and the polarizing layer 8 may be formed in this order. Another transparent substrate may be provided between the alignment layer 33 and the substrate 7, and similarly another transparent substrate may be provided between the polarizing layer 8 and the optical anisotropy layer 32 (or the retardation film 31 as a compensation film). FIGS. 4 to 8 show the embodiment, in which the optical anisotropy layer 32 or the optical laminated material 35 is formed between the polarizing layer 8 and the (driving) liquid crystal layer 5, and in the case where the optical anisotropy layer 32 is used as a pattern retarder or a lenticular lens as shown in FIG. 12, numerals 1 and 8 each show a linear polarizing plate, and the pattern retarder or the lenticular lens is preferably provided between one of the polarizing plates close to the observer and the observer. In the structure of the case, it is preferred that the second substrate 7 has the second alignment film 4b formed on one surface thereof through the color filter 6, and the polarizing layer 8 formed on the other surface thereof, the alignment layer 33 is provided on the polarizing layer 8, and the optical anisotropy layer 32 as the pattern retarder or the lenticular lens is provided on the alignment layer 33. In this case, another substrate may be provided between the polarizing layer 8 and the alignment layer 33, and the order of the alignment layer 33 and the optical anisotropy layer 32 may be reversed.

In FIG. 4, the constitutional elements are shown with spaces among them for illustrative purposes. The structure of the liquid crystal display device 10 of the invention is, as shown in FIG. 4, a liquid crystal display device of a transverse electric field type (the figure shows an FFS mode as one embodiment of IPS, for example) having the liquid crystal composition (or the (driving) liquid crystal layer 5) held between the first transparent insulating substrate 2 and the second transparent insulating substrate 7 which is disposed to face each other. The first transparent insulating substrate 2 has an electrode layer 3 on the surface thereof on the side of the (driving) liquid crystal layer 5. A pair of alignment films 4 (4a and 4b) inducing homogeneous alignment are provided between the (driving) liquid crystal layer 5, and the first transparent insulating substrate 2 and the second transparent insulating substrate 7, in direct contact with the liquid crystal composition constituting the (driving) liquid crystal layer 5, and the liquid crystal molecules in the liquid crystal composition are aligned in substantially parallel to the substrates 2 and 7 under application of no voltage. As shown in FIG. 4 and FIG. 12, the second substrate 7 and the first substrate 2 may be held between a pair of polarizing plates 1 and 8. The optical anisotropy layer 32 as a pattern retarder or a lenticular lens may be provided between one of the polarizing plate close to the observer (8 or 1, 8 in FIGS. 4 and 12) and the observer, and the retardation film 31 as a compensation film may be provided between the polarizing plate 8 and the (driving) liquid crystal layer 5. In FIG. 4, the color filter 6 is provided between the second substrate 7 and the alignment film 4. An embodiment of the liquid crystal display device of the invention may be a so-called color filter-on-array (COA), and the color filter may be provided between the electrode layer containing a thin film transistor and the liquid crystal layer, or may be provided between the electrode layer containing a thin film transistor and the second substrate.

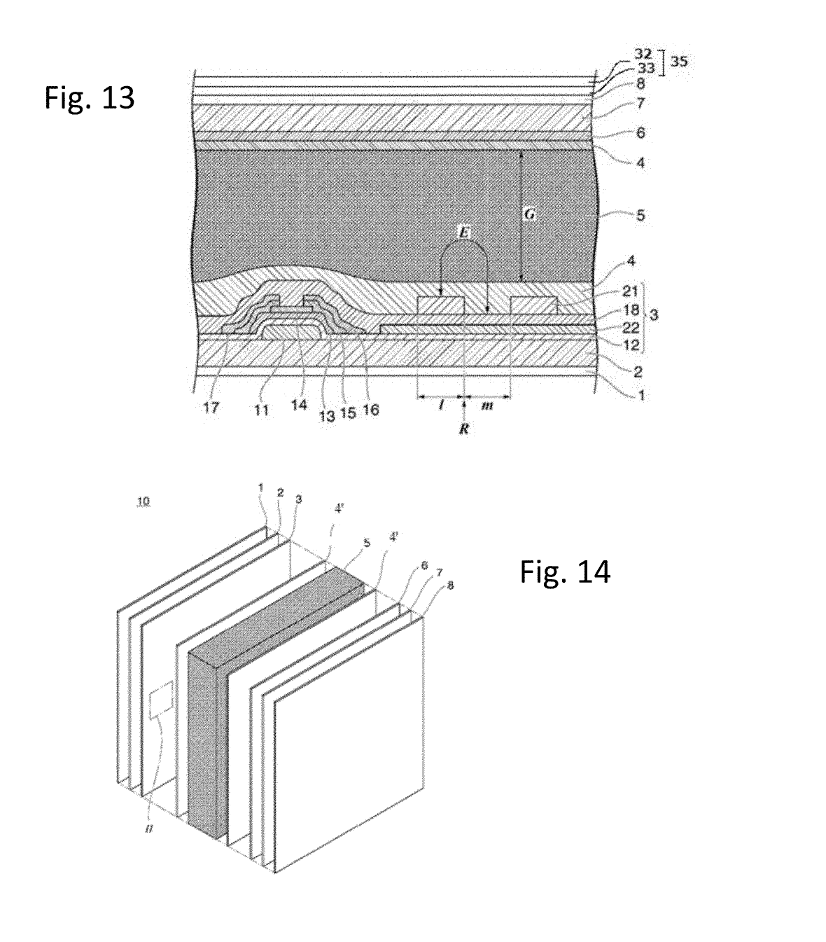

Accordingly, the liquid crystal display device 10 of the invention has such a structure that the first polarizing plate 1, the first substrate 2, the electrode layer 3 containing a thin film transistor, the alignment film 4, the (driving) liquid crystal layer 5 containing a liquid crystal composition, the alignment layer 4, the color filter 6, the second substrate 7, the second polarizing plate 8, and the optical anisotropy layer as a pattern retarder or a lenticular lens between one of the polarizing plate close to the observer (1 or 8, 8 in the figure) and the observer are laminated in this order. Embodiments of the structure are shown in FIGS. 12 and 13.

Another embodiment may have such a structure as shown in FIG. 4 and the like that the first polarizing plate 1, the first substrate 2, the electrode layer 3 containing a thin film transistor, the alignment film 4, the (driving) liquid crystal layer 5 containing a liquid crystal composition, the alignment layer 4, the color filter 6, the second substrate 7, the alignment layer 33, the optical anisotropy layer 32 or the retardation film 31 as a compensation layer, and the second polarizing plate 8 are laminated in this order.

The first substrate 2 and the second substrate 7 used each may be glass or a flexible transparent material, such as plastics, and one of them may be an opaque material, such as silicone. The two substrates 2 and 7 are adhered to each other with a sealing material or a sealant, such as an epoxy thermosetting composition, disposed in the peripheral portions thereof, and a granular spacer, such as glass particles, plastic particles, and alumina particles, or a spacer column formed of a resin formed by a photolithography method may be disposed between the substrates for retaining the distance between them. The alignment film used in the image display device (particularly the liquid crystal display device) of the invention may be a known rubbing alignment film or one that is similar to the photo alignment layer of the invention. The same is applied hereinafter.

FIG. 5 is an enlarged plan view of the region surrounded by the line II of the electrode layer 3 formed on the substrate 2 in FIG. 4. FIG. 6 is a cross sectional view of the liquid crystal display device shown in FIG. 4 cut in the direction of the line III-III in FIG. 5. As shown in FIG. 5, the electrode layer 3 containing a thin film transistor formed on the surface of the first substrate 2 has plural gate lines 26 for supplying a scanning signal and plural data lines 25 for supplying a display signal, which are intercrossed with each other in a matrix form. In FIG. 5, only one pair of the gate lines 26 and one pair of the data lines 25 are shown.

The unit pixel of the liquid crystal display device is constituted by the region surrounded by the plural gate lines 26 and the plural data lines 25, and in the unit pixel, a pixel electrode 21 and a common electrode 22 are formed. In the vicinity of the crossing part of the gate line 26 and the data line 25 crossing each other, a thin film transistor containing a source electrode 27, a drain electrode 24, and a gate electrode 28 is provided. The thin film transistor is connected to the pixel electrode 21 and functions as a switching device supplying a display signal to the pixel electrode 21. In parallel to the gate line 26, a common line (29) is provided. The common line is connected to the common electrode 22 for supplying the common signal to the common electrode 22.

A preferred embodiment of the structure of the thin film transistor contains, for example, as shown in FIG. 6, a gate electrode 11 formed on the surface of a substrate 2, a gate insulating layer 12 provided to cover the gate electrode 11 and to cover the substantially entire surface of the substrate 2, a semiconductor layer 13 formed on the surface of the gate insulating layer 12 to face the gate electrode 11, a protective film 14 provided to cover a part of the surface of the semiconductor layer 13, a drain electrode 16 provided to cover side end portions of the protective layer 14 and the semiconductor layer 13 and to be in contact with the gate insulating layer 12 formed on the surface of the substrate 2, a source electrode 17 provided to cover the other side end portions of the protective film 14 and the semiconductor layer 13 and to be in contact with the gate insulating layer 12 formed on the surface of the substrate 2, and an insulating protective layer 18 provided to cover the drain electrode 16 and the source electrode 17. An anodized film (which is not shown in the figure) may be formed on the surface of the gate electrode 11 for such purposes as flattening the steps to the gate electrode.

The semiconductor layer 13 used may be amorphous silicon, polycrystalline silicon, and the like, and a transparent semiconductor film, such as ZnO, IGZO (In—Ga—Zn—O), and ITO, is preferably used since the harmful effect of the photo carrier due to light absorption can be suppressed to enhance the aperture ratio of the device.

An ohmic contact layer 15 may be provided between the semiconductor layer 13 and the drain electrode 16 or the source electrode 17, for reducing the width and the height of the Schottky barrier. The ohmic contact layer used may be a material having an impurity, such as phosphorus, in a high concentration, such as n-type amorphous silicon and n-type polycrystalline silicon.

The gate line 26, the data line 25, and the common line 29 each are preferably a metal film, and more preferably Al, Cu, Au, Ag, Cr, Ta, Ti, Mo, W, Ni, or alloys thereof, and particularly preferably a line of Al or an alloy thereof is particularly preferably used. The insulating protective layer 18 has a layer having an insulating function, and may be formed of a silicon nitride, silicon dioxide, or silicon oxynitride film, or the like.

In the embodiment shown in FIGS. 5 and 6, the common electrode 22 is an electrode in the form of flat plate formed on the substantially entire upper surface of the gate insulating layer 12, and the pixel electrode 21 is an electrode in the form of a comb formed on the insulating protective layer 18 covering the common electrode 22. Therefore, the common electrode 22 is disposed at a position closer to the first electrode 2 than the pixel electrode 21, and these electrodes are disposed on each other through the insulating protective layer 18. The pixel electrode 21 and the common electrode 22 are formed, for example, of a transparent conductive material, such as ITO (indium tin oxide), IZO (indium zinc oxide), and IZTO (indium zinc tin oxide). The pixel electrode 21 and the common electrode 22 are formed of a transparent conductive material, and therefore the opening area per unit pixel area is increased, thereby increasing the aperture ratio and the transmittance.

In the liquid crystal display device shown in FIG. 6, the pixel electrode 21 and the common electrode 22 form a fringe electric field between the electrodes, and therefor the electrodes are formed in such a manner that the electrode distance R between the pixel electrode 21 and the common electrode 22 (which may be referred to as the minimum spacing distance) is smaller than the distance G between the first electrode 2 and the second electrode 7. The electrode distance R herein means the distance in the horizontal direction in parallel to the substrate between the electrodes. In FIG. 6, the common electrode 22 in the form of a flat plate and the pixel electrode 21 in the form of a comb overlap each other, and thus an example having an electrode distance R of 0 is shown, in which the minimum spacing distance R is smaller than the distance G between the first substrate 2 and the second substrate 7 (i.e., the cell gap), and thus a fringe electric field E is formed. Accordingly, the FFS type liquid crystal display device can utilize the horizontal electric field formed in the direction perpendicular to the lines constituting the comb form of the pixel electrode 21, and the electric field in a parabolic form. The electrode width 1 of the comb form portion of the pixel electrode 21 and the width m of the gap of the comb form portion of the pixel electrode 21 are preferably such widths that all the liquid crystal molecules in the (driving) liquid crystal layer 5 are driven by the electric field formed. The minimum spacing distance R between the pixel electrode and the common electrode can be controlled by the (average) thickness of the gate insulating film 12. The liquid crystal display device of the invention may be formed in such a manner that the electrode distance R between the pixel electrode 21 and the common electrode 22 (which may be referred to as the minimum spacing distance) is larger than the distance G between the first electrode 2 and the second electrode 7 (i.e., the IPS system), which is different from the structure in FIG. 6. Examples of this case include a structure, in which a pixel electrode in the form of a comb and a common electrode in the form of a comb are formed alternately within the substantially one plane. In the image display device of the invention, the optical laminated material 35 has a structure containing the alignment layer 33, the optical anisotropy layer 32, and depending on necessity, a substrate, and in the optical laminated material 35, the order of the alignment layer 33 and the optical anisotropy layer 32 is not limited. In FIG. 6, accordingly, the optical laminated material 35 is shown that has a structure containing the alignment layer 33, the optical anisotropy layer 32, and depending on necessity, a substrate. This is the same as in FIGS. 8, 9, and 11.

In the cross sectional view in the case where the image display device of the invention has layers laminated in the order shown in FIG. 12 (the electrode structure is the same as in FIG. 5), the optical laminated material 35 (containing the alignment layer 33 and the optical anisotropy layer 32) is disposed outside with respect to the polarizing layer 8, as shown in FIG. 13.

The color filter 6 in the invention preferably forms a black matrix (which is not shown in the figure) at a portion corresponding to the thin film transistor and a storage capacitor 23, from the standpoint of the prevention of light leakage. The color filter 6 generally contains three kinds of filter pixels of R (red), G (green), and B (blue) for respective dots of a picture or an image, which are aligned, for example, in the direction, in which the gate line extends. The color filter 6 can be produced, for example, by a pigment dispersion method, a printing method, an electrodeposition method, a dyeing method, or the like. A production method of the color filter by a pigment dispersion method will be described for example. A curable colored composition for a color filter is coated on the transparent substrate, and the coated film is patterned and then cured by heat or light irradiation. The process is performed for each of the three colors, red, green, and blue, thereby producing the pixel part for the color filter. In addition, a so-called color filter-on-array may be used, in which a pixel electrode having an active element, such as TFT and a thin film diode, is provided on the substrate.

On the electrode layer 3 and the color filter 6, one pair of alignment films 4 inducing the homogeneous alignment each are provided in direct contact with the liquid crystal composition constituting the (driving) liquid crystal layer 5.

The polarizing plate 1 and the polarizing plate 8 may be controlled to optimize the viewing angle and the contrast by adjusting the polarizing axes of the polarizing plates, and the transmission axes thereof are preferably perpendicular to each other to drive the device in a normally black mode. In particular, any one of the polarizing plate 1 and the polarizing plate 8 is preferably disposed to have a transmission axis in parallel to the alignment direction of the liquid crystal molecules. The product of the refractive index anisotropy Δn of the liquid crystal and the cell thickness is preferably controlled to maximize the contrast. Furthermore, a retardation film 31 or an optical anisotropy layer 35 (such as a compensation layer) may be used between the polarizing plate 1 and the polarizing plate 8, for enhancing the viewing angle. By using the alignment layer of the invention as the alignment layer for producing the retardation film, the retardation film can have further smaller alignment disorder.

In the case of the IPS system as another embodiment of the liquid crystal display device, the minimum spacing distance R of the common electrode and the pixel electrode close to each other is larger than the minimum spacing distance G of the liquid crystal alignment films, and examples of which include a structure, in which the common electrode and the pixel electrode are formed on one substrate, and the common electrode and the pixel electrode are disposed alternately.

In the production method of the invention, it is preferred that one pair of the substrates having the electrode layer and/or the substrates having the film formed on the surface thereof are disposed to face each other with the films being directed inward, and then the liquid crystal composition is filled between the substrates. At this time, the distance of the substrates is preferably controlled through a spacer.

The distance between the substrates (which is the average thickness of the resulting liquid crystal layer, and may be referred to as the spacing distance of the alignment layers) is preferably controlled to from 1 to 100 μm. The average spacing distance of the films is further preferably from 1.5 to 10 μm.

In the invention, examples of the spacer for controlling the distance between the substrates include glass particles, plastic particles, alumina particles, and a columnar spacer formed of a photoresist material.

The FFS type liquid crystal display device having been described with reference to FIGS. 4 to 6 is an example, and the invention can be practiced by any other embodiments unless they deviate from the technical concept of the invention.

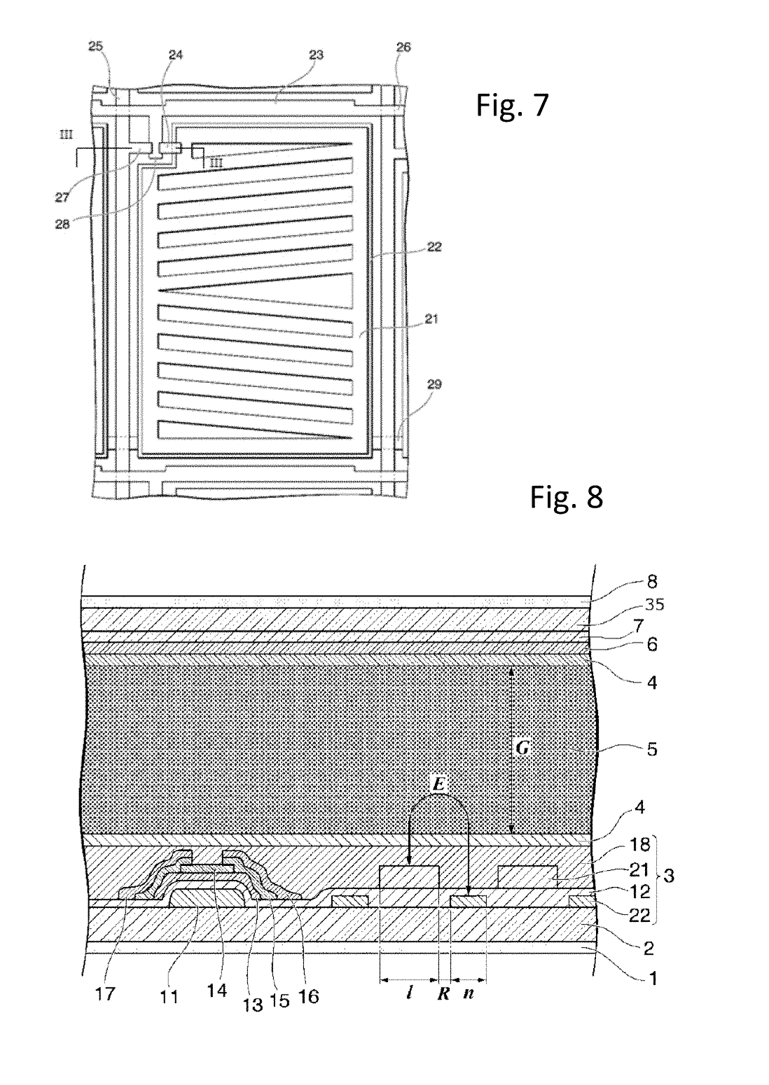

Another embodiment of the liquid crystal display device of the invention will be described below with reference to FIGS. 7 and 8.

For example, FIG. 7 is another embodiment of the enlarged plan view of the region surrounded by the line II of the electrode layer 3 formed on the substrate 2 in FIG. 4. As shown in FIG. 7, the pixel electrode 21 may have a structure having slits. The pattern of the slits may have an inclination angle with respect to the gate line 26 and the data line 25.

The pixel electrode 21 shown in FIG. 7 has a shape obtained by cutting an electrode in the form of a flat plate in a substantially rectangular shape by cutout portions in a substantially rectangular shape. A common electrode 22 in the form of a comb is provided over the back surface of the pixel electrode 21 through an insulating layer 18 (which is not shown in the figure). In the case where the minimum spacing distance R between the common electrode and the pixel electrode adjacent to each other is smaller than the minimum spacing distance G of the alignment layers, an FFS system is obtained, and in the case where the distance R is larger than the distance G, an IPS system is obtained. The surface of the pixel electrode is preferably covered with a protective insulating film and an alignment film. As similar to the aforementioned embodiments, a storage capacitor 23 may be provided in the region surrounded by the plural gate lines 26 and the plural data lines 25. The shape of the cutout portions is not particularly limited, and may be not only the substantially rectangular shape shown in FIG. 7, but also known shapes including an elliptic shape, a circular shape, a rectangular shape, a rhombus shape, a triangular shape, and a parallelogram shape. In the case where the minimum spacing distance R between the common electrode and the pixel electrode adjacent to each other is larger than the minimum spacing distance G of the alignment layers, an IPS system is obtained.

FIG. 8 shows an embodiment other than FIG. 6 (the shapes of the common electrode and the pixel electrode are different therefrom), and is another example of the cross sectional view obtained by cutting the liquid crystal display device shown in FIG. 4 in the direction of the line III-III in FIG. 7. The first substrate 2 having the alignment film 4 and the electrode layer 3 containing a thin film transistor formed on the surface thereof and the second substrate 8 having the alignment layer 4 formed on the surface thereof are disposed to face each other with a prescribed distance G in such a manner that the alignment layers 4 are directed inward, and the (driving) liquid crystal layer 5 containing a liquid crystal composition is filled in the surface therebetween. On a part of the surface of the first electrode 2, the gate insulating film 12, the common electrode 22, the insulating film 18, the pixel electrode 21, and the alignment layer 4 are laminated in the order shown in the figure. As shown in FIG. 7, such a structure is provided that the pixel electrode 21 has a shape that is a flat plate having a center portion and end portions thereof that are cut by the cutout portions in a triangular shape, and the remaining portions thereof are cut by the cutout portions in a rectangular shape, and the common electrode 22 has a comb form substantially in parallel to the cutout portions of the substantially rectangular shape of the pixel electrode 21 and is disposed on the side of the first substrate with respect to the pixel electrode. The optical anisotropy layer 32 and the alignment layer 33 as a pattern retarder or a lenticular lens may be provided between one of the polarizing plate (8 or 1) close to the observer and the observer. The optical laminated material 35 as a compensation film may be provided on the polarizing plate 1 and the polarizing plate 8 on the side of the (driving) liquid crystal layer 5 as shown in the figure.

In the example shown in FIG. 8, the common electrode 22 in the form of a comb or having slits is used, the electrode distance R between the pixel electrode 21 and the common electrode 22 is R=α (in FIG. 8, the horizontal component of the electrode distance is shown by R for convenience sake). Furthermore, while FIG. 6 shows the example, in which the common electrode 22 is formed on the gate insulating film 12, the common electrode 22 may be formed on the first substrate 2, and the pixel electrode 21 may be provided through the gate insulating film 12, as shown in FIG. 8. The electrode width 1 of the pixel electrode 21, the electrode width n of the common electrode 22, and the electrode distance R are preferably controlled appropriately to such ranges that all the liquid crystal molecules in the (driving) liquid crystal layer 5 can be driven by the electric field formed. In the case where the minimum spacing distance R between the common electrode and the pixel electrode adjacent to each other is smaller than the minimum spacing distance G of the alignment layers, an FFS system is obtained, and in the case where the distance R is larger than the distance G, an IPS system is obtained. In FIG. 8, while the positions of the pixel electrode 21 and the common electrode 22 are different from each other in the thickness direction, the positions of the electrodes may be the same as each other in the thickness direction, and the common electrode may be provided on the side of the (driving) liquid crystal layer 5.

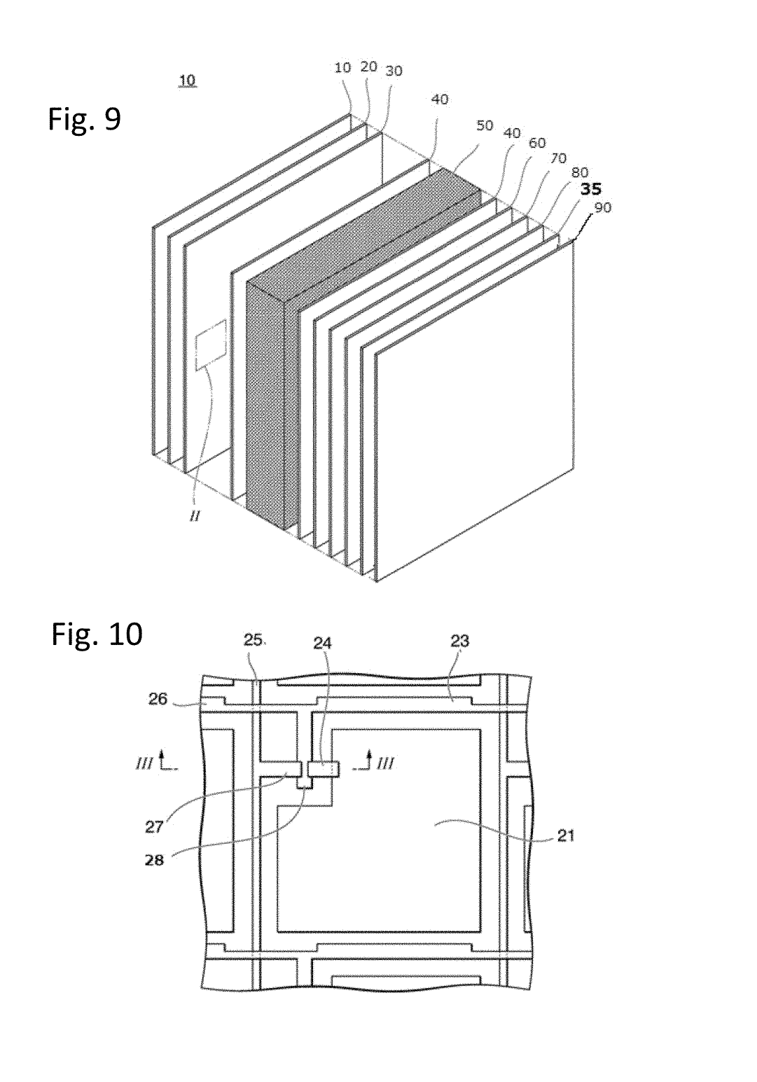

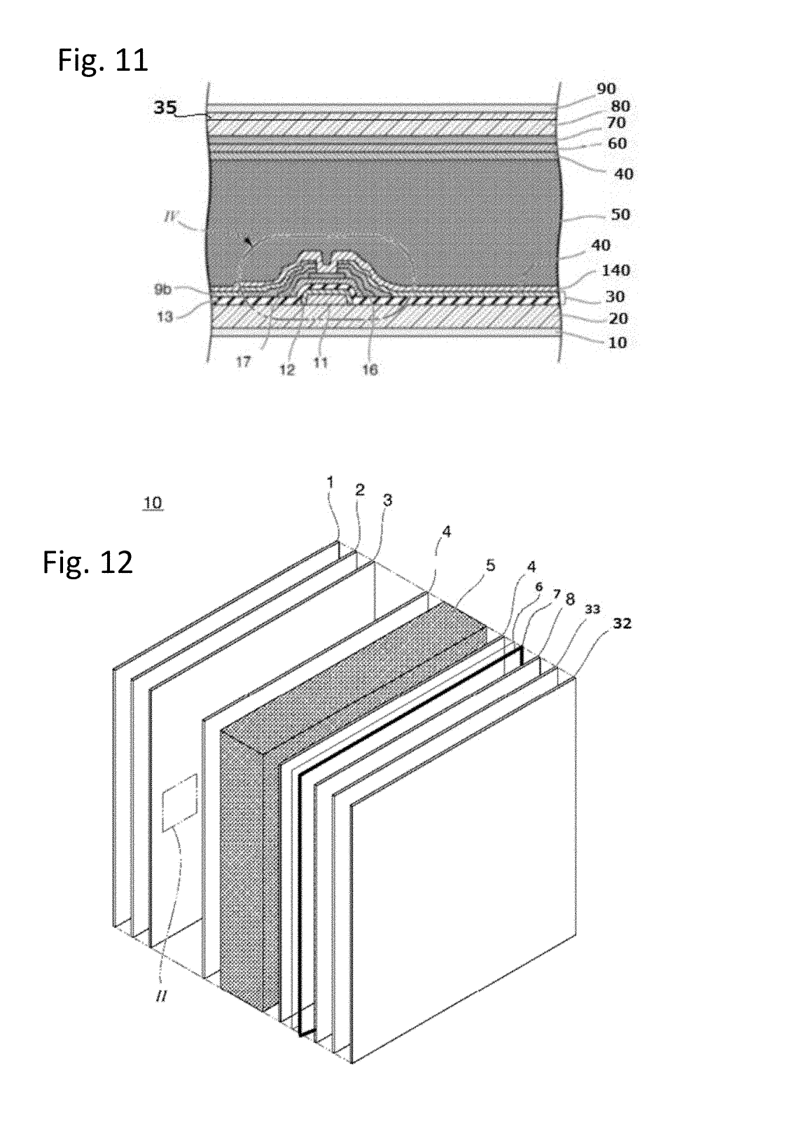

Another preferred embodiment of the invention is a vertical electric field type liquid crystal display device using a liquid crystal composition. Specifically, while FIGS. 4 to 8 describe the structure of the horizontal electric field type liquid crystal display device, the structure of a vertical electric field type liquid crystal display device will be described with reference to FIGS. 9 to 11. FIG. 9 shows the structure of the vertical electric field type liquid crystal display device, and the constitutional elements are shown with spaces among them for illustrative purposes. FIG. 10 is an enlarged plan view of the region surrounded by the line II of the electrode layer 30 containing a thin film transistor (which may also be referred to as a thin film transistor layer 30) formed on the substrate in FIG. 9. FIG. 11 is a cross sectional view of the liquid crystal display device shown in FIG. 9 cut in the direction of the line III-III in FIG. 10. The vertical electric field type liquid crystal display device of the invention will be described with reference to FIGS. 9 to 11.

The liquid crystal display device 10 of the invention has a structure as shown in FIG. 9 containing a second substrate 80 having a transparent electrode (layer) 60 formed of a transparent conductive material (which may also be referred to as a common electrode 60), a first substrate 20 containing a thin film transistor layer 30 having formed therein a thin film transistor for controlling the pixel electrode containing pixel electrodes formed of a transparent conductive material for each pixels, and a liquid crystal composition (or a (driving) liquid crystal layer 50) held between the first substrate 20 and the second substrate 80, in which the alignment of the liquid crystal molecules in the liquid crystal composition is substantially perpendicular to the substrates 20 and 80 under application of no voltage, and the liquid crystal composition used is the liquid crystal composition of the invention. As shown in FIGS. 9 and 11, the second substrate 80 and the first substrate 20 may be held between one pair of polarizing plates 10 and 90. An optical laminated material 35 (retardation film) as a compensation film may be provided on the polarizing plates 10 and 90 on the side of the (driving) liquid crystal layer 50. An optical laminated material 35 as a pattern retarder or a lenticular lens (which is not shown in the figure) may be provided between one of the polarizing plates close to the observer and the observer. In FIG. 9, a color filter 70 is further provided between the first substrate 80 and the common electrode 60. Moreover, one pair of alignment films 40 are provided on the surfaces of the transparent electrode (layer) 60 and the electrode layer 30 in such a manner that the alignment layers are adjacent to the (driving) liquid crystal layer 50 of the invention and are in direct contact with the liquid crystal composition constituting the (driving) liquid crystal layer 50.

Specifically, the liquid crystal display device 10 of the invention has a structure containing the first polarizing plate 10, the first substrate 20, the electrode layer containing a thin film transistor (which may also be referred to as the thin film transistor layer) 30, the alignment film 40, the layer 50 containing the liquid crystal composition, the alignment film 40, the common electrode 60, the color filter 70, the second substrate 80, the optical laminated material 35, and the second polarizing plate 90, which are laminated in this order.

The structure of the electrode layer 30 containing a thin film transistor formed on the surface of the first substrate 20 shown in FIG. 10 (i.e., the storage capacitor 23, the drain electrode 24, the data line 25, the gate line 26, the source electrode 27, and the gate electrode 28) has the same functions as in FIGS. 5 and 7 and thus is omitted herein.

Another embodiment of the image display device of the invention will be described below.

Another embodiment of the image display device of the invention has the image display part that has a first substrate having a first photo alignment layer formed on the surface thereof, a second substrate having a second photo alignment layer formed on the surface thereof, disposed to face the first photo alignment layer with a space from the first photo alignment layer, a liquid crystal layer containing a liquid crystal medium capable of being controlled in alignment with an external field, filled between the first substrate and the second substrate in such a manner that the liquid crystal layer is in contact with the first photo alignment layer and the second photo alignment layer, and an electrode layer containing an active device and a pixel electrode, between the first photo alignment layer and the first substrate, in which the first photo alignment layer or the second photo alignment layer has a yellowness index (YI) of 0.001<YI<100.

Accordingly, the image display device of the aforementioned embodiment is preferably a liquid crystal display device. A high definition liquid crystal display device, or a liquid crystal display device having reduced disorder of the liquid crystal alignment in the vicinity of the boundary region of the retardation film, the pattern retarder, the lenticular lens, or the like can be provided thereby. The liquid crystal display device of the invention has an alignment layer reducing the deterioration due to an ultraviolet ray, shows a high liquid crystal alignment performance, decreases the alignment failure points of the liquid crystal by the enhancement of the alignment regulation force, and enhances the contrast by the decrease of light leakage. The photo alignment layer of the invention has a yellowness index within the particular range, and thus absorbs bluish violet light having relatively high energy but transmits yellow or red and green mixed light having relatively low energy, and thereby an image display device excellent in light resistance can be provided. In particular, it is considered that this is effective in a process step, in which the device itself is exposed and irradiated with an ultraviolet ray, such as a process step, in which the liquid crystal display device of the invention is sealed with a photocurable sealant, or the process step, in which the liquid crystal display device is sealed with a photo-and-heat-curable sealant by the ODF process, in the production process of the liquid crystal display device.

For the image display device of the invention, FIGS. 1 to 13 describe the image display device, in which the optical anisotropy layer containing at least one of the optical anisotropy molecule regulating a phase or a velocity of transmitted light or the polymer liquid crystal is used as the liquid crystal layer containing a liquid crystal compound regulating a phase or a velocity of transmitted light. FIGS. 14 to 21 describe an image display device (liquid crystal display device) that is different from FIGS. 1 to 13. More specifically, a liquid crystal display device, in which a liquid crystal medium capable of regulating the alignment thereof with an external field is used as a liquid crystal layer containing a liquid crystal compound regulating a phase or a velocity of transmitted light. In this case, the image display device of the invention is preferably a liquid crystal display device.

FIG. 14 is a schematic cross sectional view showing one example of the image display device of the invention. The image display device 10 of the invention has a first substrate 2 having a first photo alignment layer 4′ formed on the surface thereof, a second substrate 7 disposed with a space from the first substrate, having a second alignment film 4′ formed on the surface thereof, and a (driving) liquid crystal layer 5 filled between the first substrate 2 and the second substrate 7, in contact with the first alignment film 4′ and the second alignment film 4′, and has an electrode layer 3 having a thin film transistor as an active element, a common electrode 22, and a pixel electrode, between the alignment films 4′ and the first substrate 2.

The relationship between the FIGS. 14 to 16 and FIGS. 4 to 6 is that the liquid crystal display device shown by FIGS. 14 to 16 uses the optical alignment film 4′ as the alignment film. The liquid crystal display device shown by FIGS. 14 to 16 is different in such a point that the optical laminated material 35 formed of the photo alignment layer 33 and the optical anisotropy layer 32 or the retardation film 31 is not provided, but the other structures are the same, and the liquid crystal display device is briefly described below. FIG. 14 is an illustration schematically showing the structure of the liquid crystal display device. The liquid crystal display device 10 of the invention is a liquid crystal display device of a transverse electric field type (the figure shows an FFS mode as one embodiment of IPS, for example) having the liquid crystal composition (or the liquid crystal layer 5) held between the first transparent insulating substrate 2 and the second transparent insulating substrate 7 which are disposed to face each other, in which the liquid crystal layer used is a liquid crystal medium capable of regulating the alignment thereof with an external field (described later). The first transparent insulating substrate 2 has an electrode layer 3 on the surface thereof on the side of the (driving) liquid crystal layer 5. A pair of alignment films 4′ inducing homogeneous alignment are provided between the (driving) liquid crystal layer 5, and the first transparent insulating substrate 2 and the second transparent insulating substrate 7, in direct contact with the liquid crystal composition constituting the (driving) liquid crystal layer 5, and the liquid crystal molecules in the liquid crystal composition are aligned in substantially parallel to the substrates 2 and 7 under application of no voltage. As shown in FIG. 14 and FIG. 16, the second substrate 7 and the first substrate 2 may be held between a pair of polarizing plates 1 and 8. An embodiment of the liquid crystal display device of the invention may be a so-called color filter-on-array (COA).

Accordingly, the liquid crystal display device 10 of the invention has such a structure that the first polarizing plate 1, the first substrate 2, the electrode layer 3 containing a thin film transistor, the first alignment film 4′, the liquid crystal layer 5 containing a liquid crystal medium capable of controlling the alignment thereof by an external field, the second alignment layer 4′, the color filter 6, the second substrate 7, and the second polarizing plate 8 are laminated in this order. The materials for the first substrate 2 and the second substrate 7 are the same as in the description for FIG. 4, and thus are omitted herein.

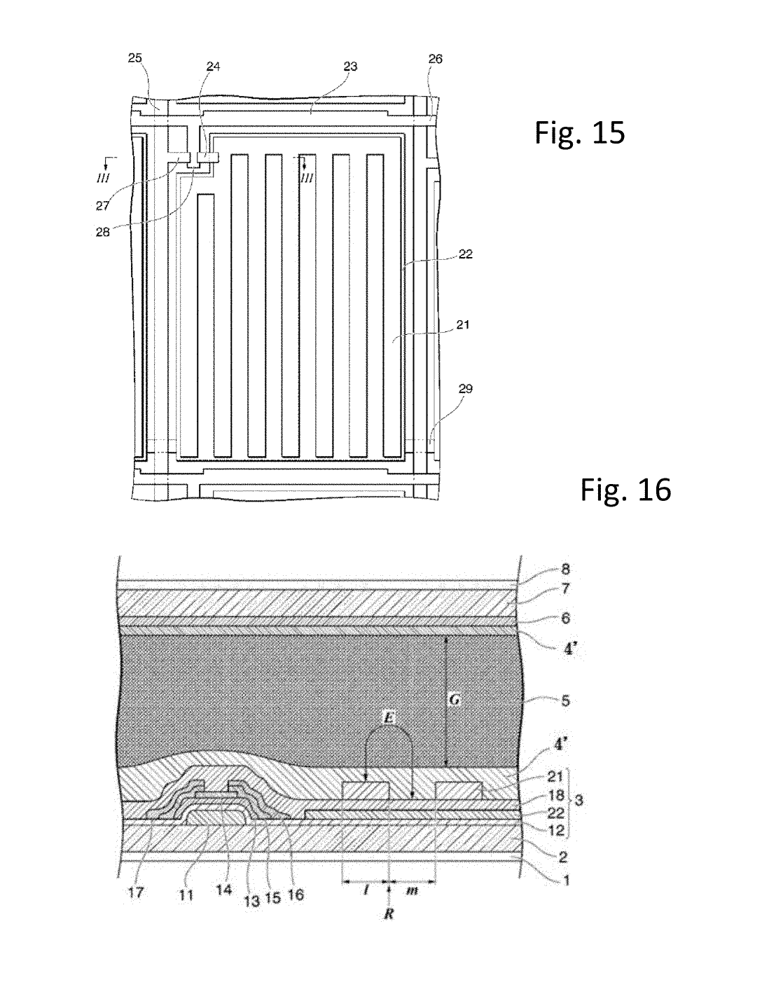

FIG. 15 is an enlarged plan view of the region surrounded by the line II of the electrode layer 3 formed on the substrate 2 in FIG. 14. FIG. 16 is a cross sectional view of the liquid crystal display device shown in FIG. 1 cut in the direction of the line III-III in FIG. 15. As shown in FIG. 15, the electrode layer 3 containing a thin film transistor formed on the surface of the first substrate 2 has plural gate lines 26 for supplying a scanning signal and plural data lines 25 for supplying a display signal, which are intercrossed with each other in a matrix form. The structures and the like of the pixel electrode 21, the common electrode 22, the storage capacitor 23, the drain electrode 24, the data line 25, the gate line 26, the source electrode 27, and the gate electrode 28 in FIG. 16 are the same as in the description for FIG. 5, and thus are omitted herein. The preferred embodiments of the structure of the thin film transistor, the semiconductor layer 13, the gate line 26, the data line 25, and the common line 29 are the same as, for example, FIG. 5, and thus are omitted herein.

In the preferred embodiment of the liquid crystal display device shown in FIGS. 14 to 16, the common electrode 22 is an electrode in the form of a flat plate formed on the substantially entire upper surface of the gate insulating layer 12, and the pixel electrode 21 is an electrode in the form of a comb formed on the insulating protective layer 18 covering the common electrode 22. Therefore, the common electrode 22 is disposed at a position closer to the first electrode 2 than the pixel electrode 21, and these electrodes are disposed on each other through the insulating protective layer 18. The pixel electrode 21 and the common electrode 22 are formed, for example, of a transparent conductive material, such as ITO (indium tin oxide), IZO (indium zinc oxide), and IZTO (indium zinc tin oxide). The pixel electrode 21 and the common electrode 22 are formed of a transparent conductive material, and therefore the opening area per unit pixel area is increased, thereby increasing the aperture ratio and the transmittance.

The pixel electrode 21 and the common electrode 22 form a fringe electric field between the electrodes, and therefor the electrodes are formed in such a manner that the electrode distance R between the pixel electrode 21 and the common electrode 22 (which may be referred to as the minimum spacing distance) is smaller than the distance G between the first electrode 2 and the second electrode 7. The electrode distance R herein means the distance in the horizontal direction in parallel to the substrate between the electrodes. In FIG. 16, the common electrode 22 in the form of a flat plate and the pixel electrode 21 in the form of a comb overlap each other, and thus an example having an electrode distance R of 0 is shown, in which the minimum spacing distance R is smaller than the distance G between the first substrate 2 and the second substrate 7 (i.e., the cell gap), and thus a fringe electric field E is formed. Accordingly, the FFS type liquid crystal display device can utilize the electric field formed in the direction perpendicular to the lines constituting the comb form of the pixel electrode 21, and the electric field in a parabolic form. The electrode width 1 of the comb form portion of the pixel electrode 21 and the width m of the gap of the comb form portion of the pixel electrode 21 are preferably such widths that all the liquid crystal molecules in the (driving) liquid crystal layer 5 are driven by the electric field formed. The minimum spacing distance R between the pixel electrode and the common electrode can be controlled by the (average) thickness of the gate insulating film 12. The liquid crystal display device of the invention may be formed in such a manner that the electrode distance R between the pixel electrode 21 and the common electrode 22 (which may be referred to as the minimum spacing distance) is larger than the distance G between the first electrode 2 and the second electrode 7 (i.e., the IPS system). Examples of this case include a structure, in which a pixel electrode in the form of a comb and a common electrode in the form of a comb are formed alternately within the substantially one plane.

The image display device of the invention is preferably a liquid crystal display device having an active device, a pixel electrode, and a common electrode between the first photo alignment layer and the first substrate, in which the liquid crystal layer undergoes homogeneous alignment.

In the image display device of the invention, the pixel electrode is preferably in the form of a comb, and the common electrode, the insulating layer, and the pixel electrode are preferably laminated in this order on the first substrate.

In the image display device of the invention, the common electrode is preferably in the form of a comb, and the pixel electrode, the insulating layer, and the common electrode are preferably laminated in this order on the first substrate.

A preferred embodiment of the liquid crystal display device of the invention is an FFS type liquid crystal display device utilizing a fringe electric field, and when the minimum spacing distance R between the common electrode 22 and the pixel electrode 21 is smaller than the minimum spacing distance G of the photo alignment layers 4′ (i.e., the substrate distance), a fringe electric field is formed between the common electrode and the pixel electrode, and the alignment of the liquid crystal molecules in the horizontal direction and the vertical direction can be efficiently utilized. In the FFS type liquid crystal display device of the invention, when a voltage is applied to the liquid crystal molecules having a long axis that is in parallel to the alignment direction of the alignment layer, an equipotential line in a parabolic form is formed between the pixel electrode 21 and the common electrode 22 reaching the upper portions of the pixel electrode 21 and the common electrode 22, and the long axes of the liquid crystal molecules in the (driving) liquid crystal layer 5 are aligned along the electric field thus formed. Accordingly, the liquid crystal molecules can be driven even with low dielectric anisotropy.

The color filter 6 in the invention preferably forms a black matrix (which is not shown in the figure) at a portion corresponding to the thin film transistor and a storage capacitor 23, from the standpoint of the prevention of light leakage. The color filter 6 generally contains three kinds of filter pixels of R (red), G (green), and B (blue) for each dots of a picture or an image, which are aligned, for example, in the direction, in which the gate line extends. The color filter 6 can be produced, for example, by a pigment dispersion method, a printing method, an electrodeposition method, a dyeing method, or the like. A production method of the color filter by a pigment dispersion method will be described for example. A curable colored composition for a color filter is coated on the transparent substrate, and the coated film is patterned and then cured by heat or light irradiation. The process is performed for each of the three colors, red, green, and blue, thereby producing the pixel part for the color filter. In addition, a so-called color filter-on-array may be used, in which a pixel electrode having an active element, such as TFT and a thin film diode, is provided on the substrate.

On the electrode layer 3 and the color filter 6, one pair of photo alignment layers 4′ inducing the homogeneous alignment each are provided in direct contact with the liquid crystal composition constituting the (driving) liquid crystal layer 5.

In the image display device of the invention, a color filter is preferably further provided between the pixel electrode and the first substrate or between the second photo alignment layer and the second substrate. In the case where the color filter is provided between the pixel electrode and the first substrate, the second alignment layer preferably has a yellowness index (YI) of 0.001<YI<100.

In the case where the color filter is provided between the second photo alignment layer and the second substrate, the first alignment layer preferably has a yellowness index (YI) of 0.001<YI<100.

The polarizing plate 1 and the polarizing plate 8 may be controlled to optimize the viewing angle and the contrast by adjusting the polarizing axes of the polarizing plates, and the transmission axes thereof are preferably perpendicular to each other to drive the device in a normally black mode. In particular, any one of the polarizing plate 1 and the polarizing plate 8 is preferably disposed to have a transmission axis in parallel to the alignment direction of the liquid crystal molecules. The product of the refractive index anisotropy Δn of the liquid crystal and the cell thickness is preferably controlled to maximize the contrast. Furthermore, a retardation film may be used for enhancing the viewing angle.

In the case of the IPS system as another embodiment of the liquid crystal display device, the minimum spacing distance R of the common electrode and the pixel electrode close to each other is larger than the minimum spacing distance G of the liquid crystal photo alignment layers, and examples of which include a structure, in which the common electrode and the pixel electrode are formed on one substrate, and the common electrode and the pixel electrode are disposed alternately.

In the production method of the invention, it is preferred that one pair of the substrates having the electrode layer and/or the substrates having the film formed on the surface thereof are disposed to face each other with the films being directed inward, and then the liquid crystal composition is filled between the substrates. At this time, the distance of the substrates is preferably controlled through a spacer.

In the image display device of the invention, the average thickness of the photo alignment layer is preferably from 0.01 to 1 μm. The distance between the substrates (which is the average thickness of the resulting liquid crystal layer, and may be referred to as the spacing distance of the films) is preferably controlled to from 1 to 100 μm. The average spacing distance of the films is further preferably from 1.5 to 10 μm.

In the invention, the spacer used for controlling the distance between the substrates is the same as above, and thus is omitted herein.

The FFS type liquid crystal display device described with reference to FIGS. 14 to 16 is an example, and the invention can be practiced by any other embodiments unless they deviate from the technical concept of the invention.

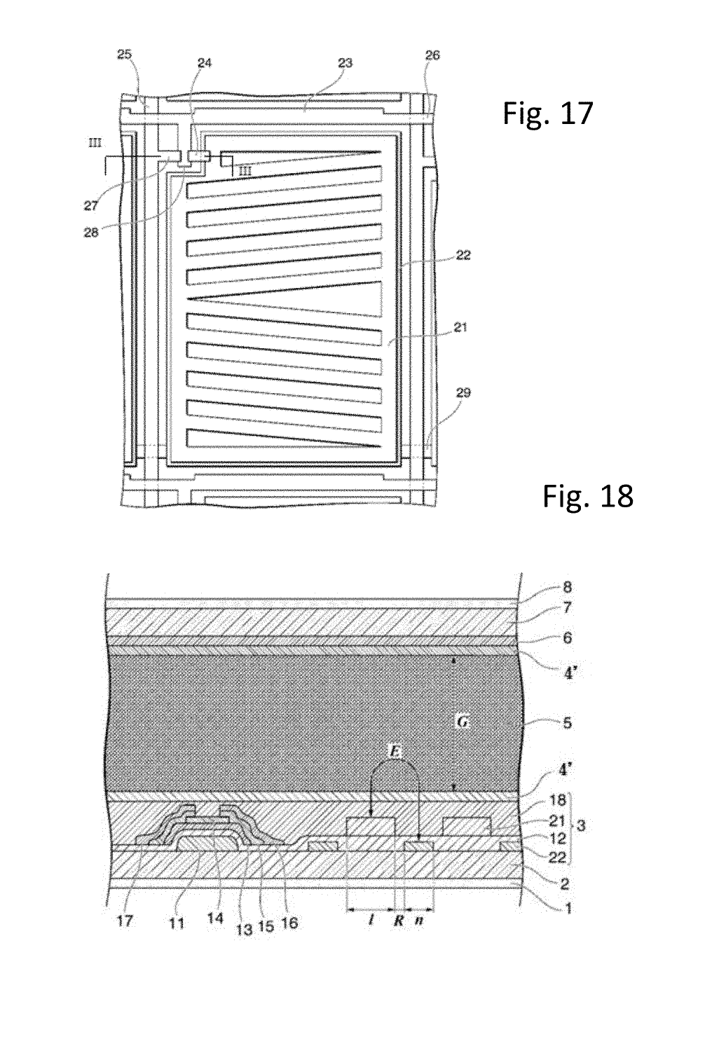

Another embodiment of the liquid crystal display device of the invention using a liquid crystal medium capable of controlling the alignment thereof with an external field (described later) will be described with reference to FIGS. 17 and 18. For example, FIG. 17 is another embodiment of the enlarged plan view of the region surrounded by the line II of the electrode layer 3 formed on the substrate 2 in FIG. 14. As shown in FIG. 18, the pixel electrode 21 may have a structure having slits. The pattern of the slits may have an inclination angle with respect to the gate line 26 and the data line 25.

The pixel electrode 21 shown in FIG. 17 has a shape obtained by cutting an electrode in the form of a flat plate in a substantially rectangular shape by cutout portions in a substantially rectangular shape. A common electrode 22 in the form of a comb is provided over the back surface of the pixel electrode 21 through an insulating layer 18 (which is not shown in the figure). In the case where the minimum spacing distance R between the common electrode and the pixel electrode adjacent to each other is smaller than the minimum spacing distance G of the alignment layers, an FFS system is obtained, and in the case where the distance R is larger than the distance G, an IPS system is obtained. The surface of the pixel electrode is preferably covered with a protective insulating film and a photo alignment layer. As similar to the aforementioned embodiments, a storage capacitor 23 may be provided in the region surrounded by the plural gate lines 26 and the plural data lines 25. The shape of the cutout portions is not particularly limited, and may be as similar to FIG. 7.

FIG. 18 shows an embodiment other than FIG. 16, and is another example of the cross sectional view obtained by cutting the liquid crystal display device shown in FIG. 14 in the direction of the line III-III in FIG. 15. The first substrate 2 having the photo alignment layer 4′ and the electrode layer 3 containing a thin film transistor formed on the surface thereof and the second substrate 8 having the photo alignment layer 4′ formed on the surface thereof are disposed to face each other with a prescribed distance G in such a manner that the alignment layers 4′ are directed inward, and the (driving) liquid crystal layer 5 containing a liquid crystal composition is filled in the surface therebetween. On a part of the surface of the first electrode 2, the gate insulating film 12, the common electrode 22, the insulating film 18, the pixel electrode 21, and the alignment layer 4 are laminated in the order shown in the figure.

In the example shown in FIG. 18, the common electrode 22 in the form of a comb or having slits is used, and the electrode distance R between the pixel electrode 21 and the common electrode 22 is R=α (in FIG. 18, the horizontal component of the electrode distance is shown by R for convenience sake). Furthermore, while FIG. 16 shows the example, in which the common electrode 22 is formed on the gate insulating film 12, the common electrode 22 may be formed on the first substrate 2, and the pixel electrode 21 may be provided through the gate insulating film 12, as shown in FIG. 18. The electrode width 1 of the pixel electrode 21, the electrode width n of the common electrode 22, and the electrode distance R are preferably controlled appropriately to such ranges that all the liquid crystal molecules in the (driving) liquid crystal layer 5 can be drive by the electric field formed. In the case where the minimum spacing distance R between the common electrode and the pixel electrode adjacent to each other is smaller than the minimum spacing distance G of the alignment layers, an FFS system is obtained, and in the case where the distance R is larger than the distance G, an IPS system is obtained. In FIG. 18, while the positions of the pixel electrode 21 and the common electrode 22 are different from each other in the direction connecting them (i.e., the thickness direction), the positions of the electrodes may be the same as each other in the thickness direction, and the common electrode may be provided on the side of the (driving) liquid crystal layer 5.

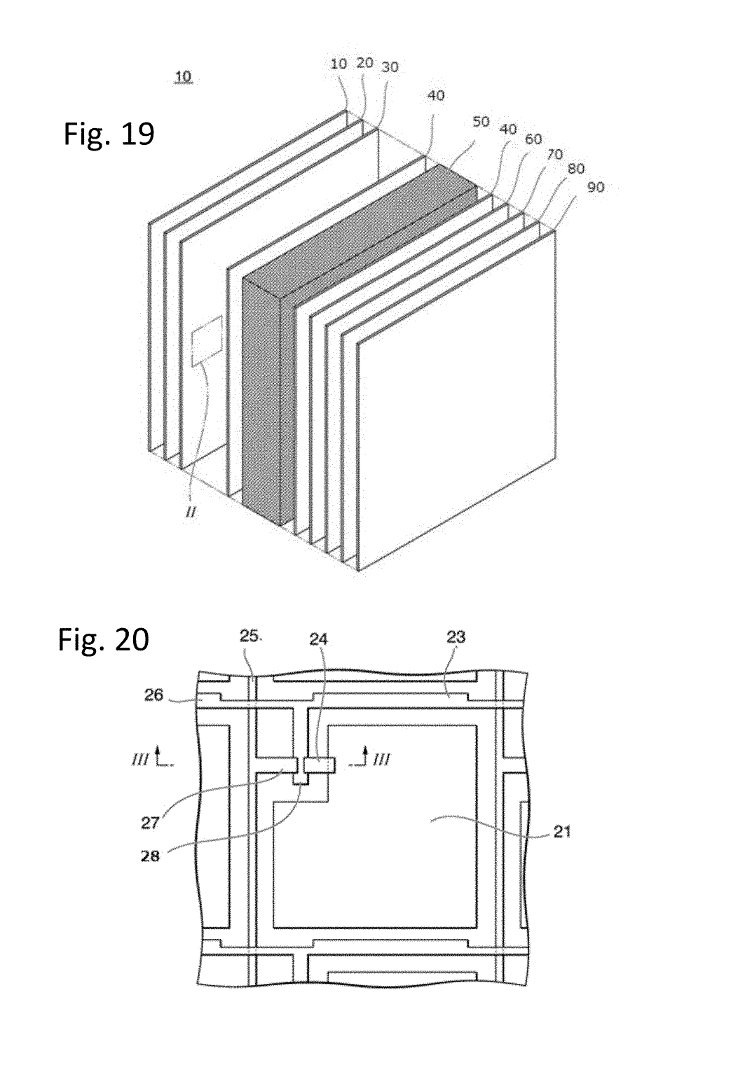

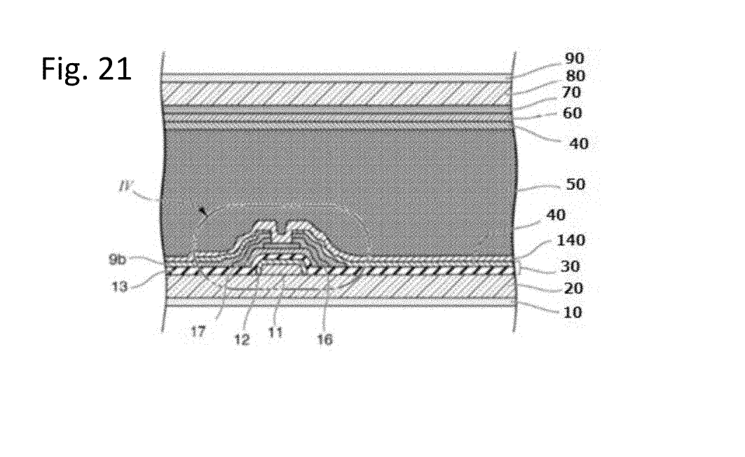

Another preferred embodiment of the invention is a vertical electric field type liquid crystal display device using a liquid crystal composition. FIG. 19 is an illustration schematically showing the structure of the vertical electric field type liquid crystal display device. FIG. 19 shows the constitutional elements with spaces among them for illustrative purposes. FIG. 20 is an enlarged plan view of the region surrounded by the line II of the electrode layer 30 containing a thin film transistor (which may also be referred to as a thin film transistor layer 30) formed on the substrate in FIG. 20. FIG. 21 is a cross sectional view of the liquid crystal display device shown in FIG. 19 cut in the direction of the line III-III in FIG. 20. The vertical electric field type liquid crystal display device of the invention will be described with reference to FIGS. 19 to 21.

The liquid crystal display device 10 of the invention has a structure as shown in FIG. 19 containing a second substrate 80 having a transparent electrode (layer) 60 formed of a transparent conductive material (which may also be referred to as a common electrode 60), a first substrate 20 containing a thin film transistor layer 30 having formed therein a thin film transistor for controlling the pixel electrode containing pixel electrodes formed of a transparent conductive material for each pixels, and a liquid crystal composition (or a liquid crystal layer 50) held between the first substrate 20 and the second substrate 80, in which the alignment of the liquid crystal molecules in the liquid crystal composition is substantially perpendicular to the substrates 20 and 80 under application of no voltage, and the liquid crystal composition used is the liquid crystal composition of the invention. As shown in FIGS. 19 and 21, the second substrate 80 and the first substrate 20 may be held between one pair of polarizing plates 10 and 90. In FIG. 19, a color filter 70 is further provided between the first substrate 80 and the common electrode 60. Moreover, one pair of photo alignment layers 40 are provided on the surfaces of the transparent electrode (layer) 60 and the electrode layer 30 (particularly 140) in such a manner that the photo alignment layers are adjacent to the liquid crystal layer 50 of the invention and are in direct contact with the liquid crystal composition constituting the (driving) liquid crystal layer 50.

Specifically, the liquid crystal display device 10 of the invention has a structure containing the second polarizing plate 10, the second substrate 20, the electrode layer containing a thin film transistor (which may also be referred to as the thin film transistor layer) 30, the photo alignment layer 40, the layer 50 containing the liquid crystal composition, the photo alignment layer 40, the common electrode 60, the color filter 70, the first substrate 80, and the first polarizing plate 90, which are laminated in this order.

Accordingly, the image display device of the invention preferably has a common electrode between the second substrate and the second photo alignment layer.

The structure of the electrode layer 30 containing a thin film transistor formed on the surface of the first substrate 20 shown in FIG. 20 (i.e., the storage capacitor 23, the drain electrode 24, the data line 25, the gate line 26, the source electrode 27, and the gate electrode 28) is the same as above, and thus is omitted herein.

In the production method of the liquid crystal display device of the invention, the method of introducing the liquid crystal composition (which may contain a polymerizable compound depending on necessity) between the two substrates may be an ordinary vacuum injection method, an ordinary ODF method, or the like. However, the vacuum injection method has a problem that injection marks remain although dropping marks are not formed. The invention can be more preferably applied to a display device that is produced by the ODF method. In the production process of a liquid crystal display device by the ODF method, a sealant, such as an epoxy photo-and-heat-curable sealant, is applied to one of the substrates of the back assembly and the front assembly with a dispenser to draw a bump in the form of a closed loop, and after dropping the prescribed amount of the liquid crystal composition into the bump under degassing conditions, the front assembly and the back assembly are adhered, thereby producing the liquid crystal display device. The liquid crystal composition of the invention can stably perform the dropping of the liquid crystal composition in the ODF process, and thus is preferably used therefor. In the vacuum injection method, it is preferred that the substrates are disposed to face each other in such a manner that the (transparent) electrode layer is directed inward (the liquid crystal alignment films face each other), a sealant, such as an epoxy photo-and-heat-curable sealant, is screen-printed on the substrate with a liquid crystal injection port provided, the substrates are adhered to each other in such a manner that the liquid crystal alignment films face each other, and then the sealant is cured by heating.

In the process of production of the liquid crystal display device, the formation of dropping marks is largely influenced by the liquid crystal material injected, and the influence of the structure of the liquid crystal display device also cannot be avoided. As shown in FIG. 7, only the thin alignment film 40, the transparent electrode 60 or 140, and the like are the members that are in direct contact with the liquid crystal composition, and therefore the formation of dropping marks is influenced, for example, by the combination of the chemical structure of the polymer used in the alignment film 40 and the liquid crystal compound having the particular chemical structure.

In the liquid crystal display device of the invention, the yellowness index (YIL) of the first substrate or the second substrate having the photo alignment layer is 0.001<YIL<100, and thus not only light dropping marks are not conspicuous, but also the deterioration with the lapse of time due to the back light or an ultraviolet ray can be suppressed and prevented.

The liquid crystal layer, the photo alignment layer, and the optical laminated material, which are constitutional elements of the image display device of the invention, will be described in detail below.

### Liquid Crystal Layer

The liquid crystal layer containing a liquid crystal compound in the invention is preferably any of a liquid crystal medium capable of controlling the alignment thereof with an external field, an optical anisotropy molecule obtained by curing a polymerizable liquid crystal compound, and a polymer liquid crystal capable of undergoing phase transition. These three components will be described in detail below.

### Liquid Crystal Medium

The liquid crystal medium in the invention is preferably a composition capable of controlling the alignment thereof with an external field, and more preferably a nematic composition. The nematic composition may be a liquid crystal composition having positive dielectric anisotropy (i.e., a p-type liquid crystal) or a liquid crystal composition having negative dielectric anisotropy (i.e., an n-type liquid crystal) depending on the target operation mode. The property values of the liquid crystal composition may be appropriately controlled depending on the characteristic value of the target liquid crystal display device. The clearing point of the liquid crystal composition is preferably high to some extent, and specifically is preferably in a range of from 60 to 120° C., and more preferably in a range of from 70 to 100° C. In the case where the average refractive index of the liquid crystal layer is too large, the wavelength of the incident light changing depending on the difference in refractive index between the glass substrate and the liquid crystal layer provides a difference in reaction rate between the upper and lower photosensitive polymer films, and therefore the birefringence (Δn) of the liquid crystal is preferably low to some extent, and specifically is preferably in a range of from 0.06 to 0.25, more preferably in a range of from 0.07 to 0.20, and particularly preferably in a range of from 0.08 to 0.15.

In the invention, a transverse electric field type liquid crystal display device has a structural limitation that the driving voltage of the liquid crystal molecule is proportional to the electrode distance of the comb pattern electrode, and thus in the case where a low operation voltage is important, a p-type liquid crystal composition, which is easily provided with high dielectric anisotropy, is preferred. In the case where a p-type liquid crystal composition is driven along the electric force line formed between the electrodes, there are cases where light leakage occurs due to alignment disorder in a microscopic region, which consequently result in increase of the black luminance or decrease of the transmittance. For the purpose of avoiding the phenomenon, an n-type liquid crystal composition, which does not form microscopic alignment disorder due to the electric force line distribution, can be preferably used. In any of the compositions, the liquid crystal compound constituting the composition is preferably selected from the group of liquid crystal compounds having relatively high UV stability. The electron withdrawing group that is introduced to the polar compound for exhibiting the positive or negative dielectric anisotropy in the composition may be various ones including a cyano group and a halogen, and a cyano group is preferred, a halogen and a halogenated alkyl are more preferred, and among these, fluorine is particularly preferred.

The liquid crystal medium used in the liquid crystal layer in the invention is preferably a composition, and more preferably a nematic composition. As the liquid crystal compound contained in the liquid crystal layer, a compound represented by the following general formula (LC) is preferred.

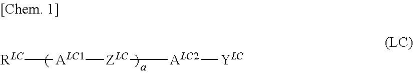

In the general formula (LC), R^{LC} represents an alkyl group having from 1 to 15 carbon atoms, in which one or two or more CH₂ groups in the alkyl group may be substituted by —O—, —CH═CH—, —CO—, —OCO—, —COO—, or —C≡C— in such a manner that oxygen atoms are not directly adjacent to each other, and one or two or more hydrogen atoms in the alkyl group may be arbitrarily substituted by a halogen atom,

A^{LC1} and A^{LC2} each independently represent a group selected from the group consisting of

(a) a trans-1,4-cyclohexylene group (in which one CH₂ group or two or more CH₂ groups that are not adjacent to each other present in the group may be substituted by an oxygen atom or a sulfur atom),

(b) a 1,4-phenylene group (in which one CH group or two or more CH groups that are not adjacent to each other present in the group may be substituted by a nitrogen atom), and

(c) a 1,4-bicyclo(2.2.2)octylene group, a naphthalen-2,6-diyl group, a decahydronaphthalen-2,6-diyl group, a 1,2,3,4-tetrahydronaphthalen-2,6-diyl group, and a chroman-2,6-diyl group,

in which one or two or more hydrogen atoms contained in the group (a), the group (b), or the group (c) may be substituted by F, Cl, CF₃, or OCF₃,

Z^{LC} represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—,

Y^{LC} represents a hydrogen atom, a fluorine atom, a chlorine atom, a cyano group, or an alkyl group having from 1 to 15 carbon atoms, in which one or two or more CH_{z} groups in the alkyl group may be substituted by —O—, —CH═CH—, —CO—, —OCO—, —COO—, —C≡C—, —CF₂O—, or —OCF₂— in such a manner that oxygen atoms are not directly adjacent to each other, and one or two or more hydrogen atoms in the alkyl group may be arbitrarily substituted by a halogen atom, and

a represents an integer of from 1 to 4, provided that in the case where a represents 2, 3, or 4, and plural groups represented by A^{LC1} are present, the plural groups represented by A^{LC1} may be the same as or different from each other, and in the case where plural groups represented by Z^{LC} are present, the plural groups represented by Z^{LC} may be the same as or different from each other.

The compound represented by the general formula (LC) is preferably one kind or two or more kinds of a compound selected from the group of compounds represented by the following general formulae (LC1) and (LC2).

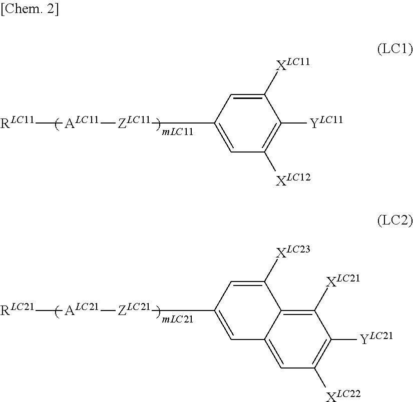

In the general formulae (LC1) and (LC2), R^{LC11} and R^{LC21} each independently represent an alkyl group having from 1 to 15 carbon atoms, in which one or two or more CH₂ groups in the alkyl group may be substituted by —O—, —CH═CH—, —CO—, —OCO—, —COO—, or —C≡C— in such a manner that oxygen atoms are not directly adjacent to each other, and one or two or more hydrogen atoms in the alkyl group may be arbitrarily substituted by a halogen atom, and A^{LC11} and A^{LC21} each independently represent any of the following structures.

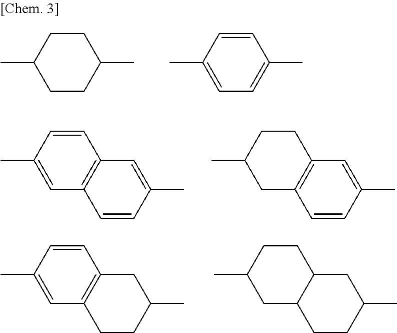

(in the structures, one or two or more CH₂ groups in the cyclohexylene group may be substituted by an oxygen atom, one or two or more CH groups in the 1,4-phenylene group may be substituted by a nitrogen atom, and one or two or more hydrogen atoms in the structures may be substituted by F, Cl, CF₃, or OCF₃), X^{LC11}, X^{LC12}, and X^{LC21} to X^{LC23} each independently represent a hydrogen atom, Cl, F, CF₃, or OCF₃, Y^{LC11} and Y^{LC21} each independently represent a hydrogen atom, Cl, F, CN, CF₃, OCH₂F, OCHF₂, or OCF₃, Z^{LC11} and Z^{LC21} each independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—, and m^{LC11} and m^{LC21} each independently represent an integer of from 1 to 4, in which in the case where plural groups of each of A^{LC11}, A^{LC21}, Z^{LC11}, and Z^{LC21} are present, the groups may be the same as or different from each other.

R^{LC11} and R^{LC21} each independently preferably represent an alkyl group having from 1 to 7 carbon atoms, an alkoxy group having from 1 to 7 carbon atoms, or an alkenyl group having from 2 to 7 carbon atoms, more preferably an alkyl group having from 1 to 5 carbon atoms, an alkoxy group having from 1 to 5 carbon atoms, or an alkenyl group having from 2 to 5 carbon atoms, further preferably a linear group, and most preferably an alkenyl group having the following structures.

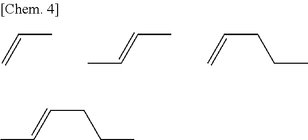

(in the formulae, the ring structure is bonded to the right end thereof)

A^{LC11} and A^{LC21} each independently preferably represent the following structures.

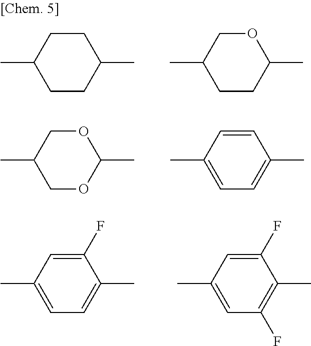

Y^{LC11} and Y^{LC21} each independently preferably represent F, CN, CF₃, or OCF₃, more preferably F or OCF₃, and particularly preferably F.

Z^{LC11} and Z^{LC21} each independently preferably represent a single bond, —CH₂CH₂—, —COO—, —OCO—, —OCH₂—, —CH₂O—, —OCF₂—, or —CF₂O—, preferably a single bond, —CH₂CH₂—, —OCH₂—, —OCF₂—, or —CF₂O—, and more preferably a single bond, —OCH₂—, or —CF₂O—.

m^{LC11} and m^{LC21} each independently preferably represent 1, 2, or 3, preferably 1 or 2 for the case where the storage stability and the responsibility at a low temperature are important, and preferably 2 or 3 in the case where the upper limit value of the upper limit temperature of the nematic phase is improved.

The compound represented by the general formula (LC1) is preferably one kind or two or more kinds of a compound selected from the group of compounds represented by the following general formulae (LC1-a) to (LC1-c).

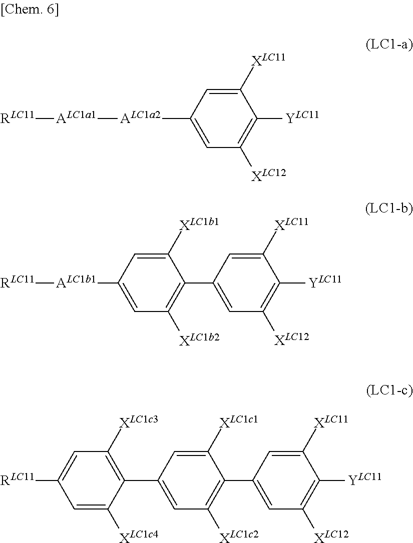

In the formulae, R^{LC11}, Y^{LC11}, X^{LC11}, and X^{LC12} each independently have the same meanings as R^{LC11}, Y^{LC11}, X^{LC11}, and X^{LC12} in the general formula (LC1) respectively, A^{LC1a1}, A^{LC1a2}, and A^{LC1b1} each represent a trans-1,4-cyclohexylene group, a tetrahydropyran-2,5-diyl group, or a 1,3-dioxan-2,5-diyl group, and X^{LC1b1}, X^{LC1b2}, and X^{LC1c1} to X^{LC1c4} each independently represent a hydrogen atom, Cl, F, CF₃, or OCF₃.

R^{LC11} each independently represent an alkyl group having from 1 to 7 carbon atoms, an alkoxy group having from 1 to 7 carbon atoms, or an alkenyl group having from 2 to 7 carbon atoms, and more preferably an alkyl group having from 1 to 5 carbon atoms, an alkoxy group having from 1 to 5 carbon atoms, or an alkenyl group having from 2 to 5 carbon atoms.

X^{LC11} to X^{LC1c4} each independently preferably represent a hydrogen atom or F.

Y^{LC11} each independently represent F, CF₃, or OCF₃.

The compound represented by the general formula (LC1) is preferably one kind or two or more kinds of a compound selected from the group of compounds represented by the following general formulae (LC1-d) to (LC1-m).

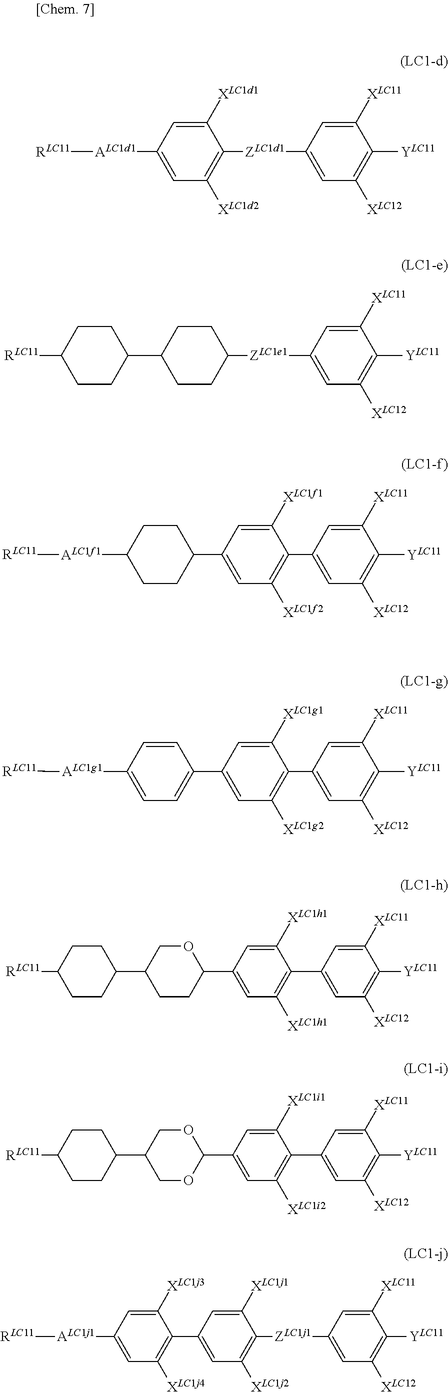

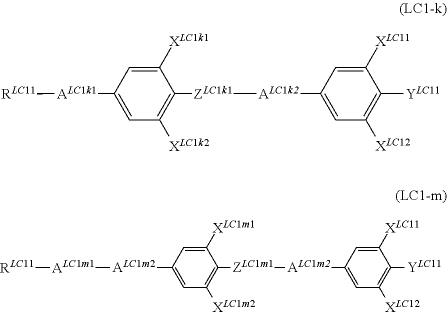

In the formulae, R^{LC11}, Y^{LC11}, X^{LC11}, and X^{LC12} each independently have the same meanings as R^{LC11}, Y^{LC11}, X^{LC11}, and X^{LC12} in the general formula (LC1) respectively, A^{LC1d1}, A^{LC1f1}, A^{LC1g1}, A^{LC1j1}, A^{LC1k1}, A^{LC1k2}, and A^{LC1m1} to A^{LC1m3} each represent a 1,4-phenylene group, a trans-1,4-cyclohexylene group, a tetrahydropyran-2,5-diyl group, or a 1,3-dioxan-2,5-diyl group, X^{LC1d1}, X^{LC1d2}, X^{LC1f1}, X^{LC1f2}, X^{LC1g1}, X^{LC1g2}, X^{LC1h1}, X^{LC1h2}, X^{LC1i1}, X^{LC1i2}, X^{LC1j1}˜X^{LC1j4}, X^{LC1k1}, X^{LC1k2}, X^{LC1m1}, and X^{LC1m2} each independently represent a hydrogen atom, Cl, F, CF₃, or OCF₃, and Z^{LC1d1}, Z^{LC1e1}, Z^{LC1j1}, Z^{LC1k1}, Z^{LC1m1} each independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—.

R^{LC11} each independently represent an alkyl group having from 1 to 7 carbon atoms, an alkoxy group having from 1 to 7 carbon atoms, or an alkenyl group having from 2 to 7 carbon atoms, and more preferably an alkyl group having from 1 to 5 carbon atoms, an alkoxy group having from 1 to 5 carbon atoms, or an alkenyl group having from 2 to 5 carbon atoms.

X^{LC11} to X^{LC1m2} each independently preferably represent a hydrogen atom or F.

Y^{LC11} each independently represent F, CF₃, or OCF₃.

Z^{LC1d1} to Z^{LC1m1} each independently represent —CF₂O— or —OCH₂—.

The compound represented by the general formula (LC2) is preferably one kind or two or more kinds of a compound selected from the group of compounds represented by the following general formulae (LC2-a) to (LC2-g).

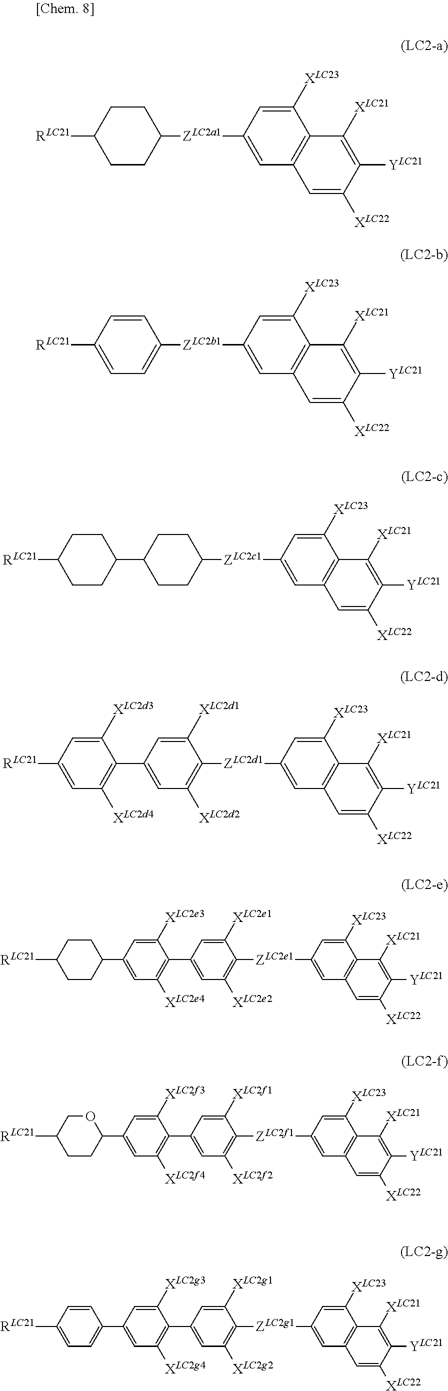

In the formulae, R^{LC21}, Y^{LC21}, and X^{LC21} to X^{LC23} each independently have the same meanings as R^{LC21}, Y^{LC21}, and X^{LC21} to X^{LC23} in the general formula (LC2) respectively, X^{LC2d1} to X^{LC2d4}, X^{LC2e1} to X^{LC2e4}, X^{LC2f1} to X^{LC2f4}, and X^{LC2g1} to X^{LC2g4} each independently represent a hydrogen atom, Cl, F, CF₃, or OCF₃, and Z^{LC2a1}, Z^{LC2b1}, Z^{LC2c1}, Z^{LC2d1}, Z^{LC2e1}, Z^{LC2f1}, and Z^{LC2g1} each independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—.

R^{LC21} each independently represent an alkyl group having from 1 to 7 carbon atoms, an alkoxy group having from 1 to 7 carbon atoms, or an alkenyl group having from 2 to 7 carbon atoms, and more preferably an alkyl group having from 1 to 5 carbon atoms, an alkoxy group having from 1 to 5 carbon atoms, or an alkenyl group having from 2 to 5 carbon atoms.

X^{LC21} to X^{LC2g4} each independently preferably represent a hydrogen atom or F.

Y^{LC21} each independently represent F, CF₃, or OCF₃.

Z^{LC2a1} to Z^{LC2g4} each independently represent —CF₂O— or —OCH₂—.

The compound represented by the general formula (LC) is preferably one kind or two or more kinds of a compound selected from the group of compounds represented by the following general formulae (LC3) to (LC5).

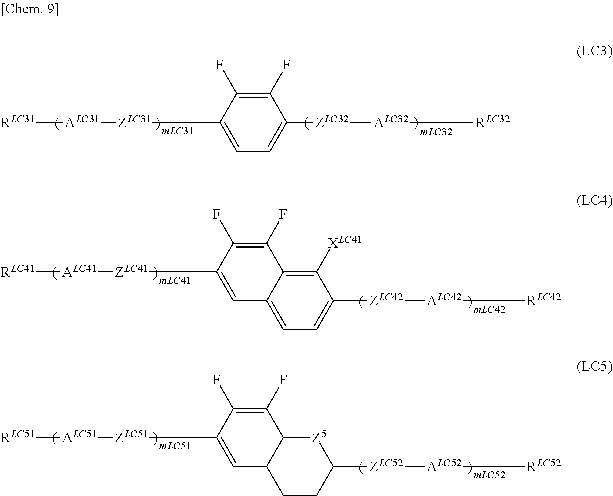

In the formulae, R^{LC31}, R^{LC32}, R^{LC41}, R^{LC42}, R^{LC51}, and R^{LC52} each independently represent an alkyl group having from 1 to 15 carbon atoms, in which one or two or more CH₂ groups in the alkyl group may be substituted by —O—, —CH═CH—, —CO—, —OCO—, —COO—, or —C≡C— in such a manner that oxygen atoms are not directly adjacent to each other, and one or two or more hydrogen atoms in the alkyl group may be arbitrarily substituted by a halogen atom, A^{LC31}, A^{LC32}, A^{LC41}, A^{LC42}, A^{LC51}, and A^{LC52} each independently represent any of the following structures.

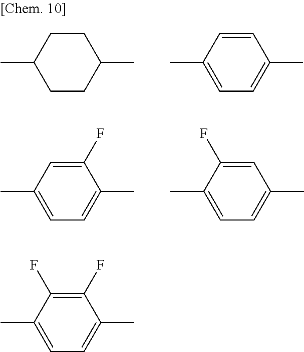

(in the structures, one or two or more CH₂ groups in the cyclohexylene group may be substituted by an oxygen atom, one or two or more CH groups in the 1,4-phenylene group may be substituted by a nitrogen atom, and one or two or more hydrogen atoms in the structures may be substituted by Cl, CF₃, or OCF₃), Z^{LC31}, Z^{LC32}, Z^{LC41}, Z^{LC42}, Z^{LC51}, and Z^{LC51} each independently represent a single bond, —CH═CH—, —C≡C—, —CH₂CH₂—, —(CH₂)₄—, —COO—, —OCH₂—, —CH₂O—, —OCF₂—, or —CF₂O—, Z⁵ represents a CH₂ group or an oxygen atom, X^{LC41} represents a hydrogen atom or a fluorine atom, and m^{LC31}, m^{LC32}, m^{LC41}, m^{LC42}, m^{LC51}, and m^{LC52} each independently represent an integer of from 0 to 3, provided that m^{LC31}+m^{LC32}, m^{LC41}+m^{LC42}, and m^{LC51}+m^{LC52} each are 1, 2, or 3, and in the case where plural groups of each of A^{LC31} to A^{LC52} and Z^{LC31} to Z^{LC52} are present, the groups may be the same as or different from each other.

R^{LC31} to R^{LC52} each independently preferably represent an alkyl group having from 1 to 7 carbon atoms, an alkoxy group having from 1 to 7 carbon atoms, or an alkenyl group having from 2 to 7 carbon atoms, more preferably an alkenyl group having the following structures.

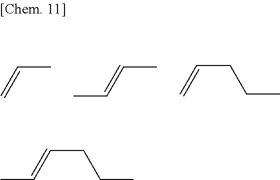

(in the formulae, the ring structure is bonded to the right end thereof)

A^{LC31} and A^{LC52} each independently preferably represent the following structures.

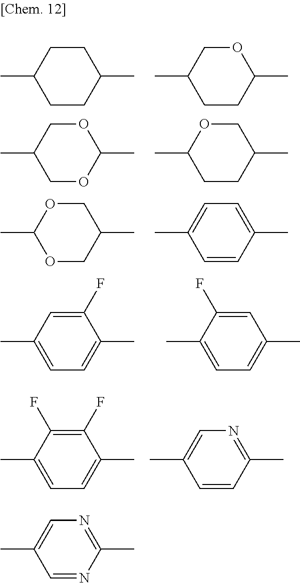

Z^{LC31} to Z^{LC51} each independently preferably represent a single bond, —CH₂O—, —COO—, —OCO—, —CH₂CH₂—, —CF₂O—, —OCF₂—, or —OCH₂—.

The compound represented by the general formula (LC3) is preferably one kind or two or more kinds of a compound selected from the group of compounds represented by the following general formulae (LC3-a) and (LC3-b).

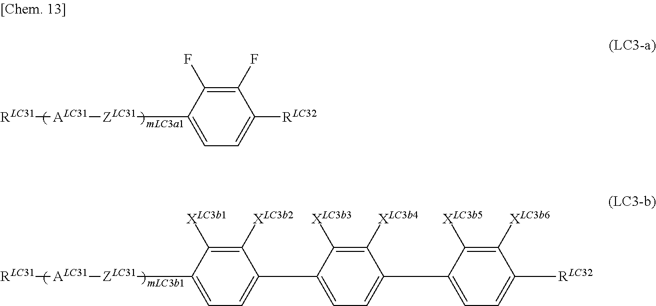

In the formulae, R^{LC31}, R^{LC32}, A^{LC31}, and Z^{LC31} each independently have the same meanings as R^{LC31}, R^{LC32}, A^{LC31}, and Z^{LC31} in the general formula (LC3), X^{LC3b1} to X^{LC3b6} each represent a hydrogen atom or a fluorine atom, provided that at least one of a combination of X^{LC3b1} and X^{LC3b2} and a combination of X^{LC3b3} and X^{LC3b4} represents fluorine atoms, m^{LC3a1} represents 1, 2, or 3, and m^{LC3b1} represents 0 or 1, in which in the case where plural groups of each of A^{LC31} and Z^{LC31} are present, the groups may be the same as or different from each other.

R^{LC31} and R^{LC32} each independently preferably represent an alkyl group having from 1 to 7 carbon atoms, an alkoxy group having from 1 to 7 carbon atoms, an alkenyl group having from 2 to 7 carbon atoms, or an alkenyloxy group having from 2 to 7 carbon atoms.

A^{LC31} preferably represents a 1,4-phenylene group, a trans-1, 4-cyclohexylene group, a tetrahydropyran-2, 5-diyl group, or a 1,3-dioxan-2,5-diyl group, and more preferably a 1,4-phenylene group or a trans-1,4-cyclohexylene group.

Z^{LC31} preferably represents a single bond, —CH₂O—, —COO—, —OCO—, or —CH₂CH₂—, and more preferably a single bond.

The general formula (LC3-a) preferably represents the following general formulae (LC3-a1) to (LC3-a4).

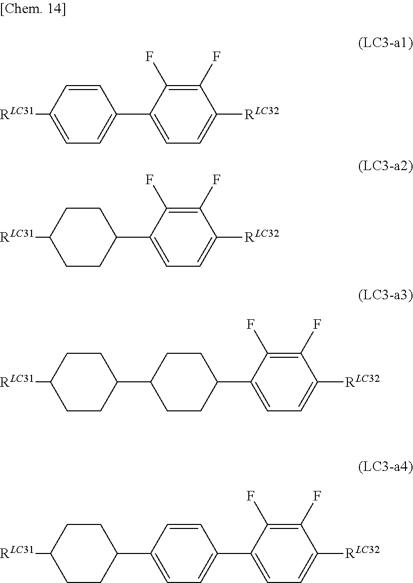

In the formulae, R^{LC31} and R^{LC32} each independently have the same meanings as R^{LC31} and R^{LC32} in the general formula (LC3) respectively.

R^{LC31} and R^{LC32} each independently preferably represent an alkyl group having from 1 to 7 carbon atoms, an alkoxy group having from 1 to 7 carbon atoms, or an alkenyl group having from 2 to 7 carbon atoms, and it is more preferred that R^{LC31} represents an alkyl group having from 1 to 7 carbon atoms, and R^{LC32} represents an alkoxy group having from 1 to 7 carbon atoms.

The general formula (LC3-b) preferably represents the following general formulae (LC3-b1) to (LC3-b12), more preferably the general formulae (LC3-b1), (LC3-b6), (LC3-b8), and (LC3-b11), further preferably the general formulae (LC3-b1) and (LC3-b6), and most preferably the general formula (LC3-b1).

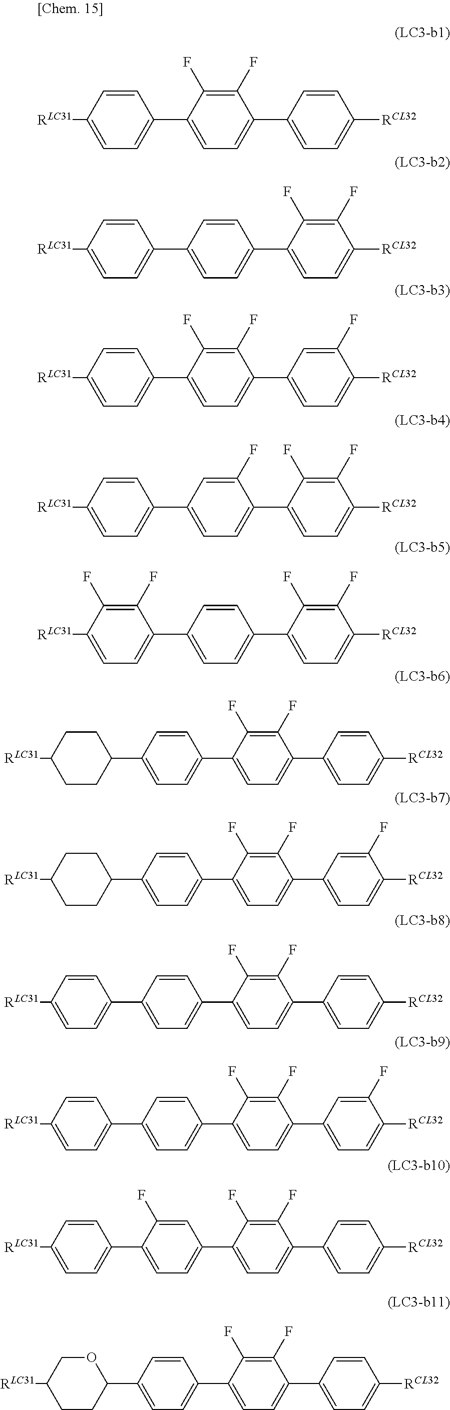

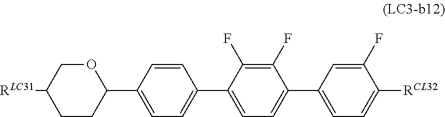

In the formulae, R^{LC31} and R^{LC32} each independently have the same meanings as R^{LC31} and R^{LC32} in the general formula (LC3) respectively.

R^{LC31} and R^{LC32} each independently preferably represent an alkyl group having from 1 to 7 carbon atoms, an alkoxy group having from 1 to 7 carbon atoms, or an alkenyl group having from 2 to 7 carbon atoms, and it is more preferred that R^{LC31} represents an alkyl group having 2 or 3 carbon atoms, and R^{LC32} represents an alkyl group having 2 carbon atoms.

The compound represented by the general formula (LC4) and the compound represented by the general formula (LC5) are preferably one kind or two or more kinds of a compound selected from the group of compounds represented by the following general formulae (LC4-a) to (LC4-c) and one kind or two or more kinds of a compound selected from the group of compounds represented by the following general formulae (LC5-a) to (LC5-c), respectively.

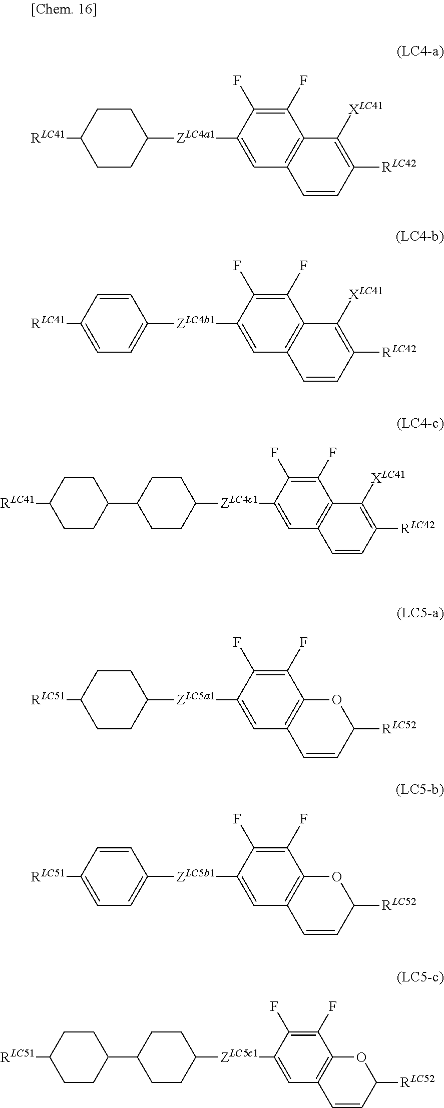

In the formulae, R^{LC41}, R^{LC42}, and X^{LC41} each independently have the same meanings as R^{LC41}, R^{LC42}, and X^{LC41} in the general formula (LC4) respectively, R^{LC51} and R^{LC52} each independently have the same meanings as R^{LC51} and R^{LC52} in the general formula (LC5) respectively, and Z^{LC4a1}, Z^{LC4b1}, Z^{LC4c1}, Z^{LC5a1}, Z^{LC5b1}, and Z^{LC5c1} each independently represent a single bond, —CH═CH—, —C≡C—, —CH₂CH₂—, —(CH₂)₄—, —COO—, —OCH₂—, —CH₂O—, —OCF₂—, or —CF₂O—.

R^{LC41}, R^{LC42}, R^{LC51}, and R^{LC52} each independently preferably represent an alkyl group having from 1 to 7 carbon atoms, an alkoxy group having from 1 to 7 carbon atoms, an alkenyl group having from 2 to 7 carbon atoms, or an alkenyloxy group having from 2 to 7 carbon atoms.

Z^{LC4a1} to Z^{LC5c1} each independently preferably represent a single bond, —CH₂O—, —COO—, —OCO—, or —CH₂CH₂—, and more preferably a single bond.

The compound represented by the general formula (LC) is preferably a liquid crystal composition containing one kind or two or more kinds of a compound represented by the following general formula (LC6).

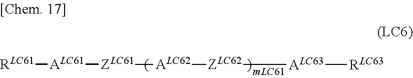

In the formula, R^{LC61} and R^{LC62} each independently represent an alkyl group having from 1 to 15 carbon atoms, in which one or two or more CH₂ groups in the alkyl group may be substituted by —O—, —CH═CH—, —CO—, —OCO—, —COO—, or —C≡C— in such a manner that oxygen atoms are not directly adjacent to each other, and one or two or more hydrogen atoms in the alkyl group may be arbitrarily substituted by a halogen atom, and A^{LC61} to A^{LC63} each independently represent any of the following

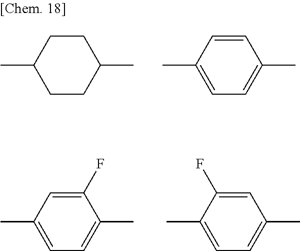

(in the structures, one or two or more CH₂CH₂ groups in the cyclohexylene group may be substituted by —CH═CH—, —CF₂O—, or —OCF₂—, one or two or more CH groups in the 1, 4-phenylene group may be substituted by a nitrogen atom, and Z^{LC61} and Z^{LC62} each independently represent a single bond, —CH═CH—, —C≡C—, —CH₂CH₂—, —(CH₂)₄—, —COO—, —OCH₂—, —CH₂O—, —OCF₂—, or —CF₂O—, and mⁱⁱⁱ¹ represents from 0 to 3, provided that the compounds represented by the general formulae (LC1) to (LC6) are excluded.

R^{LC61} and R^{LC62} each independently preferably represent an alkyl group having from 1 to 7 carbon atoms, an alkoxy group having from 1 to 7 carbon atoms, or an alkenyl group having from 2 to 7 carbon atoms, more preferably an alkenyl group having the following structures.

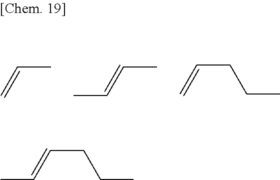

(in the formulae, the ring structure is bonded to the right end thereof)

A^{LC61} to A^{LC63} each independently preferably represent the following structures.

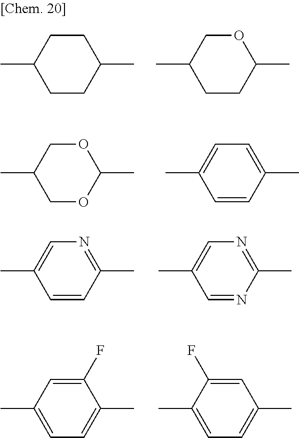

Z^{LC61} and Z^{LC62} each independently preferably represent a single bond, —CH₂CH₂—, —COO—, —OCH₂—, —CH₂O—, —OCF₂—, or —CF₂O—.

The compound represented by the general formula (LC6) is preferably one kind or two or more kinds of a compound represented by the following general formulae (LC6-a) to (LC6-m).

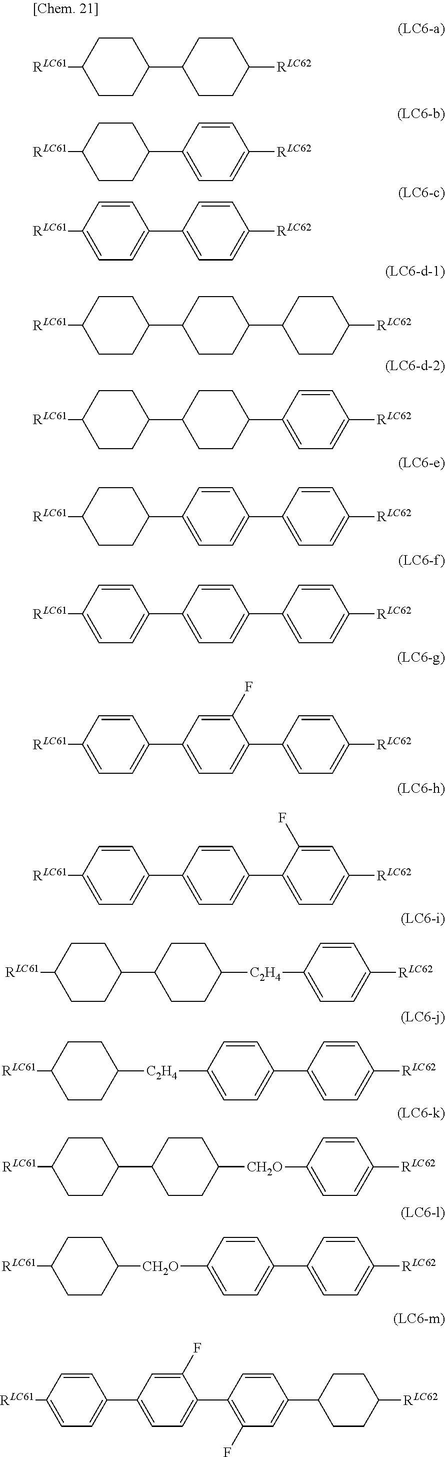

In the formulae, R^{LC61} and R^{LC62} each independently represent an alkyl group having from 1 to 7 carbon atoms, an alkoxy group having from 1 to 7 carbon atoms, an alkenyl group having from 2 to 7 carbon atoms, or an alkenyloxy group having from 2 to 7 carbon atoms.

The liquid crystal medium used in the liquid crystal layer in the invention may be a polymer stabilized liquid crystal composition by adding a polymerizable compound thereto. The polymer stabilized liquid crystal composition is preferably obtained by adding a monomer as a precursor of the polymer component to a nematic liquid crystal composition. The monomer may be at least one polymerizable compound (II) selected from the group of compounds represented by the following general formulae (II-a), (II-b), and (II-c).

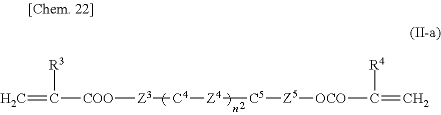

In the formula (II-a), R³ and R⁴ each independently represent a hydrogen atom or a methyl group,

C⁴ and C⁵ each independently represent a 1,4-phenylene group, a 1,4-cyclohexylene group, a pyridin-2,5-diyl group, a pyrimidin-2,5-diyl group, a pyridazin-3,6-diyl group, a 1,3-dioxan-2,5-diyl group, a cyclohexen-1,4-diyl group, a decahydronaphthalen-2,6-diyl group, a 1,2,3,4-tetrahydronaphthalen-2,6-diyl group, a 2,6-naphthylene group, or an indan-2,5-diyl group (in which among these groups, a 1,4-phenylene group, a 1,2,3,4-tetrahydronaphthalen-2,6-diyl group, a 2,6-naphthylene group, and an indan-2,5-diyl group may be unsubstituted or may have one or two or more of a fluorine atom, a chlorine atom, a methyl group, a trifluoromethyl group, or a trifluoromethoxy group, as a substituent),

Z³ and Z⁵ each independently represent a single bond or an alkylene group having from 1 to 15 carbon atoms (in which one or two or more methylene groups present in the alkylene group each independently may be substituted by an oxygen atom, —CO—, —COO—, or —OCO—, provided that oxygen atoms are not bonded directly to each other, and one or two or more hydrogen atoms present in the alkylene group each independently may be substituted by a fluorine atom, a methyl group, or an ethyl group),

Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—, and

n² represents 0, 1, or 2, provided that when n² represents 2, plural groups represented by C⁴ and Z⁴ each may be the same as or different from each other.

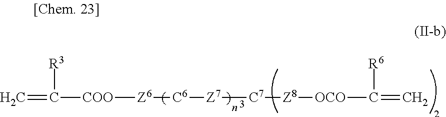

In the formula (II-b), R⁵ and R⁶ each independently represent a hydrogen atom or a methyl group,

C⁶ represents a 1,4-phenylene group, a 1,4-cyclohexylene group, a pyridin-2,5-diyl group, a pyrimidin-2,5-diyl group, a pyridazin-3,6-diyl group, a 1,3-dioxan-2,5-diyl group, a cyclohexen-1,4-diyl group, a decahydronaphthalen-2,6-diyl group, a 1,2,3,4-tetrahydronaphthalen-2,6-diyl group, a 2,6-naphthylene group, or an indan-2,5-diyl group (in which among these groups, a 1,4-phenylene group, a 1,2,3,4-tetrahydronaphthalen-2,6-diyl group, a 2,6-naphthylene group, and an indan-2,5-diyl group may be unsubstituted or may have one or two or more of a fluorine atom, a chlorine atom, a methyl group, a trifluoromethyl group, or a trifluoromethoxy group, as a substituent),

C⁷ represents a benzen-1,2,4-triyl group, a benzen-1,3,4-triyl group, a benzen-1,3,5-triyl group, a cyclohexan-1,2,4-triyl group, a cyclohexan-1, 3,4-triyl group, or a cyclohexan-1,3,5-triyl group,

Z⁶ and Z⁸ each independently represent a single bond or an alkylene group having from 1 to 15 carbon atoms (in which one or two or more methylene groups present in the alkylene group each independently may be substituted by an oxygen atom, —CO—, —COO—, or —OCO—, provided that oxygen atoms are not bonded directly to each other, and one or two or more hydrogen atoms present in the alkylene group each independently may be substituted by a fluorine atom, a methyl group, or an ethyl group),

Z⁷ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—, and

n³ represents 0, 1, or 2, provided that when n³ represents 2, plural groups represented by C⁶ and Z⁷ each may be the same as or different from each other.

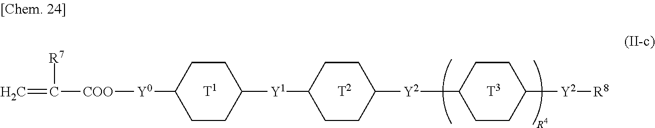

In the formula (II-c), R⁷ represents a hydrogen atom or a methyl group,

the six-membered rings T¹, T², and T³ each independently represent

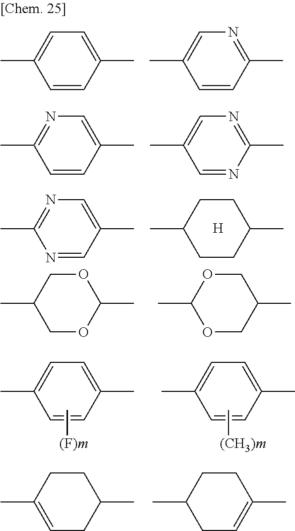

(wherein m represents an integer of from 1 to 4),

n⁴ represents an integer of 0 or 1,

Y⁰, Y¹, and Y² each independently represent a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CHCH₂CH₂—, or —CH₂CH₂CH═CH—,

Y³ represents a single bond, —O—, —COO—, or —OCO—, and

R⁸ represents a hydrogen atom, a halogen atom, a cyano group, an alkyl group having from 1 to 20 carbon atoms, an alkenyl group having from 1 to 20 carbon atoms, an alkoxy group having from 1 to 20 carbon atoms, or a hydrocarbon group having from 1 to 20 carbon atoms.

In the liquid crystal medium in the invention, various additives, such as a light stabilizer, such as HALS, a benzotriazole or benzophenone light absorbent, and a hindered phenol antioxidant, may be used for preventing an unexpected adverse effect to the liquid crystal layer which may caused by light irradiation.

### Optical Anisotropy Molecule Obtained by Curing Polymerizable Liquid Crystal Compound and Polymer Liquid Crystal Capable of Undergoing Phase Transition

### Optical Anisotropy Molecule

The optical anisotropy molecule in the invention is obtained by curing a polymerizable liquid crystal compound, and preferably contains a molecule exhibiting optical anisotropy, and more preferably contains a polymer exhibiting optical anisotropy. Specifically, the optical anisotropy molecule in the invention is preferably a polymer obtained from a polymerizable liquid crystal compound (which may also be referred to as a liquid crystal compound capable of being polymerized), and more preferably a polymer obtained from the compound represented by the general formula (II) described later, as a component constituting the optical anisotropy layer. The optical anisotropy layer may also be obtained from a polymerizable liquid crystal composition having a liquid crystal compound capable of being polymerized.

The liquid crystal compound capable of being polymerized used in the invention is not particularly limited as far as the compound exhibits liquid crystal property by itself or as a composition with another compound, and has at least one polymerizable functional group, and known ordinary compounds may be used.

Examples thereof include the rod-like polymerizable liquid crystal compound having a rigid moiety referred to as a mesogenic moiety containing plural structures, such as a 1,4-phenylene group and a 1,4-cyclohexylene group, bonded to each other, and a polymerizable functional group, such as a vinyl group, an acrylic group, or a (meth)acrylic group, described in Handbook of Liquid Crystals (edited by D. Demus, J. W. Goodby, G. W. Gray, H. W. Spiess, and V. Vill, published by Wiley-VCH (1998)), Kikan Kagaku Sousetsu (Quarterly Chemical Review), No. 22, Chemistry of Liquid Crystal (edited by The Chemical Society of Japan (1994), JP-A-7-294735, JP-A-8-3111, JP-A-8-29618, JP-A-11-80090, JP-A-11-116538, JP-A-11-148079, and the like, and a rod-like liquid crystal compound having a maleimide group described in JP-A-2004-2373 and JP-A-2004-99446. Among these, a rod-like liquid crystal compound having a polymerizable group is preferred since the liquid crystal compound having a liquid crystal temperature range that includes a low temperature around room temperature can be easily produced.

Specifically, the polymerizable liquid crystal compound as the liquid crystal compound contained in the liquid crystal layer in the invention is preferably a compound represented by the following general formula (II).

[Chem. 26]

P²—(S¹—X¹)_{q1}-MG-R² (II)

In the formula, P² represents a polymerizable functional group, S¹ represents an alkylene group having from 1 to 18 carbon atoms (in which the hydrogen atom in the alkylene group may be substituted by one or more of a halogen atom, a CN group, or an alkyl group having a polymerizable functional group having from 1 to 8 carbon atoms, and one CH₂ group or two or more CH₂ groups that are not adjacent to each other in the group may be substituted by —O—, —COO—, —OCO—, or —OCO—O—), X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²—S¹ and S¹—X¹ do not contain —O—O—, —O—NH—, —S—S—, and —O—S—), q1 represents 0 or 1, MG represents a mesogenic group, and R² represents a hydrogen atom, a halogen atom, a cyano group, or a linear or branched alkyl group having from 1 to 12 carbon atoms, in which the alkyl group may be linear or branched, one CH₂ group or two or more CH₂ groups that are not adjacent to each other in the alkyl group each may be independently substituted by —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or R² represents the general formula (II-a)

[Chem. 27]

—(X²—S²)_{q2}—P³ (II-a)

(in the formula, P³ represents a polymerizable functional group, S² represents the same group as defined by S¹, X² represents the same group as defined by X¹ (provided that P³—S² and S²—X² do not contain —O—O—, —O—NH—, —S—S—, and —O—S— groups), and q² represents 0 or 1), and the mesogenic group represented by MG represents the general formula (II-b).

[Chem. 28]

—(B1-Z1)ᵣ₁-B2-Z2-B3- (II-b)

In the formula, B1, B2, and B3 each independently represent a 1,4-phenylene group, a 1,4-cyclohexylene group, a 1,4-cyclohexenyl group, a tetrahydropyran-2,5-diyl group, a 1,3-dioxan-2,5-diyl group, a tetrahydrothiopyran-2,5-diyl group, a 1,4-bicyclo(2.2.2)octylene group, a decahydronaphthalen-2,6-diyl group, a pyridin-2,5-diyl group, a pyrimidin-2,5-diyl group, a pyrazin-2,5-diyl group, a thiophen-2,5-diyl group, a 1,2,3,4-tetrahydronaphthalen-2,6-diyl group, a 2,6-naphthylene group, a phenanthren-2,7-diyl group, a 9,10-dihydrophenanthren-2,7-diyl group, a 1,2,3,4,4a,9,10a-octahydrophenanthren-2,7-diyl group, a 1,4-naphthylene group, a benzo[1,2-b:4,5-b′]dithiophen-2,6-diyl group, a benzo[1,2-b:4,5-b′]diselenophen-2,6-diyl group, a [l]benzothieno[3,2-b]thiophen-2,7-diyl group, a [l]benzoselenopheno[3,2-b]selenophen-2,7-diyl group, or a fluoren-2, 7-diyl group, which may have, as a substituent, one or more of F, Cl, CF₃, OCF₃, CN, an alkyl group having from 1 to 8 carbon atoms, an alkoxy group having from 1 to 8 carbon atoms, an alkanoyl group having from 1 to 8 carbon atoms, an alkanoyloxy group having from 1 to 8 carbon atoms, an alkoxycarbonyl group having from 1 to 8 carbon atoms, an alkenyl group having from 2 to 8 carbon atoms, an alkenyloxy group having from 2 to 8 carbon atoms, an alkenoyl group having from 2 to 8 carbon atoms, an alkenoyloxy group having from 2 to 8 carbon atoms, and/or the general formula (II-c)

[Chem. 29]

—(X³)_{q4}—(S³)_{q3}—P⁴ (II-c)

(in the formula, P⁴ represents a polymerizable functional group, S³ represents the same group as defined by S¹, X³ represents —O—, —COO—, —OCO—, —OCH₂—, —CH₂O—, —CH₂CH₂OCO—, —COOCH₂CH₂—, —OCOCH₂CH₂—, or a single bond, q³ represents 0 or 1, q⁴ represents 0 or 1 (provided that P⁴—S³ and S³—X³ do not contain —O—O—, —O—NH—, —S—S—, and —O—S— groups)), Z1 and Z2 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having from 2 to 10 carbon atoms, which may have a halogen atom, or a single bond, and r1 represents 0, 1, 2, or 3, in which plural groups represented by each of B1 and Z1 are present, the plural groups may be the same as or different from each other.

P², P³, and P⁴ each independently preferably represent a substituent selected from polymerizable groups represented by the following formulae (P-2-1) to (P-2-20).

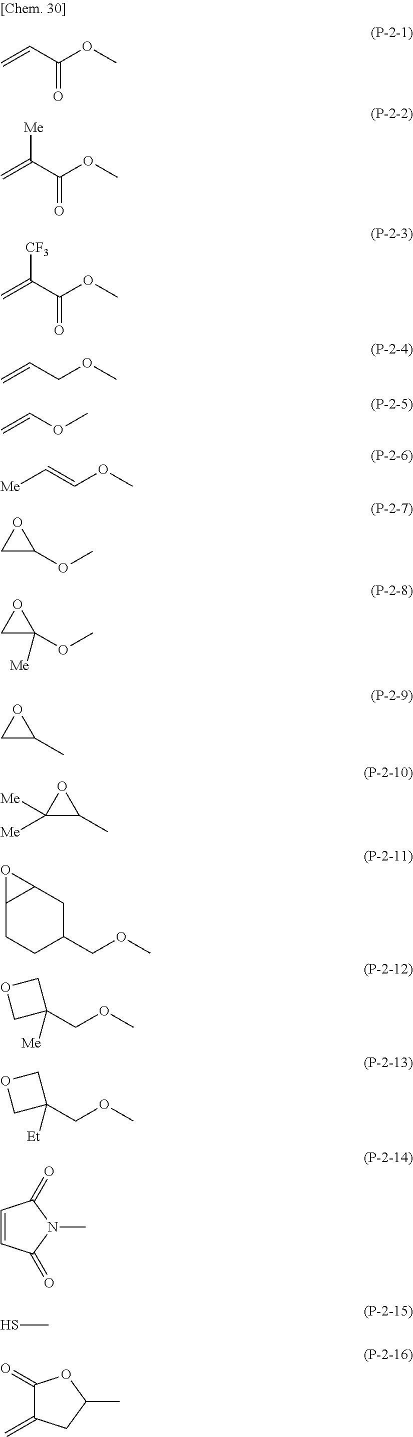

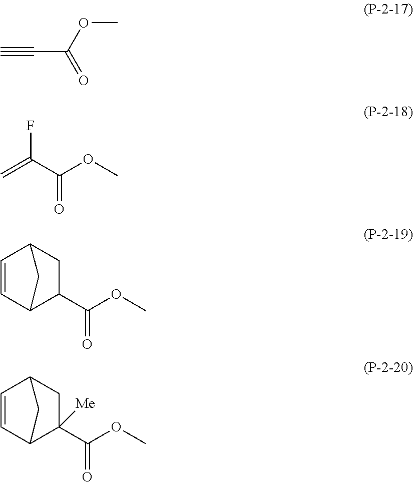

In these polymerizable functional groups, the formulae (P-2-1), (P-2-2), (P-2-7), (P-2-12), and (P-2-13) are preferred, and the formulae (P-2-1) and (P-2-2) are more preferred from the viwepoint of improving the polymerization.

In the compound represented by the general formula (II), a compound represented by the following general formula (II-2-1) is preferred as the monofunctional polymerizable liquid crystal compound having one polymerizable functional group in the molecule thereof.

[Chem. 31]

P²—(S¹—X¹)_{q1}-MG-R²¹ (II-2-1)

In the formula, P², S¹, X¹, q1, and MG each represent the same meaning as defined in the general formula (II), and R²¹ represents a hydrogen atom, a halogen atom, or a cyano group, or represents a linear or branched alkyl group having from 1 to 12 carbon atoms or a linear or branched alkenyl group having from 1 to 12 carbon atoms, in which one —CH₂— or two or more —CH₂— groups that are not adjacent to each other in the groups each may be independently substituted by —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, and one or two or more hydrogen atoms of the alkyl group and the alkenyl group may be substituted by a halogen atom or a cyano group, in which in the case where plural hydrogen atoms are substituted, the substituents may be the same as or different from each other. Examples of the general formula (II-2-1) include compounds represented by the following general formulae (II-2-1-1) to (II-2-1-4), but the compound is not limited to the following general formulae.

[Chem. 32]

P²—(S¹—X¹)_{q1}—B2-Z2-B3-R²¹ (II-2-1-1)

P²—(S¹—X¹)_{q1}—B11-Z11-B2-Z2-B3-R²¹ (II-2-1-2)

P²—(S¹—X¹)_{q1}—B11-Z11-B12-Z12-B2-Z2-B3-R²¹ (II-2-1-3)

P²—(S¹—X¹)_{q1}—B11-Z11-B12-Z12-B13-Z13-B2-Z2-B3-R²¹ (II-2-14)

In the formulae, P², S¹, X¹, and q1 each represent the same meaning as defined in the general formula (II),

B11, B12, B13, B2, and B3 each represent the same group as defined by B1 to B3 in the general formula (II-b), which may be the same as or different from each other,

Z11, Z12, Z13, and Z2 each represent the same group as defined by Z1 to Z3 in the general formula (II-b), which may be the same as or different from each other,

R²¹ represents a hydrogen atom, a halogen atom, or a cyano group, or represents a linear or branched alkyl group having from 1 to 12 carbon atoms or a linear or branched alkenyl group having from 1 to 12 carbon atoms, in which one —CH₂— or two or more —CH₂— groups that are not adjacent to each other in the groups each may be independently substituted by —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, and one or two or more hydrogen atoms of the alkyl group and the alkenyl group may be substituted by a halogen atom or a cyano group, in which in the case where plural hydrogen atoms are substituted, the substituents may be the same as or different from each other.

Examples of the compound represented by the general formulae (II-2-1-1) to (II-2-1-4) include compounds represented by the following formulae (II-2-1-1-1) to (II-2-1-1-26), but the compound is not limited thereto.

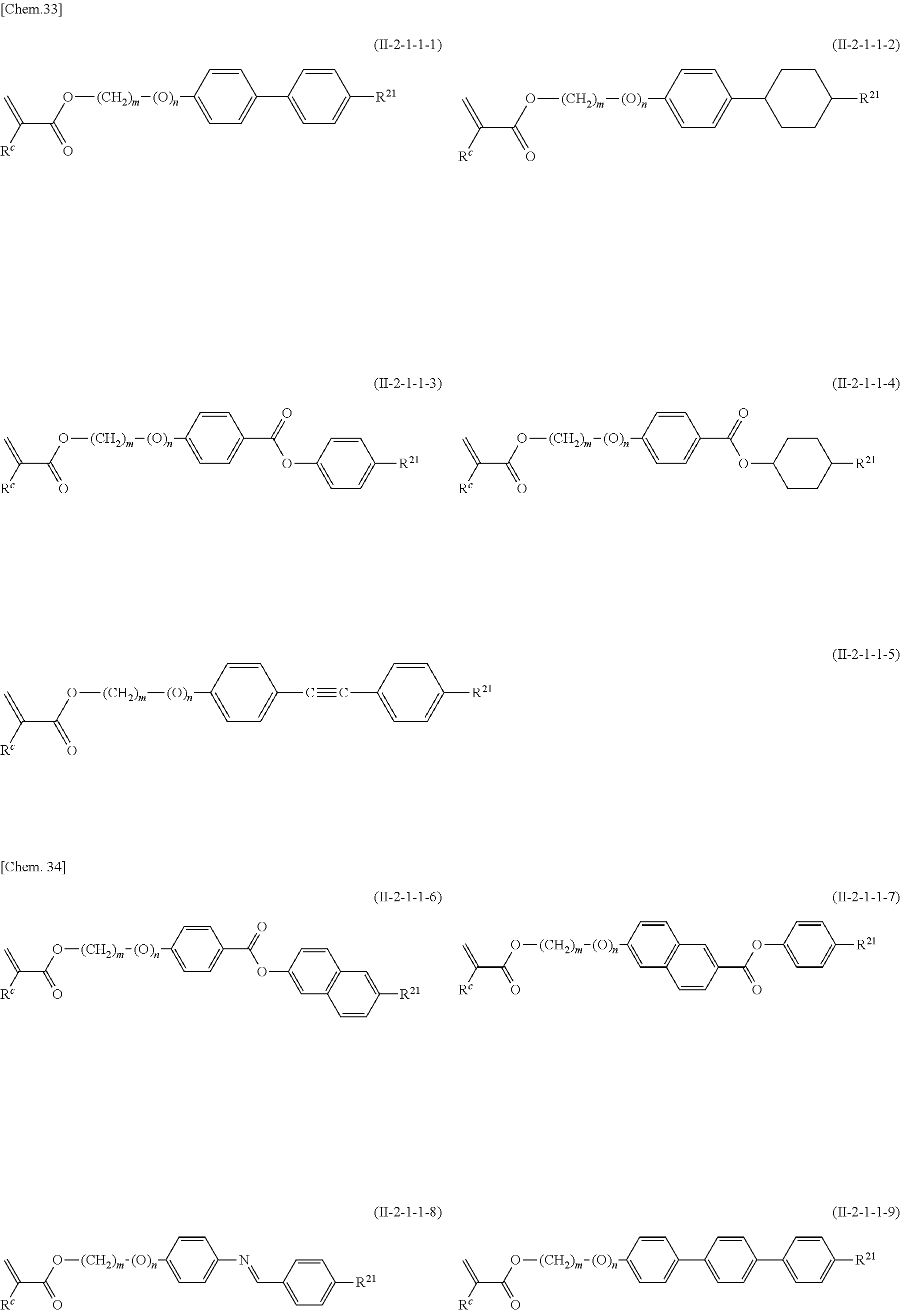

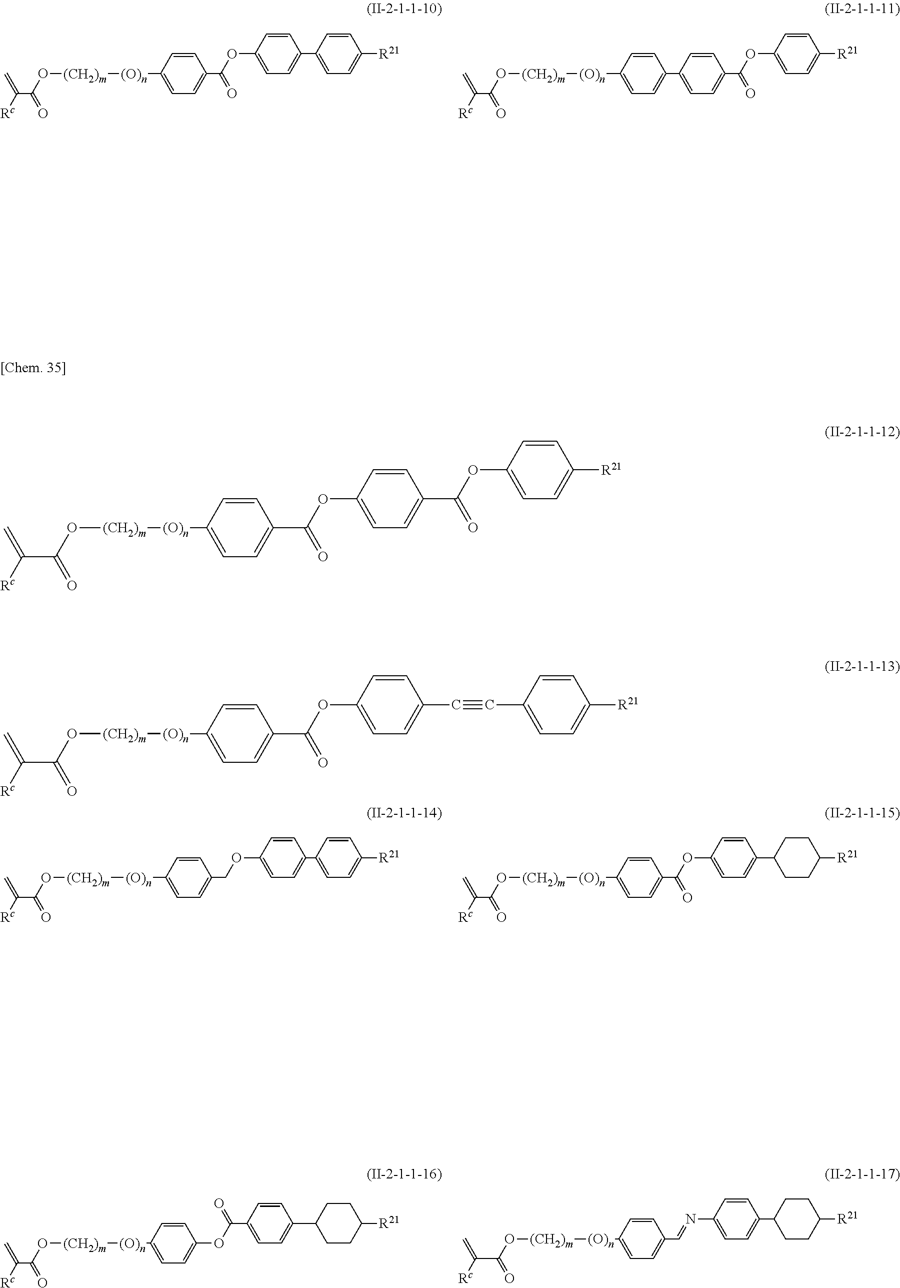

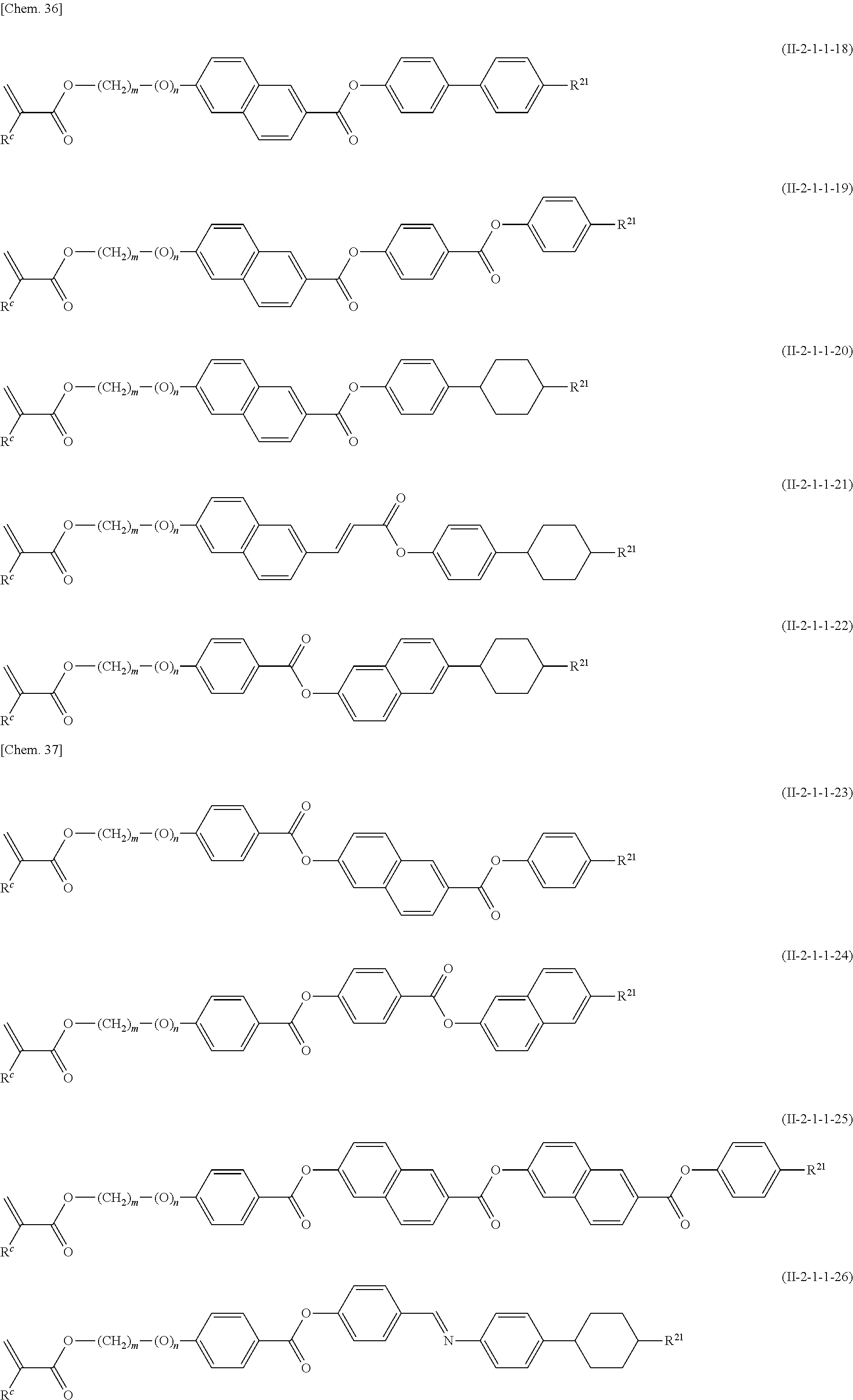

In the formulae, R^{c} represents a hydrogen atom or a methyl group, m represents an integer of from 0 to 18, n represents 0 or 1, R²¹ represents the same group as defined in the general formulae (II-2-1-1) to (II-2-1-4), provided that in R²¹, a hydrogen atom, a halogen atom, a cyano group, or one —CH₂— may be substituted by —O—, —CO—, —COO—, or —OCO—, preferably represents a linear alkyl group having from 1 to 6 carbon atoms or a linear alkenyl group having from 1 to 6 carbon atoms, in which the cyclic group may have, as a substituent, one or more of F, Cl, CF₃, OCF₃, CN, an alkyl group having from 1 to 8 carbon atoms, an alkoxy group having from 1 to 8 carbon atoms, an alkanoyl group having from 1 to 8 carbon atoms, an alkanoyloxy group having from 1 to 8 carbon atoms, an alkoxycarbonyl group having from 1 to 8 carbon atoms, an alkenyl group having from 2 to 8 carbon atoms, an alkenyloxy group having from 2 to 8 carbon atoms, an alkenoyl group having from 2 to 8 carbon atoms, an alkenoyloxy group having from 2 to 8 carbon atoms.

The total content of the monofunctional polymerizable liquid crystal compound having one polymerizable functional group in the molecule thereof is preferably from 0 to 90% by mass, more preferably from 5 to 85% by mass, and particularly preferably from 10 to 80% by mass, based on the total amount of the polymerizable liquid crystal compound used. In the case where the alignment of the optical anisotropy material is important, the lower limit thereof is preferably 10% by mass or more, and more preferably 20% by mass or more, and in the case where the rigidity is important, the upper limit thereof is preferably 80% by mass or less, and more preferably 70% by mass or less.

In the compound represented by the general formula (II), a compound represented by the following general formula (II-2-2) is preferred as the bifunctional polymerizable liquid crystal compound having two polymerizable functional groups in the molecule thereof.

[Chem. 38]

P²—(S¹—X¹)_{q1}-MG-(X²—S²)_{q2}—P³ (II-2-2)

In the formula, P², S¹, X¹, q1, MG, X², S², q2, and P³ each represent the same meaning as defined in general formula (II). Examples of the general formula (II-2-2) include compounds represented by the following general formulae (II-2-2-1) to (II-2-2-4), but the compound is not limited to the general formulae.

[Chem. 39]

P²—(S¹—X¹)_{q1}—B2-Z2-B3-(X²—S²)_{q2}—P³ (II-2-2-1)

P²—(S¹—X¹)_{q1}—B11-Z11-B2-Z2-B3-(X²—S²)_{q2}—P³ (II-2-2-2)

P²—(S¹—X¹)_{q1}—B11-Z11-B12-Z12-B2-Z2-B3-(X²—S²)_{q2}—P³ (II-2-2-3)

P²—(S¹—X¹)_{q1}—B11-Z11-B12-Z12-B13-Z13-B2-Z2-B3-(X²—S²)_{q2}—P³ (II-2-2-4)

In the formulae, P², S¹, X¹, q1, MG, X², S², q2, and P³ each represent the same meaning as defined in general formula (II),

B11, B12, B13, B2, and B3 each represent the same group as defined by B1 to B3 in the general formula (II-b), which may be the same as or different from each other, and

Z11, Z12, Z13, and Z2 each represent the same group as defined by Z1 to Z3 in the general formula (II-b), which may be the same as or different from each other.

In the compound represented by the general formulae (II-2-2-1) to (II-2-2-4), the use of the compound having three or more ring structures therein represented by the general formulae (II-2-2-2) to (II-2-2-4) is preferred since excellent alignment property can be obtained, and the use of the compound having three or more ring structures therein represented by the general formula (II-2-2-2) is particularly preferred.

Examples of the compound represented by the general formulae (II-2-2-1) to (II-2-2-4) include compounds represented by the following formulae (II-2-2-1-1) to (II-2-2-1-21), but the compound is not limited thereto.

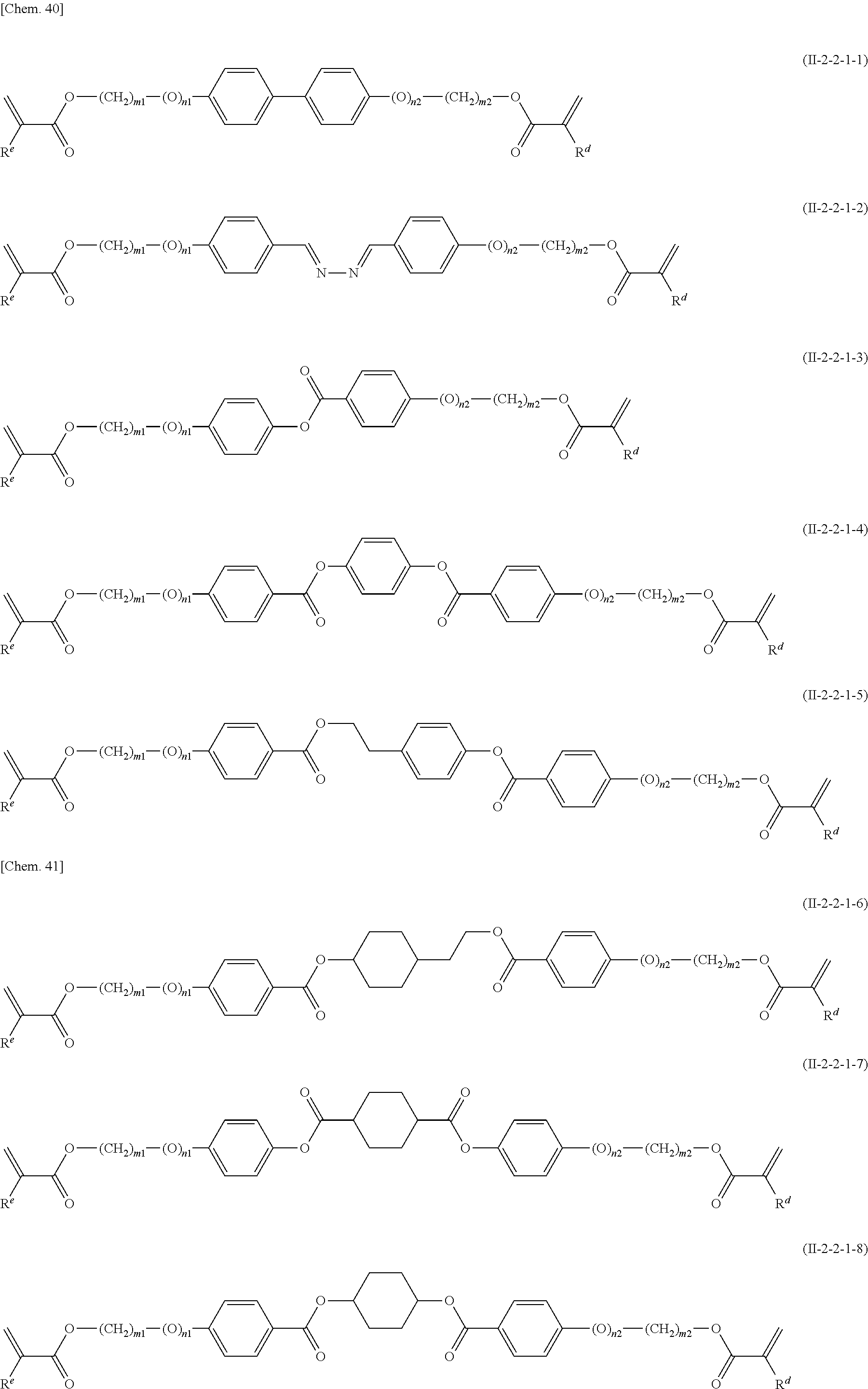

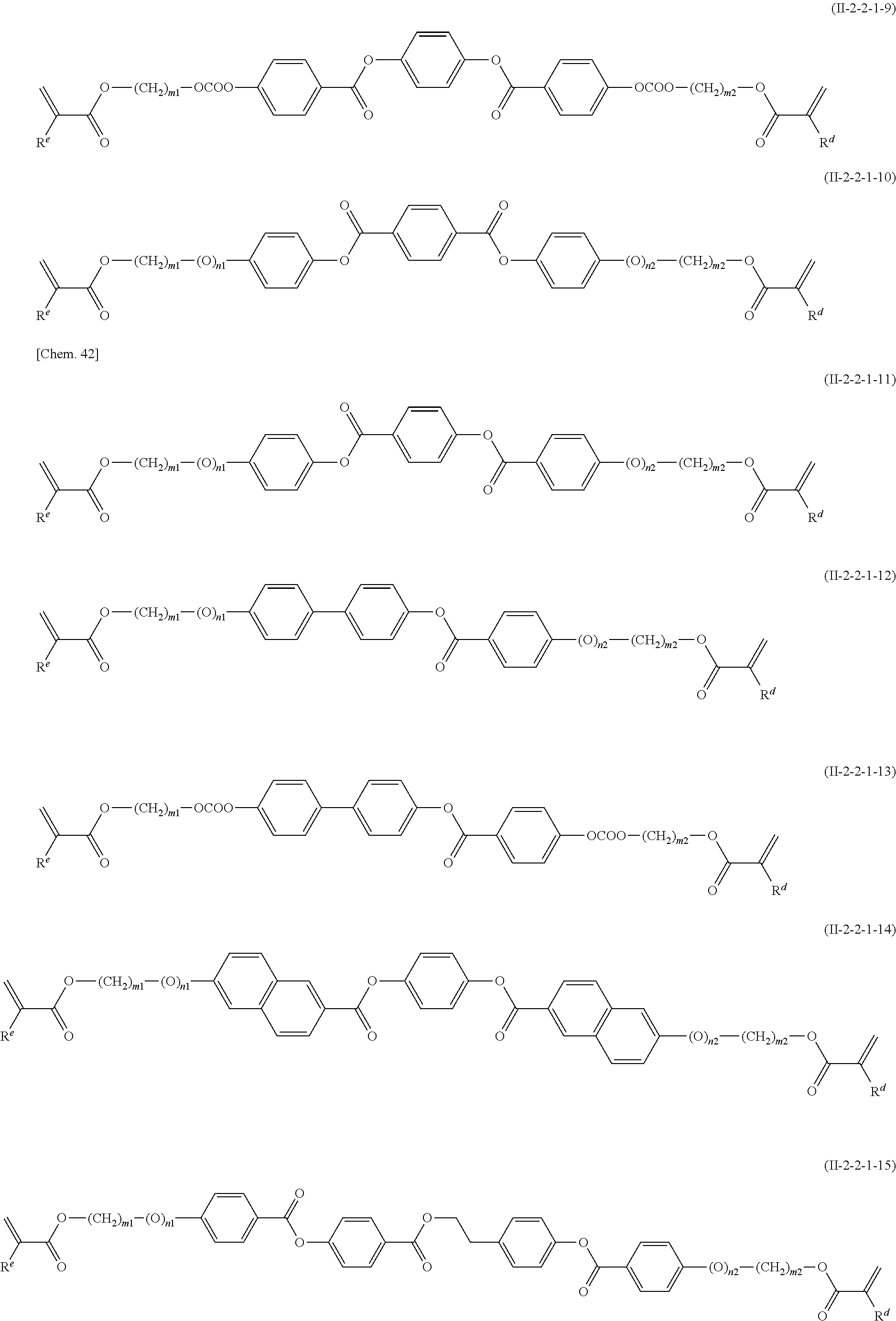

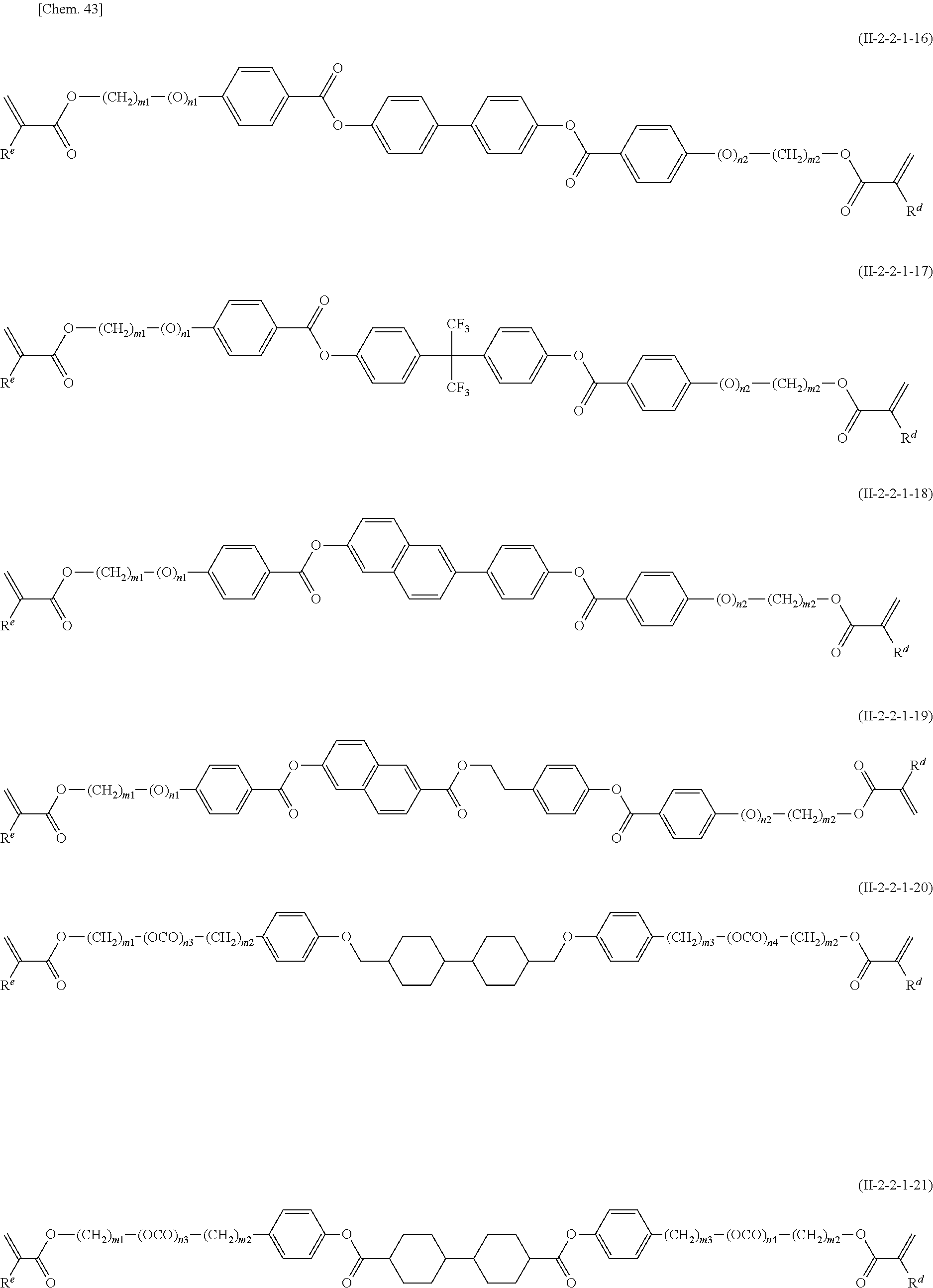

In the formulae, R^{d} and R^{e} each independently represent a hydrogen atom or a methyl group, the cyclic group may have, as a substituent, one or more of F, Cl, CF₃, OCF₃, CN, an alkyl group having from 1 to 8 carbon atoms, an alkoxy group having from 1 to 8 carbon atoms, an alkanoyl group having from 1 to 8 carbon atoms, an alkanoyloxy group having from 1 to 8 carbon atoms, an alkoxycarbonyl group having from 1 to 8 carbon atoms, an alkenyl group having from 2 to 8 carbon atoms, an alkenyloxy group having from 2 to 8 carbon atoms, an alkenoyl group having from 2 to 8 carbon atoms, an alkenoyloxy group having from 2 to 8 carbon atoms. m1 and m2 each independently represent an integer of from 0 to 18, and n1, n2, n3, and n4 each independently represent 0 or 1.

While the liquid crystal compound having two polymerizable functional groups may be used solely, or two or more thereof may be used, from 1 to 5 kinds thereof are preferably used, and from 2 to 5 kinds thereof are more preferably used.

The total content of the bifunctional polymerizable liquid crystal compound having two polymerizable functional groups in the molecule thereof is preferably from 0 to 90% by mass, more preferably from 10 to 85% by mass, and particularly preferably from 15 to 80% by mass, based on the total amount of the polymerizable liquid crystal compound used. In the case where the rigidity is important, the lower limit thereof is preferably 30% by mass or more, and more preferably 50% by mass or more, and in the case where the alignment of the optical anisotropy material is important, the upper limit thereof is preferably 80% by mass or less, and more preferably 70% by mass or less.

As the polyfunctional polymerizable liquid crystal compound having three or more polymerizable functional groups used is preferably a compound having three polymerizable functional group. In the compound represented by the general formula (II), a compound represented by the following general formula (II-2-3) is preferred as the polyfunctional polymerizable liquid crystal compound having three polymerizable functional group in the molecule thereof.

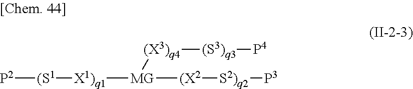

In the formula, P², S¹, X¹, q1, MG, X², S², q2, P³, X³, q4, S³, q3, and P⁴ each represent the same meaning as defined in the general formula (II). Examples of the general formula (II-2-3) include compounds represented by the following general formulae (II-2-3-1) to (II-2-3-8), but the compound is not limited to the general formulae.

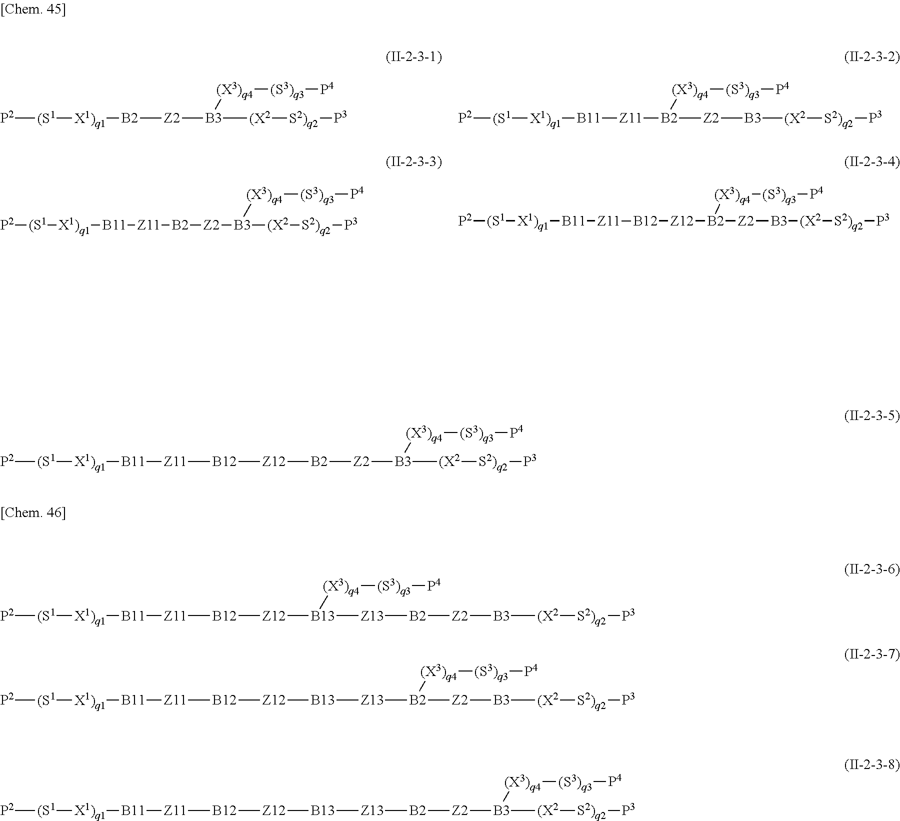

In the formulae, P², S¹, X¹, q1, MG, X², S², q2, P³, X³, q4, S³, q3, and P⁴ each represent the same meaning as defined in general formula (II),

B11, B12, B13, B2, and B3 each represent the same group as defined by B1 to B3 in the general formula (II-b), which may be the same as or different from each other, and

Z11, Z12, Z13, and Z2 each represent the same group as defined by Z1 to Z3 in the general formula (II-b), which may be the same as or different from each other.

Examples of the compound represented by the general formulae (II-2-3-1) to (II-2-3-8) include compounds represented by the following formulae (II-2-3-1-1) to (II-2-3-1-6), but the compound is not limited thereto.

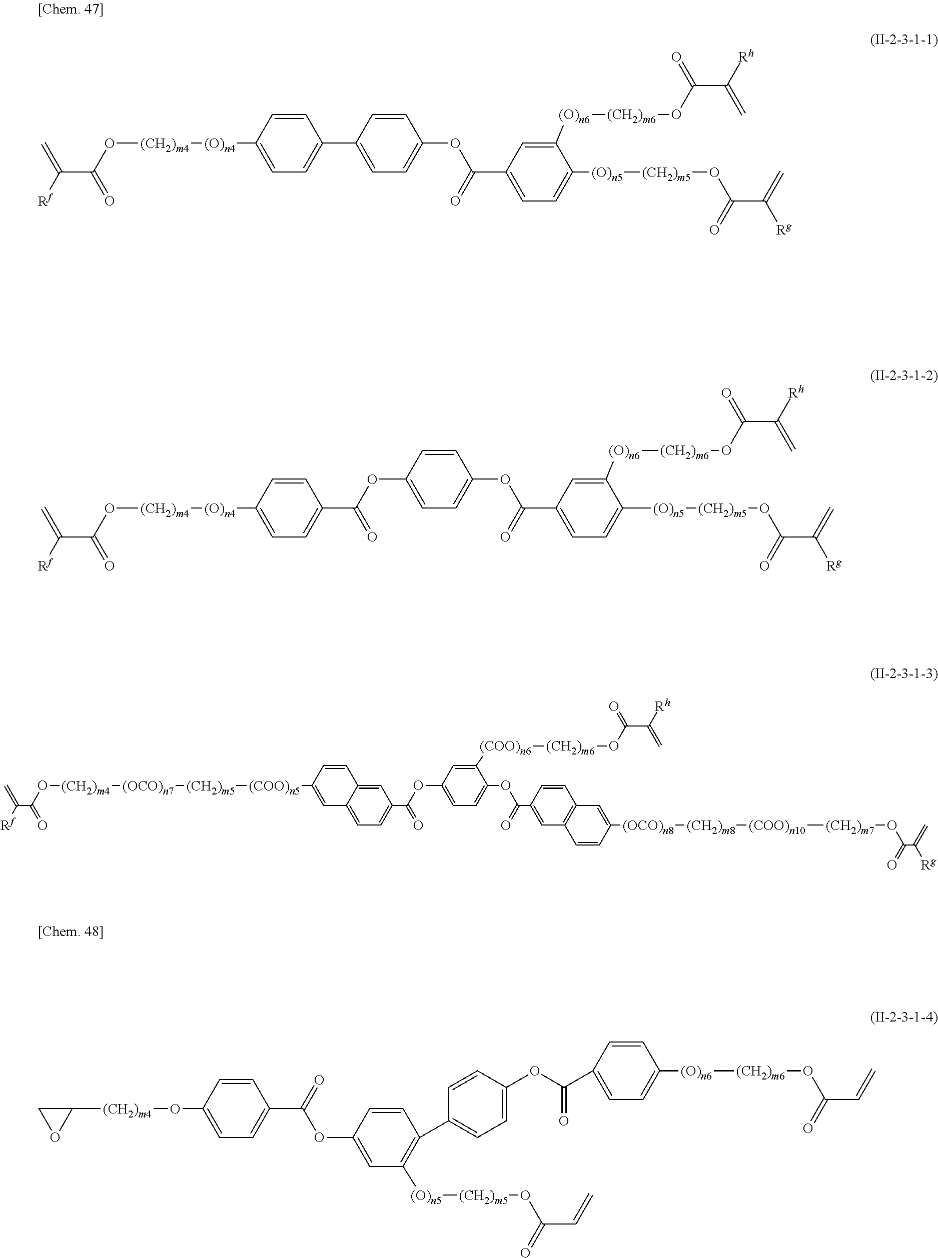

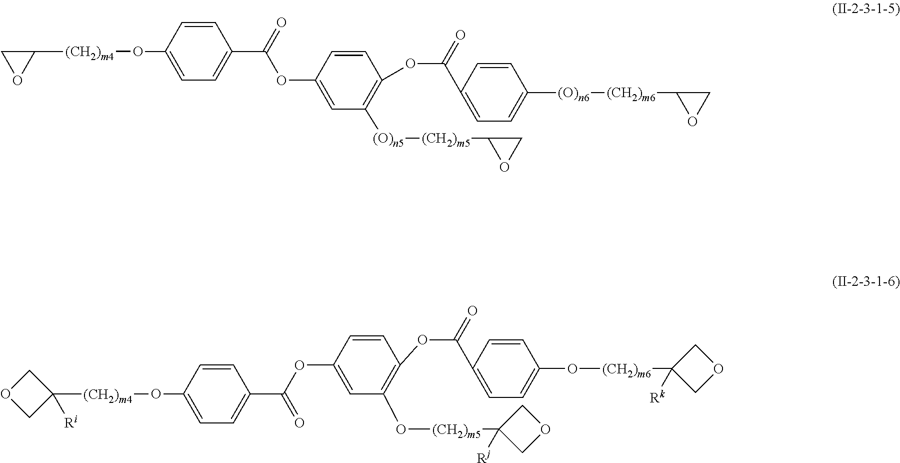

In the formulae, R^{f}, R^{g}, and R^{h} each independently represent a hydrogen atom or a methyl group, Rⁱ, R^{j}, and R^{k} each independently represent a hydrogen atom, a halogen atom, an alkyl group having from 1 to 6 carbon atoms, an alkoxy group having from 1 to 6 carbon atoms, or a cyano group, in the case where the group is an alkyl group having from 1 to 6 carbon atoms or an alkoxy group having from 1 to 6 carbon atoms, the group may be entirely unsubstituted, or may be substituted by one or two or more halogen atoms, the cyclic group may have, as a substituent, one or more of F, Cl, CF₃, OCF₃, CN, an alkyl group having from 1 to 8 carbon atoms, an alkoxy group having from 1 to 8 carbon atoms, an alkanoyl group having from 1 to 8 carbon atoms, an alkanoyloxy group having from 1 to 8 carbon atoms, an alkoxycarbonyl group having from 1 to 8 carbon atoms, an alkenyl group having from 2 to 8 carbon atoms, an alkenyloxy group having from 2 to 8 carbon atoms, an alkenoyl group having from 2 to 8 carbon atoms, an alkenoyloxy group having from 2 to 8 carbon atoms.

m4 to m9 each independently represent an integer of from 0 to 18, and n4 to n9 each independently represent 0 or 1.

The polyfunctional liquid crystal compound having three or more polymerizable functional groups may be used solely, or two or more thereof may be used.

The total content of the polyfunctional polymerizable liquid crystal compound having three or more polymerizable functional groups in the molecule thereof is preferably from 0 to 80% by mass, more preferably from 0 to 60% by mass, and particularly preferably from 0 to 40% by mass, based on the total amount of the polymerizable liquid crystal compound used. In the case where the rigidity of the optical anisotropy material is important, the lower limit thereof is preferably 10% by mass or more, more preferably 20% by mass or more, and particularly preferably 30% by mass or more, and in the case where the low curing shrinkage property is important, the upper limit thereof is preferably 60% by mass or less, more preferably 50% by mass or less, and particularly preferably 40% by mass or less.

In the polymerizable liquid crystal composition of the invention, plural kinds of the aforementioned polymerizable liquid crystal compounds are preferably used as a mixture. At least one of the monofunctional polymerizable compound, and at least one of the bifunctional polymerizable liquid crystal compound and/or the polyfunctional polymerizable liquid crystal compound are preferably used in combination since the curing shrinkage is suppressed, and the adhesiveness is improved. Among these, in the case where it is intended to improve the alignment property of the optical anisotropy material formed with the polymerizable liquid crystal composition of the invention, it is preferred that a compound selected from the formulae (II-2-1-2) to (II-2-1-4) having three or more cyclic structures in the compound is used as the monofunctional polymerizable liquid crystal compound, and a compound selected from the formulae (II-2-2-2) to (II-2-2-4) having three or more cyclic structures in the compound is used as the bifunctional polymerizable liquid crystal compound, which are mixed to form a mixture of the polymerizable liquid crystal compounds, it is more preferred that the compound represented by the formula (II-2-1-2) and the compound represented by the formula (II-2-2-2) having three or more cyclic structures in the compound are used, which are mixed to form a mixture having the content of these compounds of 70% by mass or more based on the total amount of the polymerizable liquid crystal compounds, and it is particularly preferred that the compound represented by the formula (II-2-1-2) and the compound represented by the formula (II-2-2-2) are used, which are mixed to form a mixture having the content of these compounds of 75% by mass or more based on the total amount of the polymerizable liquid crystal compounds.

### Polymer Liquid Crystal

The polymer liquid crystal used in the invention used may be a known polymer liquid crystal. The polymer liquid crystal has a partial structure providing a function exhibiting liquid crystal (mesogen), and the partial structure providing a function exhibiting liquid crystal may have any structure. The mesogen may be introduced to the main chain of the polymer, may be introduced to the side chain of the polymer, or may be introduced to the crosslinked portion thereof.

The polymer liquid crystal is preferably a ferroelectric polymer, such as polyvinylidene fluoride, or a side chain liquid crystal polymer or a main chain liquid crystal polymer exhibiting nematic liquid crystal property. The side chain liquid crystal polymer is not limited, and examples thereof include derivatives of polyester, polyamide, polyisocyanate, polymethacrylate, polyacrylate, polystyrene, polyacrylamide, and polysiloxane. Preferred examples thereof include derivatives of polymethacrylate, polyacrylate, and polysiloxane. Examples thereof include the materials described in Ekisho Binran (Liquid Crystal Handbook), edited by Liquid Crystal Handbook Editorial Committee, published by Maruzen (2000), Chapter 3, Section 8 “Polymer Liquid Crystal”.

### Photo Alignment Layer

The photo alignment layer in the invention has a yellowness index (YI) of 0.001<YI<100. In the case where the yellowness index (YI) is in the range, the alignment regulation force of the alignment layer is increased, whereby the alignment disorder of the liquid crystal molecules in the liquid crystal compound, and particularly the disorder of the liquid crystal alignment in the vicinity of the boundary region of the alignment layer, are reduced, and the alignment disorder of the liquid crystal molecules at the position apart from the alignment layer can be reduced.

The photo alignment layer in the invention is preferably constituted by a photo alignment component, and more preferably contains an ultraviolet ray absorbent. It is sufficient that the photo alignment component contains one or more kind of a photoresponsive molecule. The photoresponsive molecule is preferably at least one kind selected from the group consisting of a photoresponsive dimerization molecule, which forms a crosslinked structure through dimerization in response to light, a photoresponsive isomerization type molecule, which undergoes alignment in a direction substantially perpendicular or in parallel to the polarization axis through isomerization in response to light, and a photoresponsive decomposition type polymer, the polymer chain of which is cut in response to light, and the photoresponsive isomerization type molecule is preferred from the standpoint of the sensitivity and the alignment regulation force.

The photoresponsive isomerization type molecule in the invention is preferably a dichroic dye, and as the specific structure thereof, an azo compound represented by the following general formula (A) and a polymer thereof are preferred.

### General Formula (A)

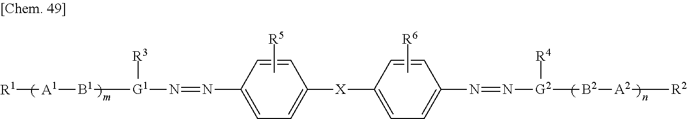

In the general formula (A), R¹ and R² each independently represent a hydroxyl group or a polymerizable functional group selected from the group consisting of a (meth)acryloyl group, a (meth)acryloyloxy group, a (meth)acryloylamino group, a vinyl group, a vinyloxy group, and a maleimide group, A¹ and A² in the formula each independently represent a single bond or a divalent hydrocarbon group, which may be substituted by an alkoxy group, B¹ and B² each independently represent a single bond, —O—, —CO—O—, —O—CO—, —CO—NH—, —NH—CO—, —NH—CO—O—, or —O—CO—NH—, provided that an —O—O— bond is not formed in the bond to R¹ and R², m and n each independently represent an integer of from 0 to 4 (provided that m or n is 2 or more, plural groups of A¹, B¹, A², and B² each may be the same as or different from each other, and A¹ or A² held between two B¹ or B² represents a divalent hydrocarbon group, which may be substituted by an alkoxy group), R³ to R⁶ each independently represent a hydrogen atom a halogen atom, a halogenated alkyl group, an allyloxy group, a cyano group, a nitro group, an alkyl group, a hydroxyalkyl group, an alkoxy group, a carboxyl group or an alkali metal salt thereof, an alkoxycarbonyl group, a halogenated methoxy group, a hydroxyl group, a sulfo group or an alkali metal salt thereof, an amino group, a carbamoyl group, a sulfamoyl group, —OR⁷ (wherein R⁷ represents a lower alkyl group having from 1 to 6 carbon atoms, a cycloalkyl group having from 3 to 6 carbon atoms, or a lower alkyl group having from 1 to 6 carbon atoms substituted by a lower alkoxy group having from 1 to 6 carbon atoms), a hydroxyalkyl group having from 1 to 4 carbon atoms, —CONR^{B}R⁹ (wherein R⁸ and R⁹ each independently represent a hydrogen atom or a lower alkyl group having from 1 to 6 carbon atoms), or a polymerizable functional group selected from the group consisting of a (meth)acryloyl group, a (meth)acryloyloxy group, a (meth)acryloylamino group, a vinyl group, a vinyloxy group, and a maleimide group, X represents a single bond, —CH═CH—, —NR¹⁰— (wherein R¹⁰ represents a hydrogen atom or a hydrocarbon group having 20 or less carbon atoms), —NH—CO—NH—, —S—, or —CH₂—, and G¹ and G each independently represent a phenylene group, such as a 1,4-phenylene group, or an arylene group, such as a 2,6-naphthalendiyl group, in which one or two or more hydrogen atoms present in the phenylene group or the arylene group may be independently substituted by a hydroxyl group, a halogen group, a cyano group, a nitro group, an amino group, a sulfo group, an alkali metal salt of a sulfo group, an alkyl group having from 1 to 7 carbon atoms, an alkoxy group, or an alkanoyl group.

In the general formula (A), when at least one of R¹ and R² is preferably a polymerizable functional group since the stability to light and heat is enhanced. In the polymerizable functional groups, a (meth)acryloyloxy group is particularly preferred. A maleimide group is preferred since a polymerization initiator may be unnecessary. In the case where R¹ is a hydroxyl group, m is preferably 0; in the case where R¹ is a polymerizable functional group, m preferably represents an integer of from 1 to 3, and more preferably 1 or 2; in the case where R² is a hydroxyl group, n is preferably 0; and in the case where R² is a polymerizable functional group, n preferably represents an integer of from 1 to 3, and more preferably 1 or 2.

A¹ and A² each independently represent a single bond or a divalent hydrocarbon group, which may be substituted by an alkoxy group. Examples of the divalent alkoxy group include a linear alkylene group having from 1 to 18 carbon atoms, such as a methylene group, an ethylene group, a trimethylene group, a tetramethylene group, a pentamethylene group, a hexamethylene group, a heptamethylene group, an octamethylene group, a nonamethylene group, a decamethylene group, an undecamethylene group, and a dodecamethylene group; a branched alkylene group having from 1 to 18 carbon atoms, such as a 1-methylethylene group, a 1-methyltriethylene group, a 2-methyltriethylene group, a 1-methyltetraethylene group, a 2-methyltetraethylene group, a 1-methylpentamethylene group, a 2-methylpentamethylene group, and a 3-methylpentamethylene group; a phenylene group, such as a p-phenylene group; and an arylene group, such as a 2,6-naphthalendiyl group. The divalent hydrocarbon group, which may be substituted by an alkoxy group, is preferably a phenylene group having a linear or branched alkoxy group having from 1 to 18 carbon atoms, such as a substituent obtained by substituting one carbon atom in the linear alkylene group having from 1 to 18 carbon atoms or the branched alkylene group having from 1 to 18 carbon atoms by an oxygen atom, a 2-methoxy-1,4-phenylene group, a 3-methoxy-1,4-phenylene group, a 2-ethoxy-1,4-phenylene group, a 3-ethoxy-1,4-phenylene group, and a 2,3,5-trimethoxy-1,4-phenylene group.

B¹ and B² each independently preferably represent a single bond, —O—, —CO—O—, or —O—CO—.

Examples of the halogen atom as R³ to R⁶ include a fluorine atom and a chlorine atom. Examples of the halogenated alkyl group include a trichloromethyl group and a trifluoromethyl group. Examples of the halogenated methoxy group include a chloromethoxy group and a trifluoromethoxy group. Examples of the alkoxy group include a lower alkyl group having from 1 to 6 carbon atoms, the alkyl moiety of which is substituted by a lower alkyl group having from 1 to 6 carbon atoms, a cycloalkyl group having from 3 to 6 carbon atoms, or a lower alkoxy group having from 1 to 6 carbon atoms. Examples of the lower alkyl group having from 1 to 6 carbon atoms include a methyl group, an ethyl group, a propyl group, a butyl group, a pentyl group, a hexyl group, and a 1-methylethyl group. Examples of the lower alkyl group having from 1 to 6 carbon atoms substituted by a lower alkoxy group having from 1 to 6 carbon atoms include a methoxymethyl group, a 1-ethoxyethyl group, a tetrahydropyranyl group. Examples of the hydroxyalkyl group include a hydroxyalkyl group having from 1 to 4 carbon atoms, and specifically include a hydroxymethyl group, a 1-hydroxyethyl group, a 2-hydroxyethyl group, a 1-hydroxypropyl group, a 2-hydroxypropyl group, a 3-hydroxypropyl group, and a 1-hydroxybutyl group. Examples of the carbamoyl group include a group having an alkyl moiety having from 1 to 6 carbon atoms, examples of which include a methyl group, an ethyl group, a propyl group, a butyl group, a pentyl group, a hexyl group, and a 1-methylethyl group. Among these, a halogen atom, a carboxyl group, a halogenated methyl group, a halogenated methoxy group, a methoxy group, an ethoxy group, a propoxy group, a hydroxymethyl group, a carbamoyl group, a dimethylcarbamoyl group, and a cyano group are preferred, and a carboxyl group, a hydroxymethyl group, and a trifluoromethyl group are particularly preferred from the standpoint that good alignment property is obtained.

R³ and R⁴ are particularly preferably substituted at the m-positions of the phenylene groups at both ends of the 4,4′-bis(phenylazo) biphenyl skeleton since an excellent photo alignment film can be obtained, and R⁵ and R⁶ are particularly preferably substituted at the 2- and 2′-positions of the 4,4′-bis(phenylazo)biphenyl skeleton since excellent photo alignment property can be obtained.

The azo compound represented by the general formula (A) is particularly preferably a compound represented by the following general formula (B).

### General Formula (B)

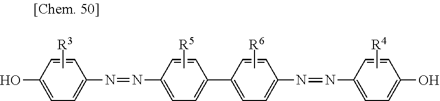

In the general formula (B), R³ to R⁶ have the same meaning as in R³ to R⁶ in the general formula (A).

Examples of the halogen atom include a fluorine atom and a chlorine atom. Examples of the halogenated methyl group include a trichloromethyl group and a trifluoromethyl group. Examples of the halogenated methoxy group include a chloromethoxy group and a trifluoromethoxy group.

Examples of the lower alkyl group having from 1 to 6 carbon atoms as R⁷ include a methyl group, an ethyl group, a propyl group, a butyl group, a pentyl group, a hexyl group, and a 1-methylethyl group. Examples of the lower alkyl group having from 1 to 6 carbon atoms substituted by a lower alkoxy group having from 1 to 6 carbon atoms represented by R⁷ include a methoxymethyl group, a 1-ethoxyethyl group, a tetrahydropyranyl group. Examples of the hydroxyalkyl group having from 1 to 4 carbon atoms include a hydroxymethyl group, a 1-hydroxyethyl group, a 2-hydroxyethyl group, a 1-hydroxypropyl group, a 2-hydroxypropyl group, a 3-hydroxypropyl group, and a 1-hydroxybutyl group.

Examples of the alkyl group having from 1 to 6 carbon atoms represented by R⁸ and R⁹ include a methyl group, an ethyl group, a propyl group, a butyl group, a pentyl group, a hexyl group, and a 1-methylethyl group.

Among these, a halogen atom, a carboxyl group, a halogenated methyl group, a halogenated methoxy group, a methoxy group, an ethoxy group, a propoxy group, a hydroxymethyl group, a carbamoyl group, a dimethylcarbamoyl group, and a cyano group are preferred, and a carboxyl group, a hydroxymethyl group, and a trifluoromethyl group are particularly preferred from the standpoint that good alignment property is obtained.

R³ and R⁴ are particularly preferably substituted at the m-positions with respect to the azo groups of the phenylene groups at both ends of the 4,4′-bis(phenylazo)biphenyl skeleton since excellent photo alignment property can be obtained.

R³ and R⁶ each independently represent a carboxyl group, a sulfo group, a nitro group, an amino group, an alkoxycarbonyl group, or a hydroxyl group, provided that the carboxyl group and the sulfo group may form a salt with an alkali metal, such as lithium, sodium, and potassium.

R⁵ and R⁶ are particularly preferably substituted at the 2- and 2′-positions of the 4,4′-bis(phenylazo)biphenyl skeleton since excellent photo alignment property can be obtained.

It is expected that R⁵ and R⁶ are moieties that most influence the photo alignment capability and the other characteristics, and various characteristics can be obtained by the kinds and the combinations of the substituents capable of being introduced to R⁵ and R⁶. R⁵ and R⁶ each are preferably a carboxyl group or a salt thereof, or a sulfo group or a salt thereof since good affinity to a transparent electrode, such as glass and ITO, and the photo alignment film can be formed uniformly on the surface of the substrate. The compound represented by the general formula (B) may be used solely, or as a mixture of plural compounds, in which R³ to R⁶ are different from each other within the range of the compound represented by the general formula (B).

Examples of the compound represented by the general formula (A) or (B) include compounds having the following structures. The weight average molecular weight of the polymers among these is preferably from 5,000 to 1,000,000, and particularly preferably from 10,000 to 500,000, from the standpoint that the viscosity of the solution suitable for coating is obtained, the heat resistance of the dried film after coating is retained, and the alignment regulation force is enhanced.

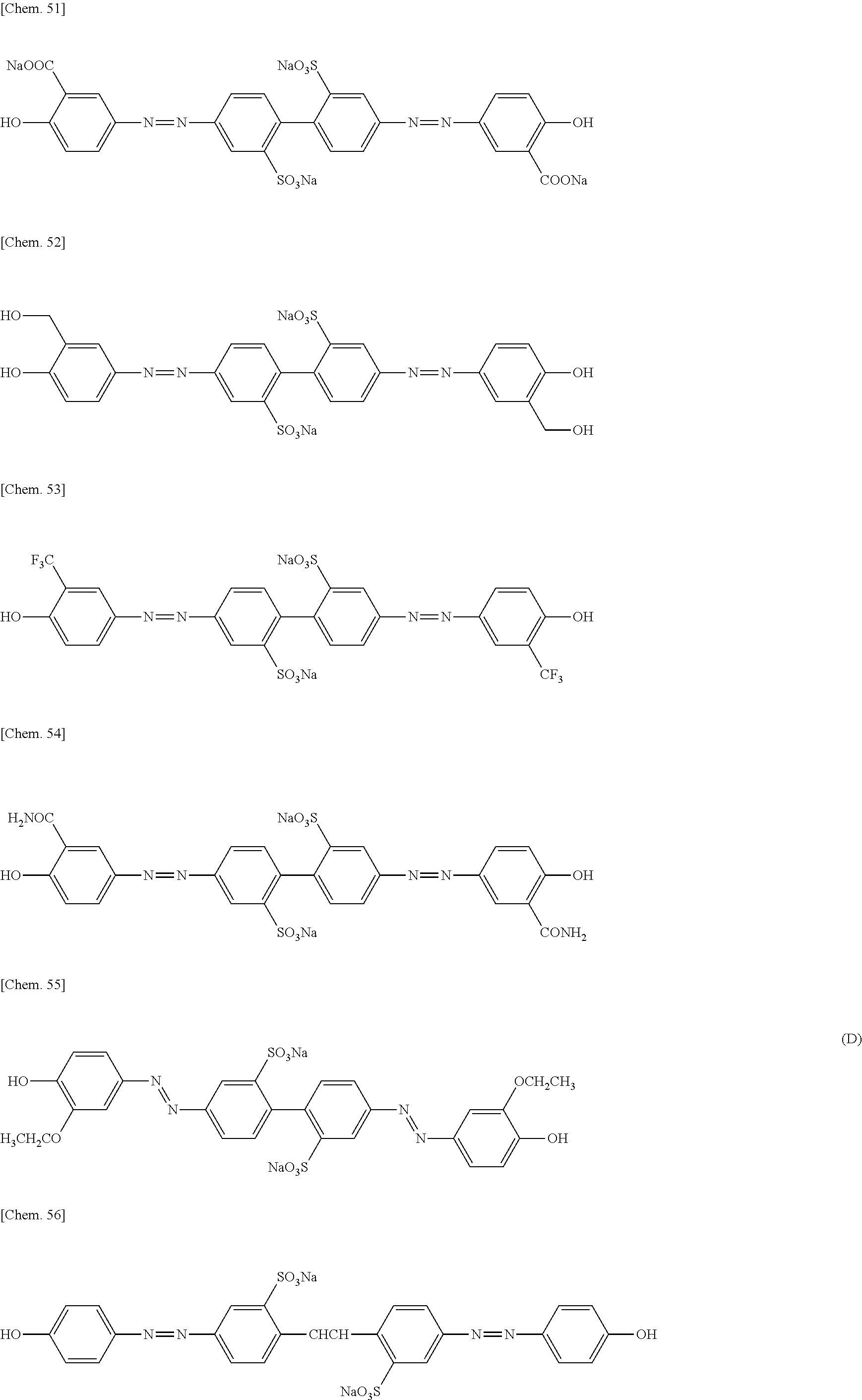

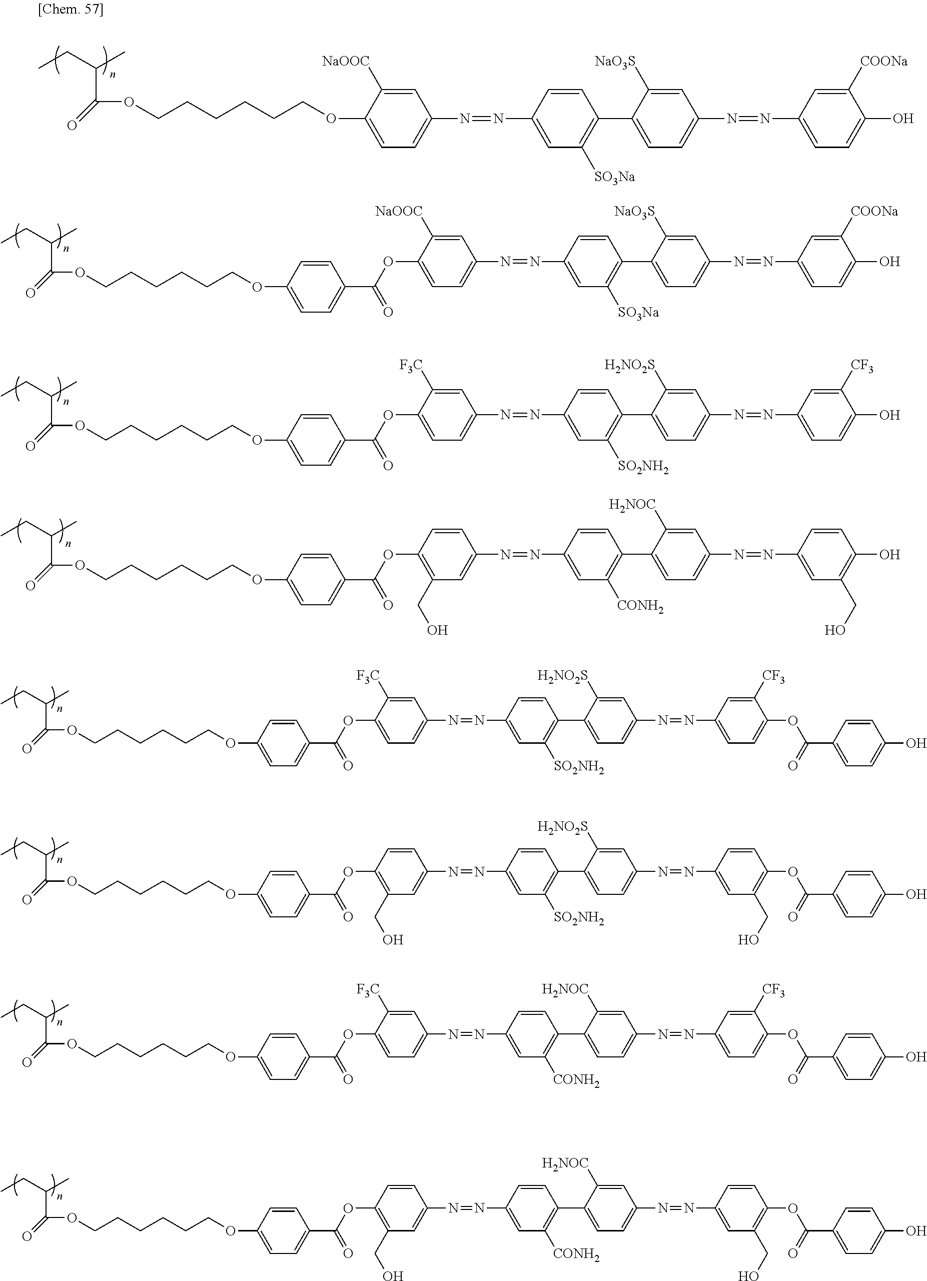

The azo compound represented by the general formula (A) in the invention is preferably a compound represented by the following general formula (C-1).

### General Formula (C-1)

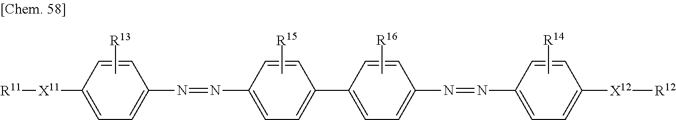

In the general formula (C-1), R¹¹ and R¹² each independently represent a hydroxyl group or a polymerizable functional group selected from the group consisting of a (meth)acryloyl group, a (meth)acryloyloxy group, a (meth)acryloylamino group, a vinyl group, a vinyloxy group, and a maleimide group. In the case where R¹¹ is a hydroxyl group, X¹¹ represents a single bond, and in the case where R¹¹ is a polymerizable functional group, X¹¹ represents a linking group represented by -(A¹-B¹)ₘ—. In the case where R¹² is a hydroxyl group, X¹² represents a single bond, and in the case where R¹² is a polymerizable functional group, X¹² represents a linking group represented by -(A²-B)ₘ-. Herein, A¹ is bonded to R¹¹, and A² is bonded to R¹². A¹ and A² each independently represent a single bond or a divalent hydrocarbon group, and B¹ and B² each independently represent a single bond, —O—, —CO—O—, —O—CO—, —CO—NH—, —NH—CO—, —NH—CO—O—, or —O—CO—NH—. m and n each independently represent an integer of from 0 to 4, provided that when m or n is 2 or more, plural groups represented by each of A¹, B¹, A², and B² each may be the same as or different from each other. A¹ or A² positioned between two groups of B¹ or B² is not a single bond.

R¹³ and R¹⁴ each independently represent a hydrogen atom a halogen atom, a carboxyl group, a halogenated methyl group, a halogenated methoxy group, a cyano group, a nitro group, —OR¹⁷ (wherein R¹⁷ represents a lower alkyl group having from 1 to 6 carbon atoms, a cycloalkyl group having from 3 to 6 carbon atoms, or a lower alkyl group having from 1 to 6 carbon atoms substituted by a lower alkoxy group having from 1 to 6 carbon atoms), a hydroxyalkyl group having from 1 to 4 carbon atoms, —CONR¹⁸R¹⁹ (wherein R¹⁸ and R¹⁹ each independently represent a hydrogen atom or a lower alkyl group having from 1 to 6 carbon atoms), or a methoxycarbonyl group. The carboxyl group may form a salt with an alkali metal. R¹⁵ and R¹⁶ each independently represent a carbamoyl group or a sulfamoyl group.

In the compound represented by the general formula (C-1), a compound, in which R¹¹ and R¹² each represent a hydroxyl group, and R¹³ and R¹⁴ each represent a hydroxyalkyl group having from 1 to 4 carbon atoms, is preferred, and a compound, in which R¹¹ and R¹² each represent a hydroxyl group, and R¹³ and R¹⁴ each represent a hydroxymethyl group, is particularly preferred.

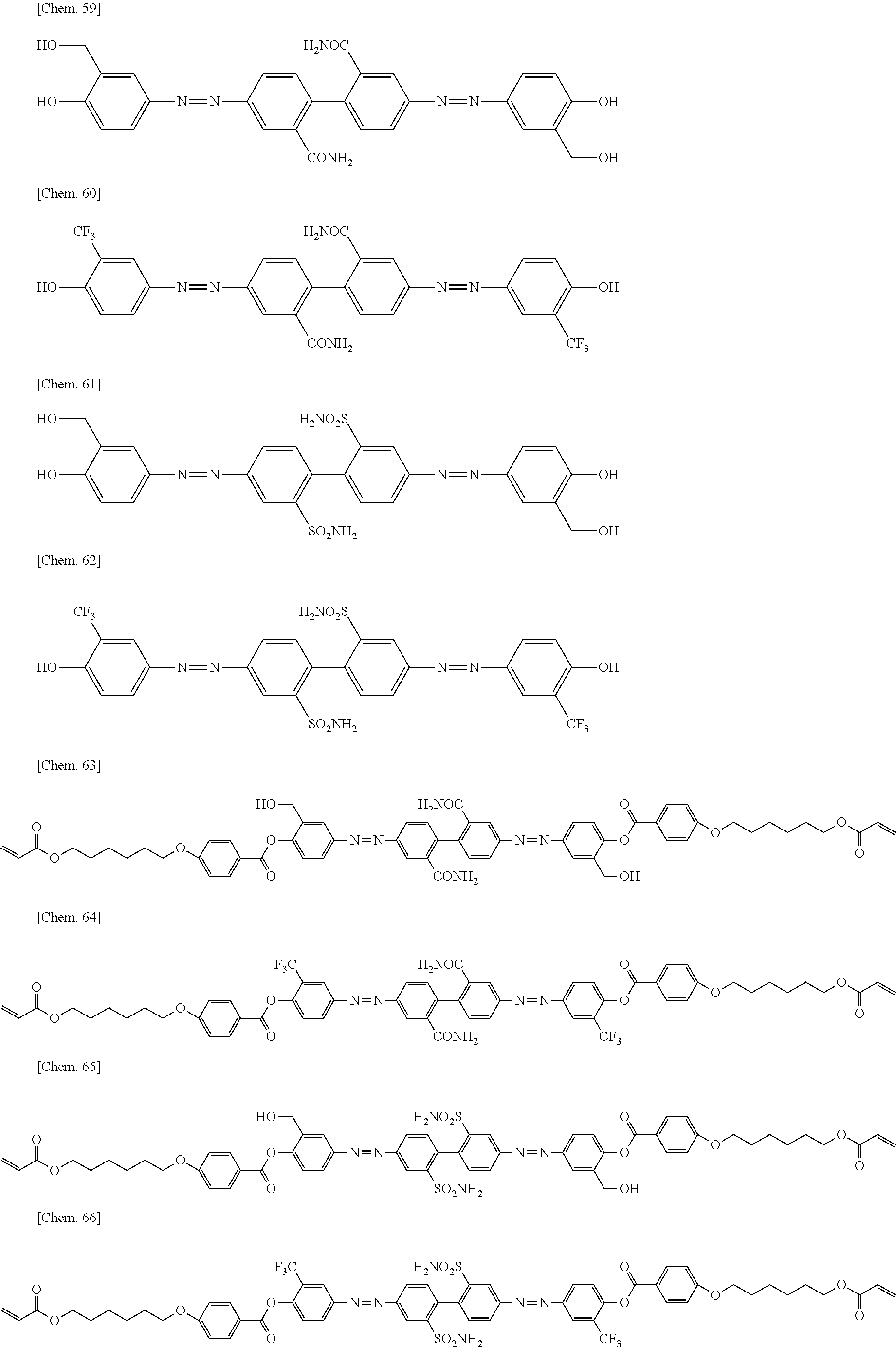

The azo compound represented by the general formula (A) in the invention is more preferably a compound represented by the following general formula (C-2).

### General Formula (C-2)

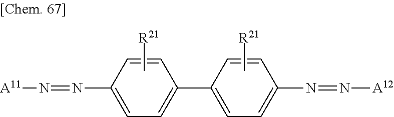

In the general formula (2-2), R²¹ and R²² each independently represent a hydrogen atom, an alkyl group having from 1 to 6 carbon atoms, or an alkoxy group having from 1 to 6 carbon atoms, and A¹¹ and A¹² each independently represent a naphthalene ring having an amino group and a sulfo group as substituents, or a benzene ring having an amino group and a sulfo group as substituents. The sulfo group may form a salt with an alkali metal. The compound represented by the general formula (C-2) is preferably a compound, in which R²¹ and R² each independently represent a hydrogen atom, a methyl group, or a methoxy group.

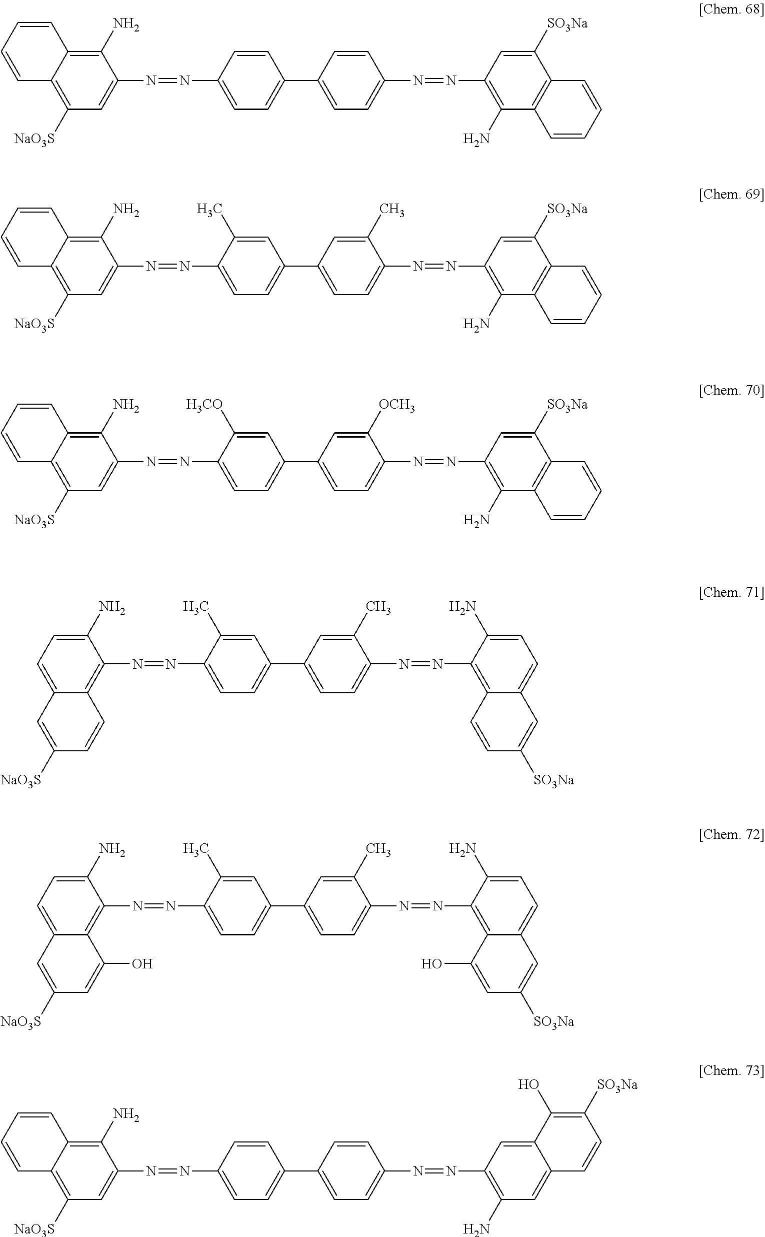

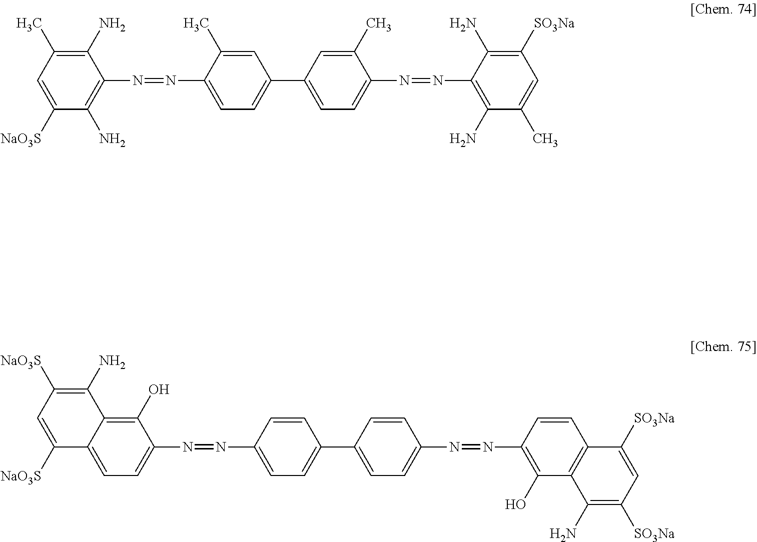

The compound represented by the general formula (A) shows high solubility in water or a polar organic solvent, and shows good affinity to glass and the like. A uniform and stable coated film can be formed only by coating a solution containing the compound dissolved in water or a polar organic solvent on a substrate, and then removing the water or the polar organic solvent.

The compound represented by the general formula (A) may be used solely or as a mixture of two or more kinds of the compound.

By using the compound represented by the general formula (B) and at least one compound (C) selected from the group consisting of the compound represented by the general formula (C-1) and the compound represented by the general formula (C-2) in combination, a photo alignment film excellent in heat resistance can be obtained while retaining the sensitivity.

The specific structure of the photoresponsive molecules in the invention is preferably a photoresponsive dimer type polymer represented by at least one selected from the group consisting of the following general formulae (1A) and (1B) and the following general formula (2). The photoresponsive molecules are preferably a photoresponsive dimer type polymer obtained by polymerizing a compound represented by the general formula (4) and/or the general formula (5).

The photoresponsive molecules in the invention are preferably a photoresponsive dimer type polymer represented by the following general formula (1A) or (1B), a hydrolysate thereof, or a condensate of the hydrolysate.

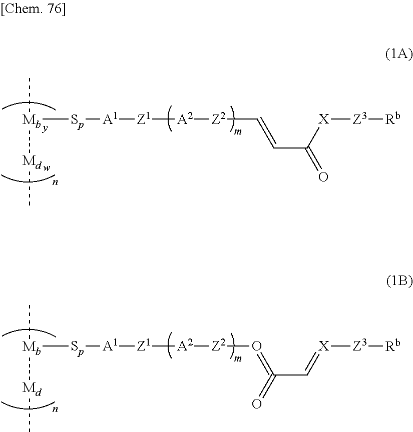

In the general formula (1), Sp represents a single bond, or a divalent linking group selected from the group consisting of —(CH₂)ᵤ— (wherein u represents from 1 to 20), —OCH₂—, —CH₂O—, —COO—, —OCO—, —CH═CH—, —CF═CF—, —CF₂O—, —OCF₂—, —CF₂CF₂—, and —C≡C—, in which in these substituents, one or more of the CH₂ groups that are not adjacent to each other each may independently be substituted by —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (wherein R each independently represent a hydrogen atom or an alkyl group having from 1 to 5 carbon atoms),

A¹ and A² each independently represent a group selected from the group consisting of

(a) a trans-1,4-cyclohexylene group (in which one methylene group or two or more methylene groups that are not adjacent to each other present in the group may be substituted by —O—, —NH—, or —S—),

(b) a 1,4-phenylene group (in which one or two or more —CH═ groups present in the group may be substituted by —N═), and

(c) a 1,4-cyclohexenylene group, a 2,5-thiophenylene group, a 2,5-furanylene group, a 1,4-bicyclo(2.2.2)octylene group, a naphthalen-1,4-diyl group, a naphthalen-2,6-diyl group, a decahydronaphthalen-2,6-diyl group, and a 1,2,3,4-tetrahydronaphthalen-2,6-diyl group,

in which the group (a), the group (b), and the group (c) each may be unsubstituted, or one or more hydrogen atoms therein may be substituted by a fluorine atom, a chlorine atom, a cyano group, a methyl group, or a methoxy group,

Z¹, Z², and Z³ each independently represent a single bond, —O—, —(CH₂)ᵤ— (wherein u represents from 1 to 20), —OCH₂—, —CH₂O—, —COO—, —OCO—, —CH═CH—, —CF═CF—, —CF₂O—, —OCF₂—, —CF₂CF₂—, or —C≡C—, in which in these substituents, one or more of the CH₂ groups that are not adjacent to each other each may independently be substituted by —O—, —CO—, —CO—O—, —O—CO—, —Si(CH₃)₂—O—Si(CH₃)₂—, —NR—, —NR—CO—, —CO—NR—, —NR—CO—O—, —O—CO—NR—, —NR—CO—NR—, —CH═CH—, —C≡C—, or —O—CO—O— (wherein R each independently represent a hydrogen atom or an alkyl group having from 1 to 5 carbon atoms),

X represents —O—, a single bond, —NR—, or a phenylene group,

R^{b} represents a polymerizable group, an alkoxy group, a cyano group, or a fluorinated alkyl group having from 1 to 12 carbon atoms,

m represents 0, 1, or 2,

M_{b} and M_{d}, which may be the same as or different from each other, each independently represent one of monomer units represented by the following general formulae (U-1) to (U-13)

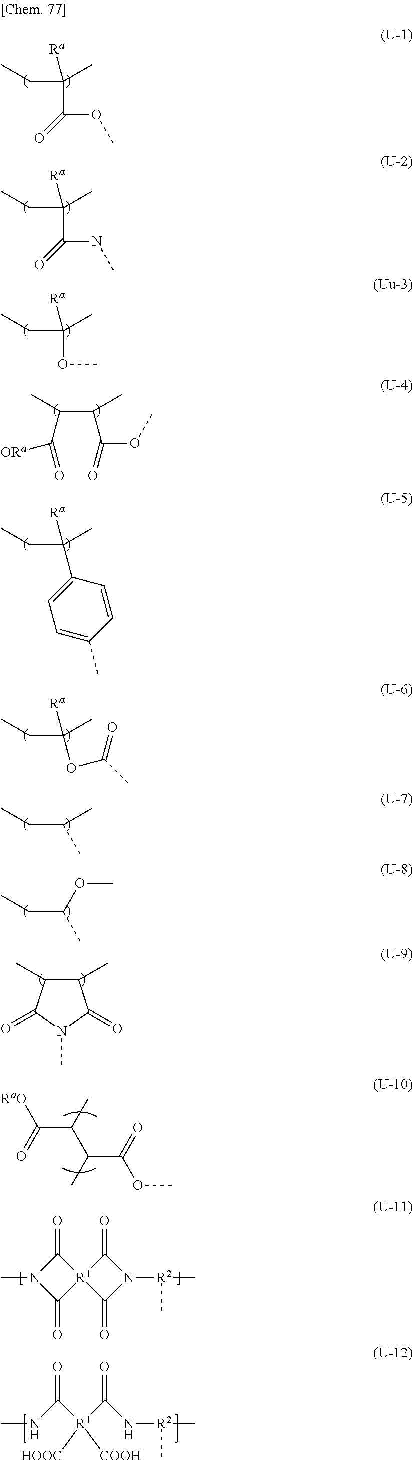

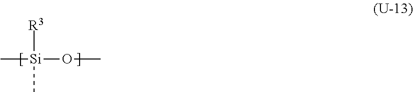

(in the general formulae (U-1) to (U-10), the broken line represents the bond to Sp, and R^{a} each independently represent a hydrogen atom, an alkyl group having from 1 to 5 carbon atoms, a phenyl group, or a halogen atom, in which an arbitrary hydrogen atom in the structures may be substituted by a fluorine atom, a chlorine atom, a methyl group, a phenyl group, or a methoxy group, and in the general formulae (U-11) to (U-13), the broken line represents the bond to Sp, and R¹ represents a tetravalent ring structure, R² represents a trivalent organic group, and R³ represents a hydrogen atom, a hydroxyl group, an alkyl group having from 1 to 15 carbon atoms, or an alkoxy group having from 1 to 15 carbon atoms),

y and w, which represent the molar fractions of the copolymer, are 0<y≦1 and 0≦w<1, and n represents from 4 to 100,000, in which the monomer units of M_{b} and M_{d} each may independently be formed of one kind of the unit or two or more of the different units.

As a preferred embodiment of the photoresponsive molecules represented by the general formula (1) in the invention, the photoresponsive dimer type polymer, in which Z is a single bond, is preferred. The trivalent organic group is preferably a skeleton selected from benzene, biphenyl, diphenyl ether, diphenylethane, diphenylmethane, and diphenylamine.

Examples of the tetravalent ring structure include the following formulae (1.1) to (1.26).

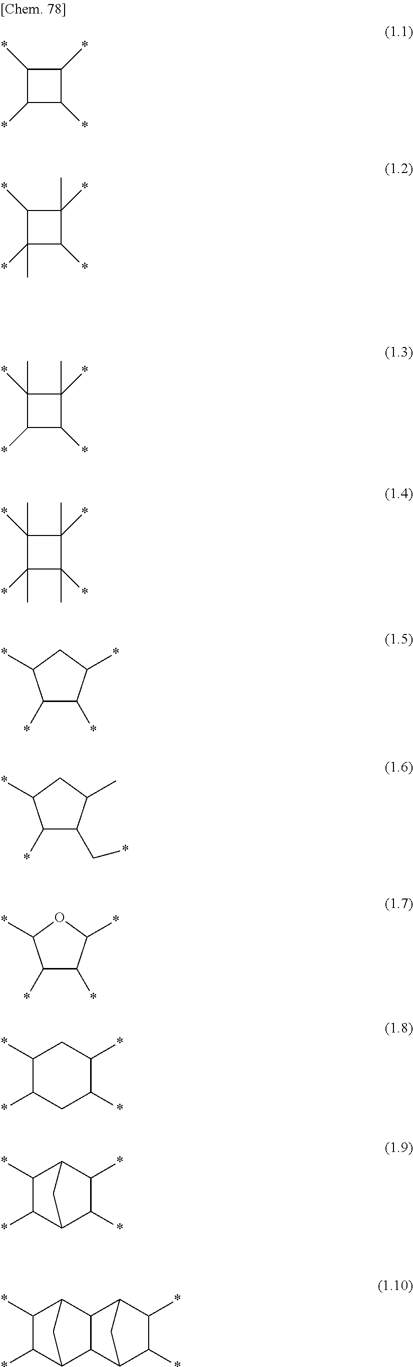

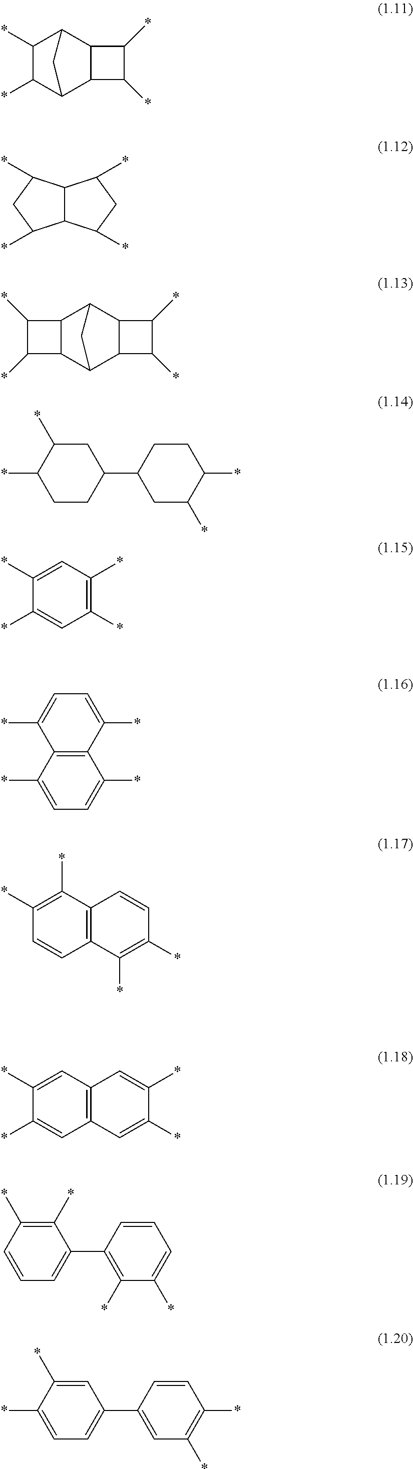

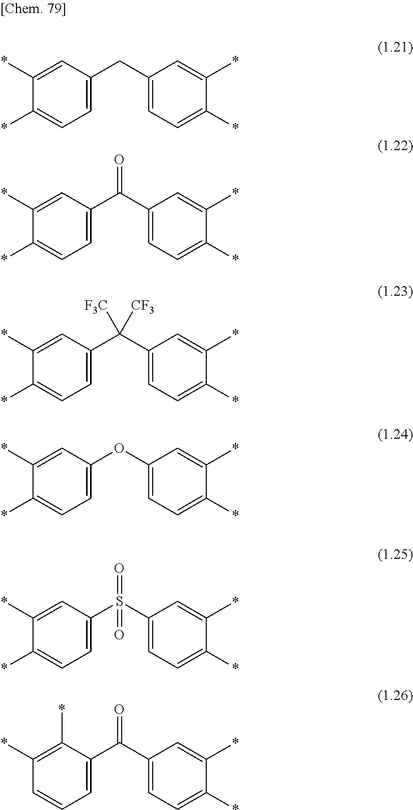

The photoresponsive molecules in the invention are preferably a photoresponsive dimer type polymer represented by the following general formula (2).

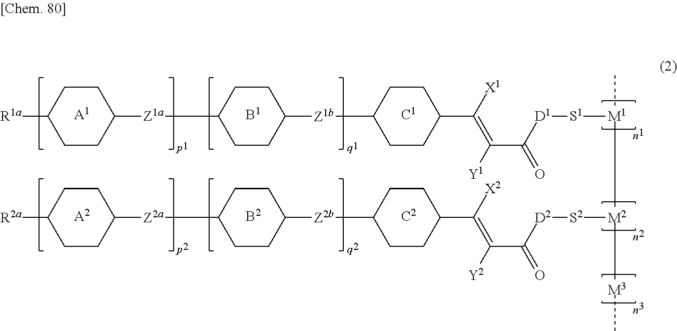

In the general formula (2), M¹ and M² each independently represent at least one kind of a repeating unit selected from the group consisting of an acrylate, a methacrylate, a 2-chloroacrylate, a 2-phenylacrylate, an acrylamide, which may be N-substituted by a lower alkyl group, a methacrylamide, a 2-chloroacrylamide, a 2-phenylacrylamide, a vinyl ether, a vinyl ester, a styrene derivative, and a siloxane compound,

M³ represents at least one kind of a repeating unit selected from the group consisting of an acrylate, a methacrylate, a 2-chloroacrylate, a 2-phenylacrylate, an acrylamide, which may be N-substituted by a lower alkyl group, a methacrylamide, a 2-chloroacrylamide, a 2-phenylacrylamide, a vinyl ether, a vinyl ester, a linear or branched alkyl ester of acrylic acid or methacrylic acid, an allyl ester of acrylic acid or methacrylic acid, an alkyl vinyl ether or ester, a phenoxyalkyl acrylate or a phenoxyalkyl methacrylate, a hydroxyalkyl acrylate or a hydroxyalkyl methacrylate, a phenylalkyl acrylate or a phenylalkyl methacrylate, acrylonitrile, methacrylonitrile, styrene, 4-methylstyrene, and a siloxane compound,

A¹, B¹, C¹, A², B², and C² each independently represent

(a) a trans-1,4-cyclohexylene group (in which one methylene group or two or more methylene groups that are not adjacent to each other present in the group may be substituted by —O—, —NH—, or —S—),

(b) a 1,4-phenylene group (in which one or two or more —CH═ groups present in the group may be substituted by —N═), and

(c) a 1,4-cyclohexenylene group, a 2,5-thiophenylene group, a 2,5-furanylene group, a 1,4-bicyclo(2.2.2)octylene group, a naphthalen-1,4-diyl group, a naphthalen-2,6-diyl group, a decahydronaphthalen-2,6-diyl group, and a 1,2,3,4-tetrahydronaphthalen-2,6-diyl group,

in which the group (a), the group (b), and the group (c) each may be unsubstituted, or one or more hydrogen atoms therein may be substituted by a fluorine atom, a chlorine atom, a cyano group, a methyl group, or a methoxy group,

S¹ and S² each independently represent a fluorine atom, a chlorine atom, or a linear or branched alkylene group (—(CH₂)ᵣ—) or —(CH₂)ᵣ-L-(CH₂)ₛ— (wherein in the formulae, L represents a single bond, —O—, —COO—, —OOC—, —NR¹—, —NR¹—CO—, —CO—NR¹—, —NR¹—COO—, —OCO—NR¹—, —NR¹—CO—NR¹—, —CH═CH—, or —C≡C—, in which R¹ represents a hydrogen atom or a lower alkyl group, and r and s each represent an integer of from 1 to 20, provided that r+s≦24),

D¹ and D² each independently contain —O—, —NR²—, or a group selected from the group consisting of the following (d) to (f)

(d) a trans-1,4-cyclohexylene group (in which one methylene group or two or more methylene groups that are not adjacent to each other present in the group may be substituted by —O—, —NH—, or —S—),

(e) a 1,4-phenylene group (in which one or two or more —CH═ groups present in the group may be substituted by —N═), and

(f) a 1,4-cyclohexenylene group, a 2,5-thiophenylene group, a 2,5-furanylene group, a 1,4-bicyclo(2.2.2)octylene group, a naphthalen-1,4-diyl group, a naphthalen-2,6-diyl group, a decahydronaphthalen-2,6-diyl group, and a 1,2,3,4-tetrahydronaphthalen-2,6-diyl group,

in which the group (d), the group (e), and the group (f) each may be unsubstituted, or one or more hydrogen atoms therein may be substituted by a fluorine atom, a chlorine atom, a cyano group, a methyl group, or a methoxy group, in which R² represents a hydrogen atom or a lower alkyl group,

X¹, X², Y¹, and Y² each independently represent a hydrogen atom, a fluorine atom, a chlorine atom, a cyano group, or an alkyl group having from 1 to 12 carbon atoms, which may be substituted by a fluorine atom in some cases, in which the CH₂ group or plural CH₂ groups that are not adjacent to each other may be replaced by —O—, —COO—, —OOC—, and/or —CH═CH— in some cases,

Z^{1a}, Z^{1b}, Z^{2a}, and Z^{2b} each independently represent a single bond, —(CH₂)t-, —O—, —CO—, —CO—O—, —O—OC—, —NR⁴—, —CO—NR⁴—, —NR⁴—CO—, —(CH₂)ᵤ—O—, —(CH₂)ᵤ—, —(CH₂)ᵤ—NR⁴—, or —NR⁴— (CH₂)ᵤ—, in which R⁴ represents a hydrogen atom or a lower alkyl group, t represents an integer of from 1 to 4, and u represents an integer of from 1 to 3,

p¹, p², q¹, and q² each independently represent 0 or 1,

R^{1a} and R^{2a} each independently represent a hydrogen atom, a fluorine atom, a chlorine atom, a cyano group, a nitro group, a linear or branched alkyl group having from 1 to 20 carbon atoms, an alkoxy group, an alkyl —COO— group, an alkyl —CO—NR³ group, or an alkyl —OCO group, in which R³ represents a hydrogen atom or a lower alkyl group, one or more hydrogen atoms in the alkyl group or the alkoxy group may be substituted by a fluorine atom, a chlorine atom, a cyano group, or a nitro group, and the CH₂ group or plural CH₂ groups that are not adjacent to each other in the alkyl group or the alkoxy group may be substituted by —O—, —CH═CH—, or —C≡C—, and

n¹, n², and n³, which represent the molar fractions of the comonomers, are 0<n¹≦1, 0≦n²<1, and 0≦n³≦0.5.

The photoresponsive molecules represented by the general formula (1) in the invention are more preferably a photoresponsive dimer type polymer represented by the following general formula (3).

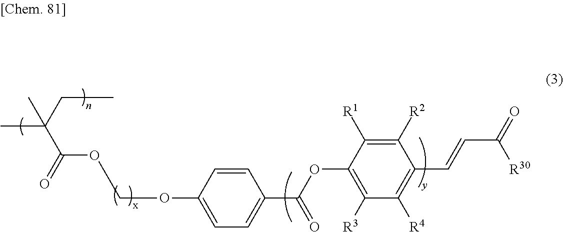

In the general formula (2), X represents from 6 to 12, Y represents from 0 to 2, R¹ to R⁴ each independently represent a hydrogen atom or an alkoxy group having from 1 to 5 carbon atoms, and R³⁰ represents the following formula (2-a) or (2-b)

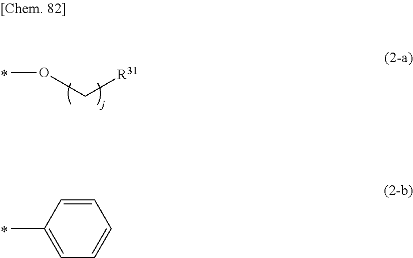

(in the formula (2-a), R³¹ represents a polymerizable group, an alkoxy group having from 1 to 10 carbon atoms, a cyano group, or a fluorinated alkyl group having from 1 to 12 carbon atoms, and j represents an integer of 0 or more and 6 or less).

All the alkyl groups and the alkoxy groups in the invention each are preferably linear, cyclic, or branched, and more preferably linear or branched. Examples of the “alkyl group” in the invention include a methyl group, an ethyl group, a propyl group, a butyl group, an isopropyl group, an isobutyl group, a t-butyl group, a 3-pentyl group, an isopentyl group, a neopentyl group, a pentyl group, a hexyl group, a heptyl group, and an octyl group. The examples of the alkyl group are common in the description herein, and appropriately selected depending on the number of carbon atoms of the alkyl groups.

Examples of the “alkoxy group” in the invention are preferably groups containing the aforementioned alkyl groups each having an oxygen atom bonded directly thereto, and preferred examples thereof include a methoxy group, an ethoxy group, a propoxy group (e.g., a n-propoxy group and an i-propoxy group), a butoxy group, a pentyloxy group, and an octyloxy group. The examples of the alkoxy group are common in the description herein, and appropriately selected depending on the number of carbon atoms of the alkoxy groups.

The photoresponsive molecules in the invention are preferably a photoresponsive dimer type polymer obtained by polymerizing a compound represented by the following general formula (4) and/or (5).

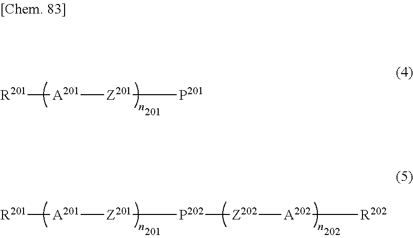

In the formulae, R²⁰¹ and R²⁰² each independently represent a linear or branched alkyl group having from 1 to 30 carbon atoms, or a polymerizable functional group having a hydrogen atom or a fluorine atom, in which one or two or more —CH²— groups in the alkyl group may be substituted by —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)—, provided that oxygen atoms or sulfur atoms each are not bonded directly to each other, one or more hydrogen atoms in the alkyl group may be substituted by a fluorine atom, a chlorine atom, a bromine atom, or a CN group, and may have a polymerizable group, the alkyl group may contain a condensed ring system or a spiro ring system, the alkyl group may contain one or two or more aromatic or alicyclic rings each contain one or two or more hetero atoms, and the rings each may be arbitrarily substituted by an alkyl group, an alkoxy group, or a halogen, Z²⁰¹ and Z²⁰² each independently represent —O—, —S—, —CO—, —CO—O—, —CO—, —CO—O—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, in which R^{a} in —CO—N(R^{a})— and —N(R^{a})—CO— represents a hydrogen atom or a linear or branched alkyl group having from 1 to 4 carbon atoms,

A²⁰¹ and A²⁰² each independently represent a cyclic group selected from a phenylene group, a cyclohexylene group, a dioxolandiyl group, a cyclohexenylene group, a bicyclo[2.2.2]octylene group, a piperidindiyl group, a naphthalendiyl group, a decahydronaphthalendiyl group, a tetrahydronaphthalendiyl group, and an indandiyl group, in which in the phenylene group, the naphthalendiyl group, the tetrahydronaphthalendiyl group, and the indandiyl group, one or two or more —CH═ groups in the ring may be substituted by a nitrogen atom; in the cyclohexylene group, the dioxolandiyl group, the cyclohexenylene group, the bicyclo[2.2.2]octylene group, the piperidindiyl group, the decahydronaphthalendiyl group, the tetrahydronaphthalendiyl group, and the indandiyl group, one or two or more —CH₂— groups that are not adjacent to each other may be substituted by —O— and/or —S—; and one or more hydrogen atoms in the cyclic groups may be substituted by a fluorine atom, a chlorine atom, a bromine atom, a CN group, a NO₂ group, or an alkyl group having from 1 to 7 carbon atoms, an alkoxy group, an alkylcarbonyl group, or an alkoxycarbonyl group, one or two or more hydrogen atoms of which may be substituted by a fluorine atom or a chlorine atom,

n₂₀₁ and n₂₀₂ each independently represent an integer of from 1 to 3, and

P²⁰¹ and P²⁰² each independently represent a photo alignment group, such as cinnamoyl, coumarin, benzylidene phthaldiimide, chalcone, azobenzene, and stilbene, in which P²⁰¹ is a monovalent group, and P²⁰² is a divalent group.

In the invention, in the compound represented by the general formula (4) or the general formula (5), at least one end thereof preferably has a polymerizable functional group, i.e., in the general formula (5), at least one of R²⁰¹ and R²⁰² is preferably a polymerizable functional group.

More preferred examples of the compound include compounds represented by the general formula (6) having a cinnamoyl group, the general formula (7) having a coumarin group, and the general formula (8) having a benzylidene phthaldiimide group.

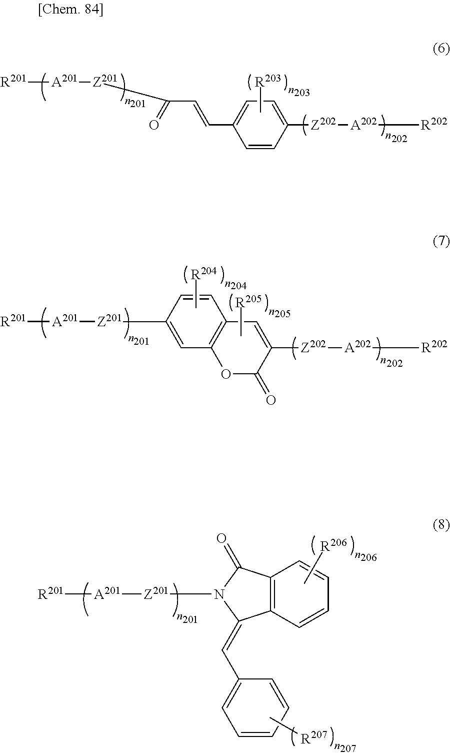

In the general formulae (6), (7), and (8), R²⁰¹, R²⁰², A²⁰¹, A²⁰², Z²⁰¹, Z²⁰², n₂₀₁, and n₂₀₂ have the same definitions as in the formulae (4) and (5),

R²⁰³, R²⁰⁴, R²⁰⁵, R²⁰⁶, and R²⁰⁷ each independently represent a halogen atom (e.g., F, Cl, Br, and I), a methyl group, a methoxy group, —CF₃, —OCF₃, a carboxyl group, a sulfo group, a nitro group, an amino group, or a hydroxyl group,

n²⁰³ represents an integer of from 0 to 4, n²⁰⁴ represents an integer of from 0 to 3, n²⁰⁵ represents an integer of from 0 to 1, n²⁰⁶ represents an integer of from 0 to 4, and n²⁰⁷ represents an integer of from 0 to 5.

In the invention, the photoresponsive decomposition type polymer, the polymer chain of which is cut in response to light, is preferably produced through condensation of a tetracarboxylic dianhydride and a diamine compound.

Examples of the tetracarboxylic dianhydride include the following formulae (A-1) to (A-43).

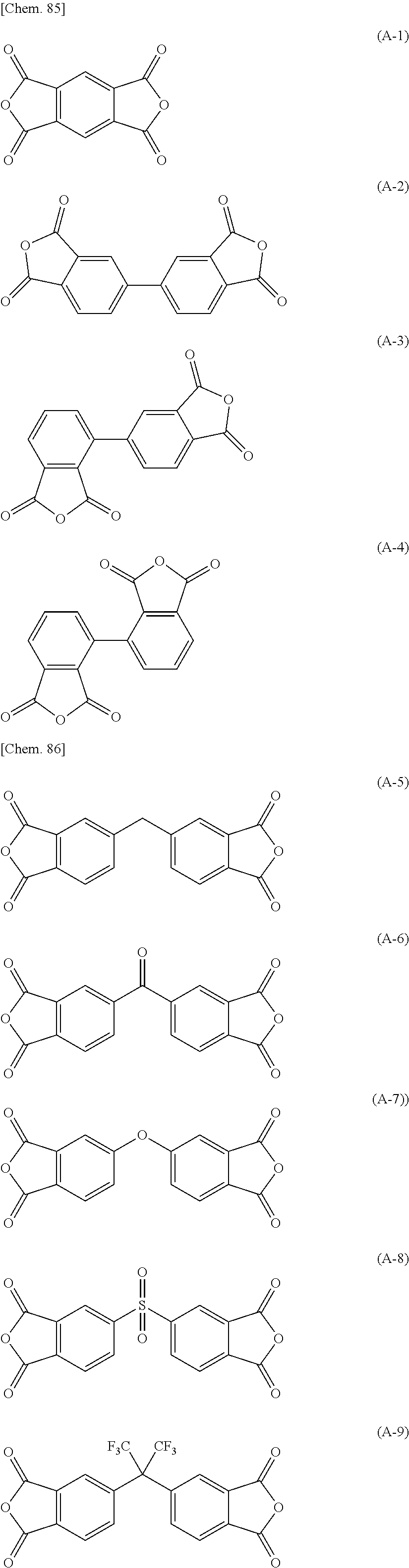

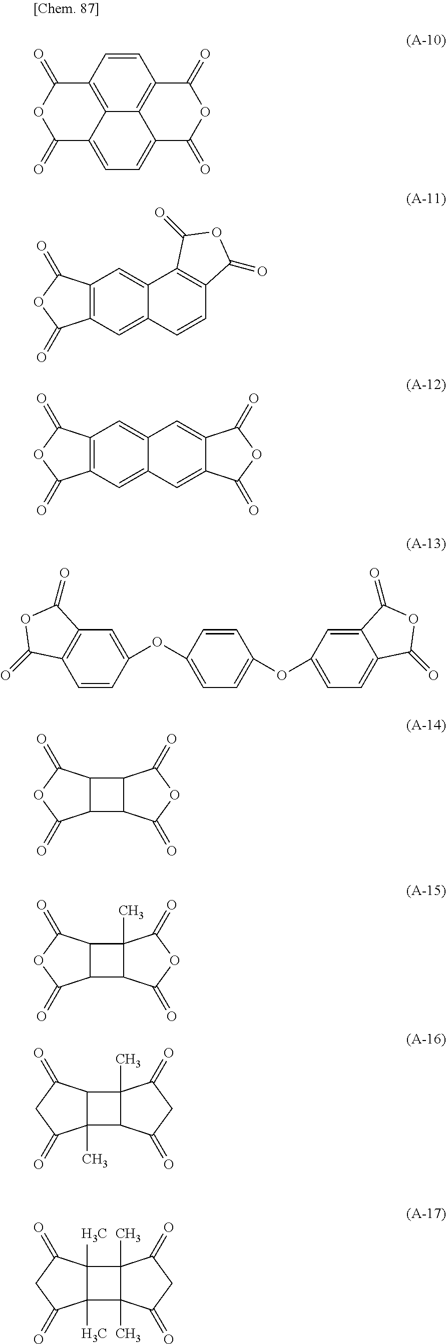

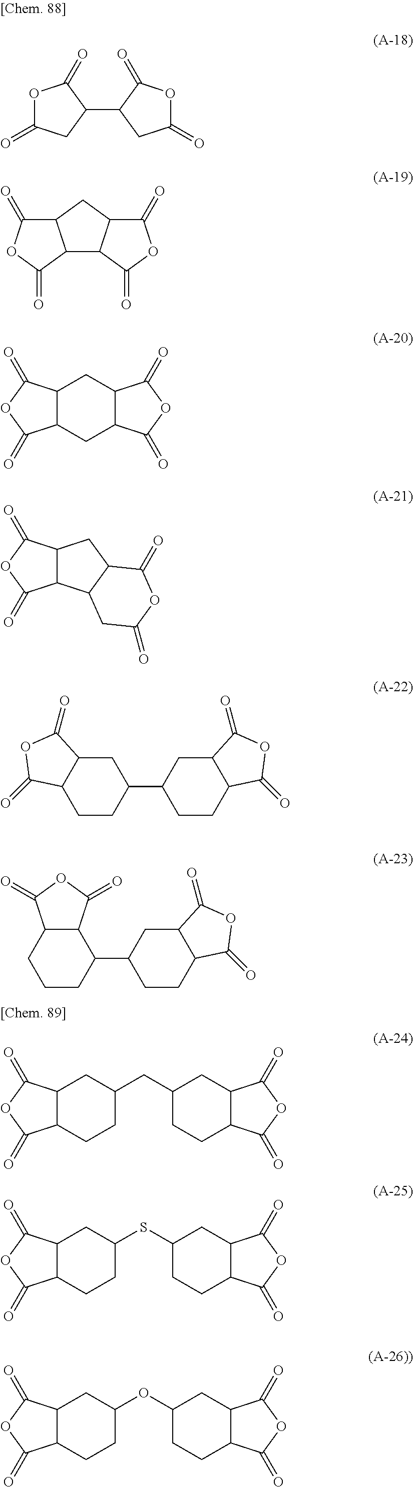

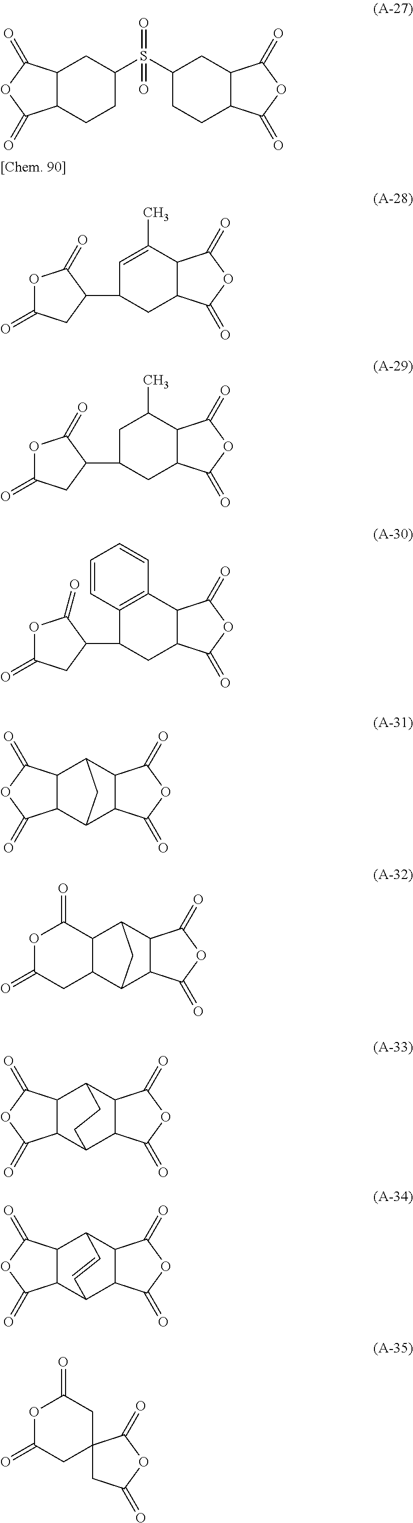

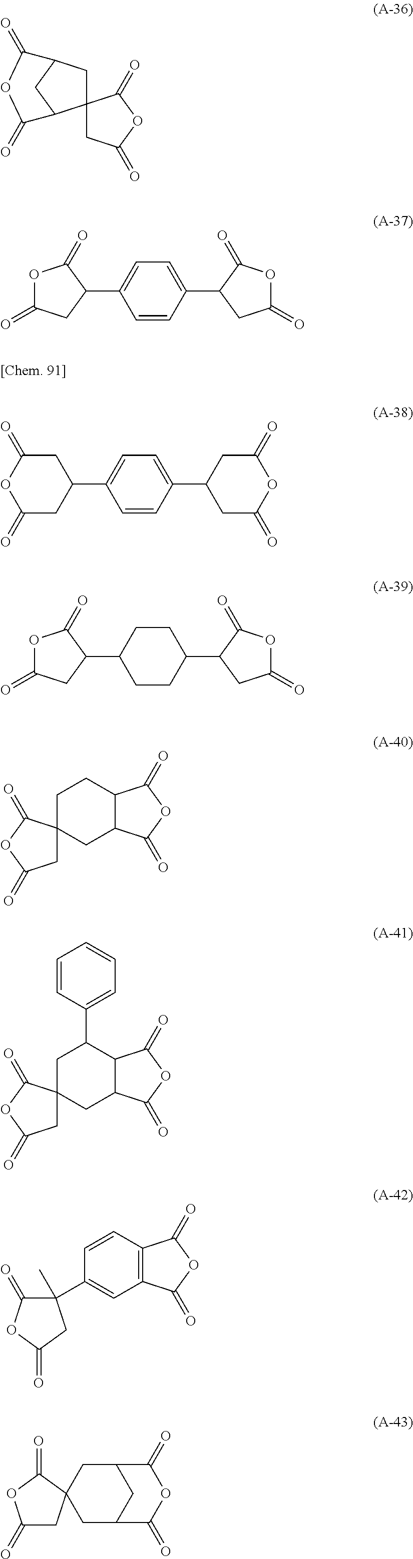

In the aforementioned compounds, the formula (A-14), the formula (A-15), the formula (A-16), the formula (A-17), the formula (A-20), the formula (A-21), the formula (A-28), the formula (A-29), the formula (A-30), and the formula (A-31) are preferred, and the formula (A-14) and the formula (A-21) are particularly preferred.

Examples of the diamine compound include the following formulae (III-1) to (VIII-17).

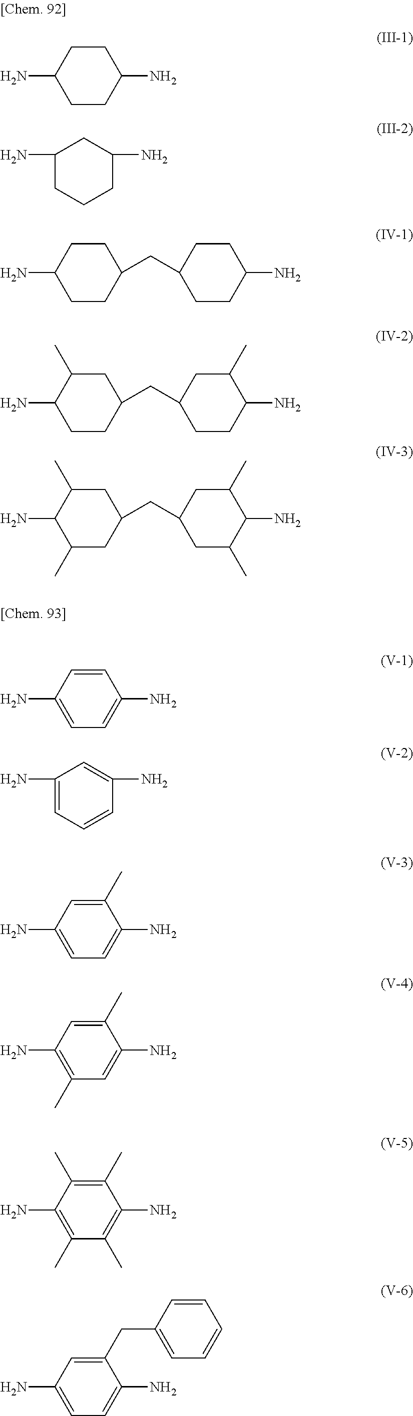

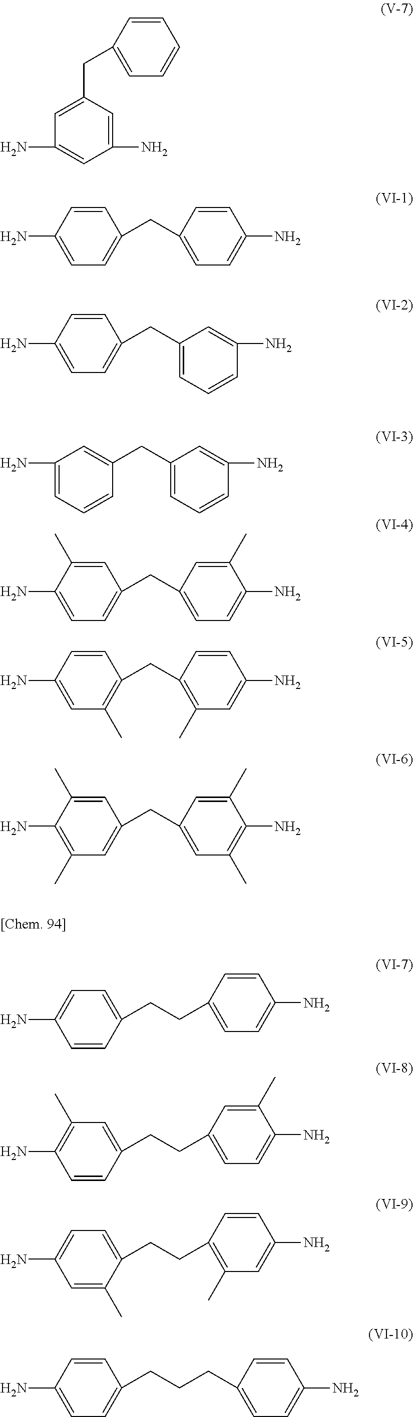

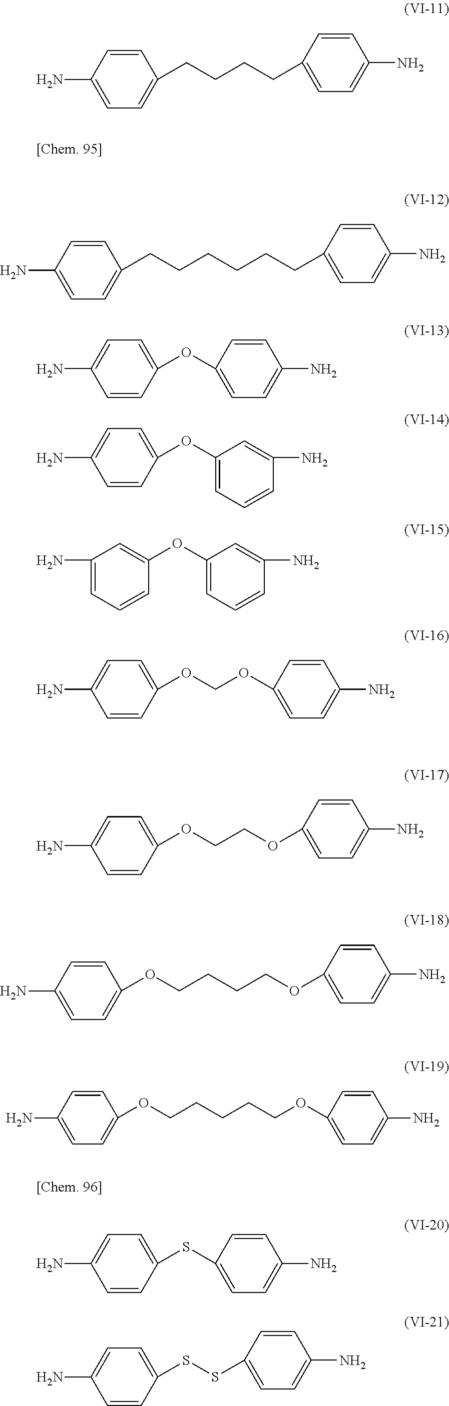

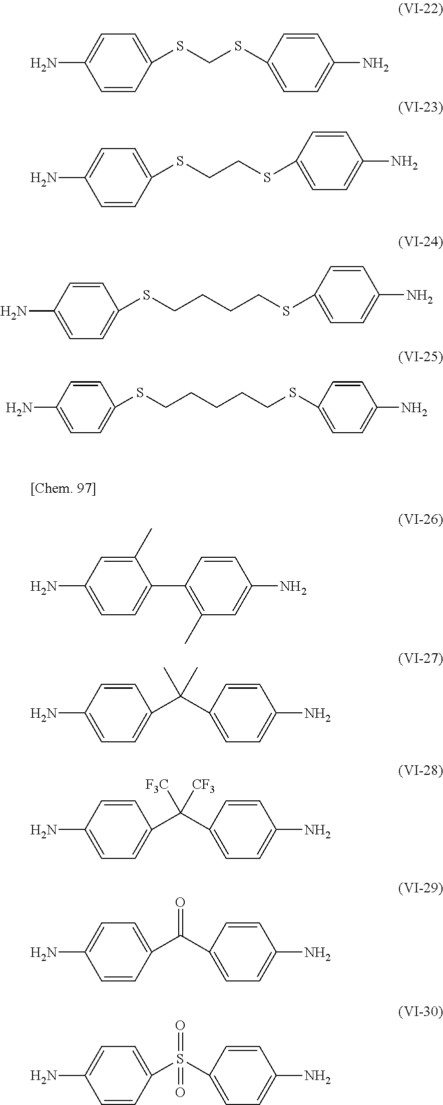

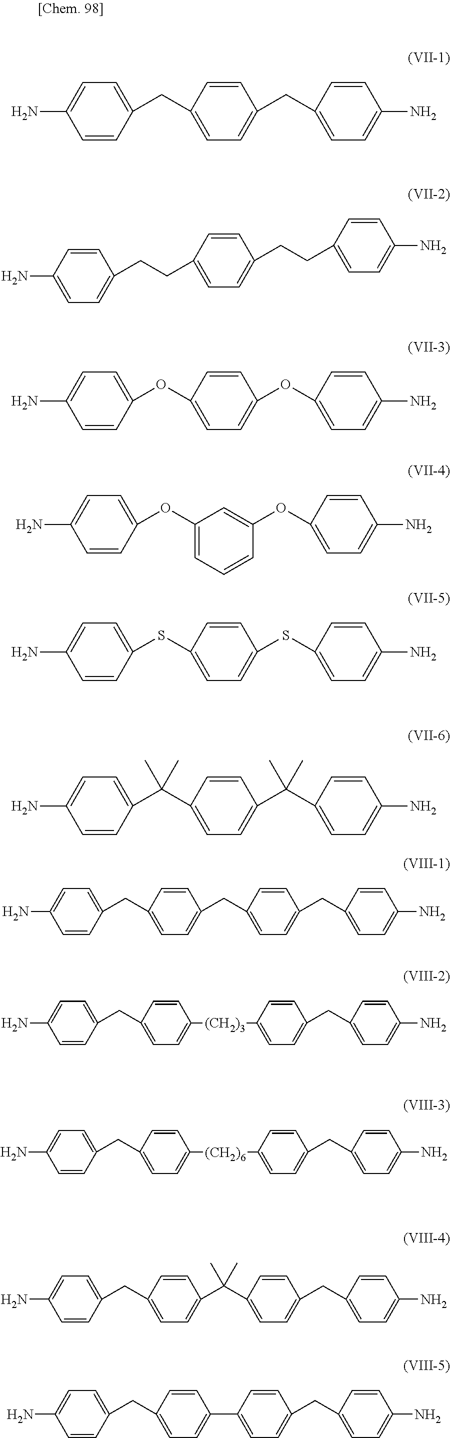

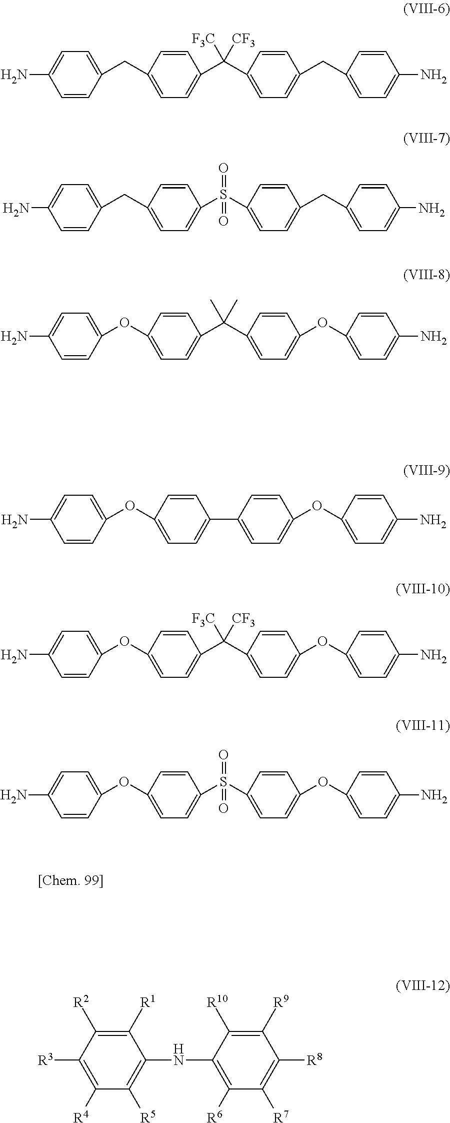

(in the general formula (VIII-12), two of R¹ to R¹⁰ each represent a primary amino group, and the others each represent a monovalent organic group other than a primary amino group, in which the groups may be the same as or different from each other)

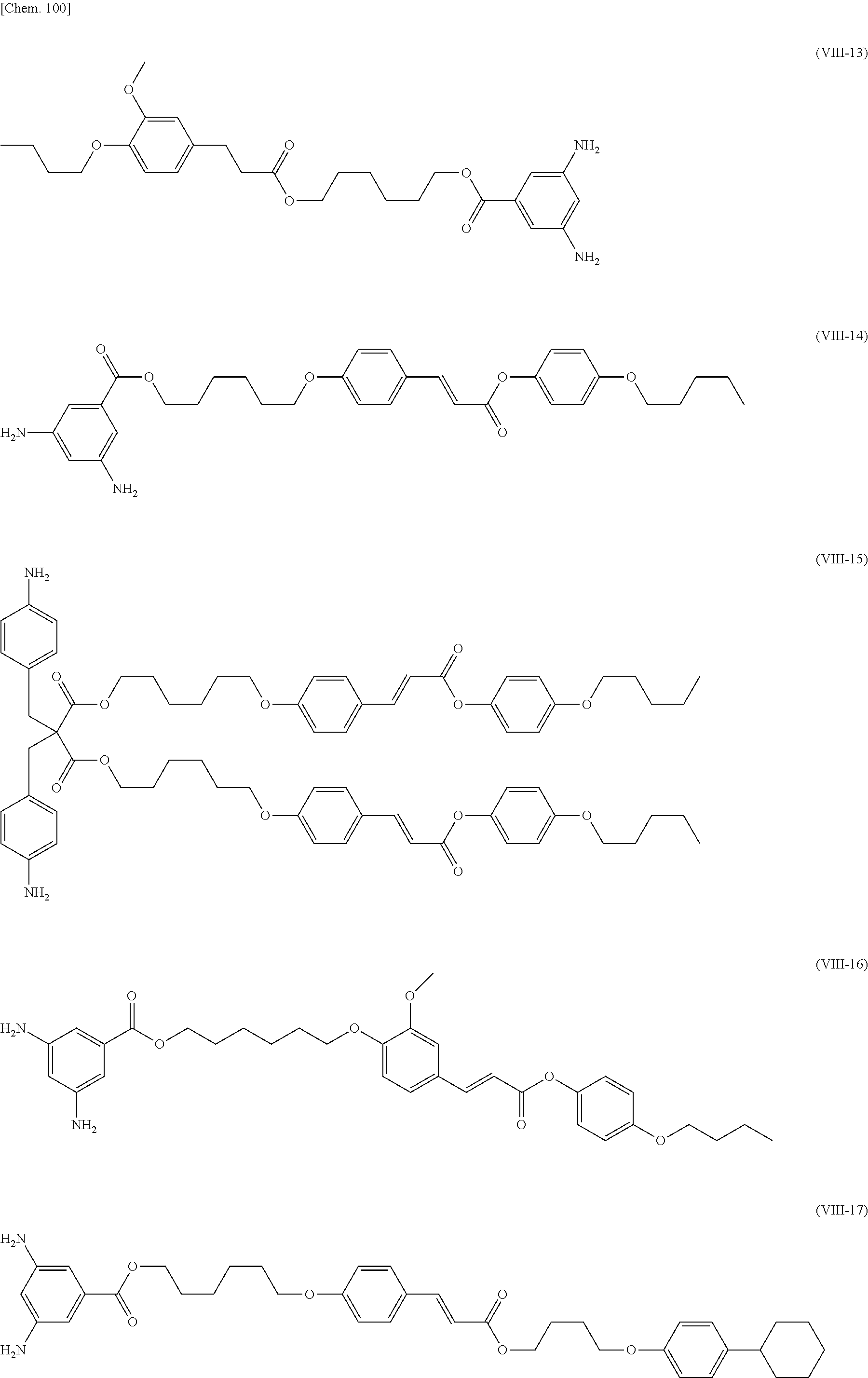

These compounds are preferably used.

The diamine compounds having a cinnamic acid skeleton represented by the formulae (1) to (5) are capable of being dimerized in response to light, and thus can be preferably used as a photoresponsive dimer type polymer.

The weight average molecular weight of the photoresponsive decomposition type polymer in the invention is preferably from 3,000 to 300,000, more preferably from 5,000 to 100,000, further preferably from 10,000 to 50,000, and particularly preferably from 10,000 to 30,000.

In the photoresponsive decomposition type polymer, the wavelength of the light used for cutting the molecular chain is preferably from 200 to 400 nm, more preferably from 200 to 280 nm, and further preferably from 240 to 280 nm.

Other examples of the photoresponsive isomerization type molecule include a polymer produced through synthesis with a tetracarboxylic dianhydride and a diamine compound, in which at least one of the tetracarboxylic dianhydride and the diamine compound has a diazo bond.

Examples of the tetracarboxylic dianhydride having a diazo bond include a compound represented by the following formula (1-8).

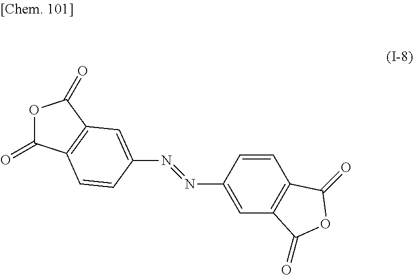 [SMILES: O=C1OC(=O)c2cc(/N=N/c3ccc4c(c3)C(=O)OC4=O)ccc21]

As the diamine compound having a diazo bond, compounds represented by the following formulae (I-1) to (I-7):

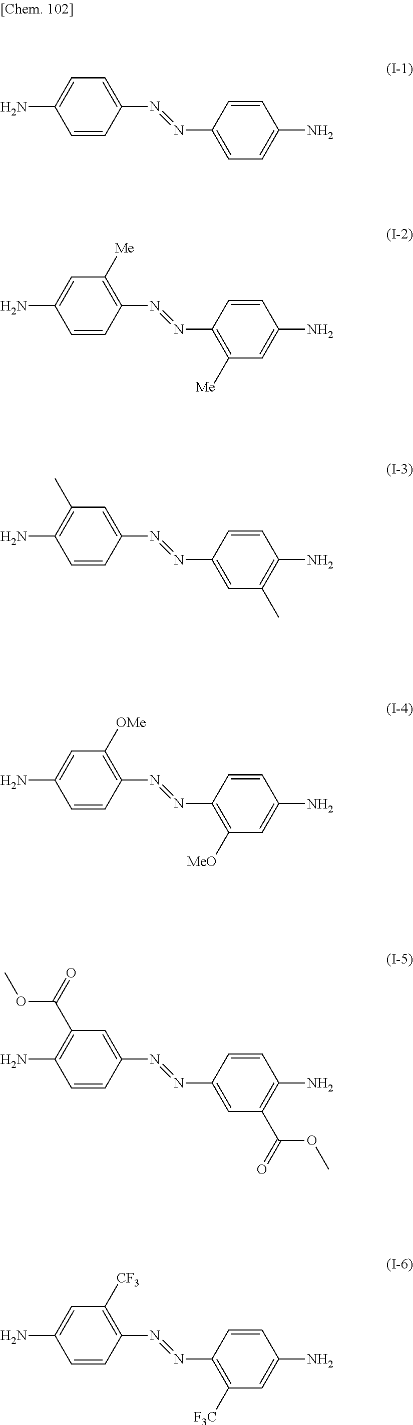

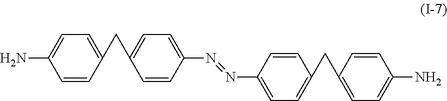 [SMILES: Nc1ccc(Cc2ccc(/N=N/c3ccc(Cc4ccc(N)cc4)cc3)cc2)cc1]

can be exemplified.

Accordingly, as a preferred embodiment of the photoresponsive isomerization type polymer in the invention, in the case where the formulae (I-1) to (I-7) are selected as the diamine compound having a diazo bond, the tetracarboxylic dianhydride is preferably the compounds represented by the formulae (1-8) and (A-1) to (A-43). As a preferred embodiment of the photoresponsive isomerization type polymer in the invention, in the case where the formula (1-8) is selected as the tetracarboxylic dianhydride having a diazo bond, the diamine compound is preferably the compound represented by the formulae (I-1) to (I-7), (III-1) to (VIII-11), (I), and (1) to (5).

In the photoresponsive isomerization type polymer, the light used for aligning in the direction substantially perpendicular to the polarizing axis through isomerization in response to light is preferably from 200 to 500 nm, more preferably from 300 to 500 nm, and further preferably from 300 to 400 nm.

The weight average molecular weight of the photoresponsive isomerization type polymer is preferably from 10,000 to 800,000, more preferably from 10,000 to 400,000, further preferably from 50,000 to 400,000, and particularly preferably from 50,000 to 300,000.

The weight average molecular weight (Mw) is obtained from results of the GPC (gel permeation chromatography) measurement.

The photo alignment layer in the invention is preferably formed of a photoresponsive alignment agent. The photoresponsive alignment agent contains a solvent component and a photo alignment component, and preferably has a yellowness index (YIS) of 0.001<YIS<500, more preferably 0.005<YIS<300, and further preferably 0.008<YIS<150. Accordingly, the photoresponsive alignment agent in the invention is preferably a solution. The photo alignment component is preferably the photoresponsive molecules described hereinabove.

According to the constitution, the alignment regulation force of the photo alignment layer to the liquid crystal layer can be increased, and thereby the definition of the liquid crystal display device can be enhanced, and the disorder of the liquid crystal alignment in the vicinity of the boundary region between the liquid crystal layer and the photo alignment layer can be reduced, or the alignment state of the liquid crystal molecules can be highly uniformized, and the display quality can be enhanced. Furthermore, the alignment disorder of the liquid crystal layer can be reduced, the alignment defect in the compensation film, the alignment disorder in the boundary region of the pattern retarder, or the alignment disorder due to the thickness of the lenticular lens can be suppressed, and the display quality of the image display device can be enhanced.

In the case of the photo alignment layer, in which the molecules of the optical anisotropy layer are aligned, the yellowness index (YIS) of the photoresponsive alignment agent of 0.001<YIS<500, and the yellowness index (YI) of the photo alignment layer as the image display device in the particular range (for example, the yellowness index of the substrate having the photo alignment layer formed thereon of 0.001<YI<100) mean the prolongation of the conjugation length of the t electrons of the photo alignment molecule contained in the photoresponsive alignment agent inducing the alignment regulation force to the molecules constituting the optical anisotropy layer in response to the light, so as to provide the rigidity of the entire molecule or a structure similar to a mesogenic structure of a liquid crystal molecule, whereby the affinity of the photo alignment molecule, i.e., the photoresponsive alignment agent, and the molecules exhibiting optical anisotropy can be enhanced, and the alignment regulation force to the molecules can be increased. Accordingly, in the image display device, the alignment defect in the compensation film, the alignment disorder in the boundary region of the pattern retarder, or the alignment disorder due to the thickness of the lenticular lens can be decreased to enhance the uniformity of alignment. In any case, the alignment regulation force is enhanced to decrease the alignment disorder of the molecules of the optical anisotropy layer, thereby providing a high definition image display device.

In the case of the photo alignment layer, in which the liquid crystal molecules of the liquid crystal medium are aligned, the yellowness index (YIS) of the photoresponsive liquid crystal alignment agent of 0.001<YIS<500, and the yellowness index (YI) of the photo alignment layer as the image display device in the particular range (for example, the yellowness index of the substrate having the photo alignment layer formed thereon of 0.001<YI<100) mean the prolongation of the conjugation length of the it electrons of the photo alignment molecule contained in the photoresponsive liquid crystal alignment agent inducing the alignment regulation force to the liquid crystal in response to the light, so as to provide the rigidity of the entire molecule or a structure similar to a mesogenic structure of a liquid crystal molecule, whereby the affinity of the photo alignment molecule, i.e., the photoresponsive liquid crystal alignment agent, and the liquid crystal molecules can be enhanced, and the alignment regulation force to the liquid crystal molecules can be increased. Accordingly, in the image display device, the alignment defect in the liquid crystal can be decreased to enhance the uniformity of alignment in the thickness direction of the liquid crystal compound. In any case, the alignment regulation force is enhanced to decrease the alignment disorder of the liquid crystal, thereby providing a high definition image display device.

The solvent component in the invention is not particularly limited as far as it dissolves the photoresponsive molecule, and may be appropriately selected depending on the properties of the photoresponsive molecule used. Examples of the solvent dissolving the photoresponsive molecule include water, a lactone series, such as γ-butyrolactone; a ketone series, such as cyclopentanone, cyclohexanone, MEK, and MIBK; an ester series, such as propylene glycol monomethyl ether acetate; and NMP (N-methyl-2-pyrrolidone). Examples of the solvent for enhancing the coating property to the substrate that may be added to the solvent include an alcohol ether series, such as 2-methoxyethanol, 2-butoxyethanol (butyl cellosolve), and carbitol (diethylene glycol monoethyl ether); and a toluene series, such as toluene.

The concentration of the photoresponsive molecule in the photoresponsive alignment agent is preferably from 0.1 to 10% by mass, more preferably from 0.2 to 10% by mass, further preferably from 0.5 to 10% by mass, and still further preferably from 0.5 to 7% by mass.

The case where the photoresponsive molecule is preferably in the range of from 0.1 to 10% by mass from the standpoint of the easiness of dissolution, the easiness of filtration of the solution, the stability of the solution, and the surface uniformity of the coated film after drying.

In the case where the photoresponsive alignment agent in the invention is coated to a substrate by screen printing, the viscosity of the photoresponsive liquid crystal agent is preferably controlled to a range of from 20 to 50 mPa·s. In the case where the photoresponsive alignment agent is formed into a film on a substrate by an ink-jet method, for forming favorable liquid droplets and preventing the nozzle head from being clogged, the viscosity of the solution is preferably controlled to a range of from 3 to 15 mPa·s, the surface tension thereof is preferably controlled to a range of from 20 to 50 N/m, and the boiling point of the solvent is preferably in a range of from 150 to 220° C.

The photoresponsive alignment agent in the invention preferably contains an ultraviolet ray absorbent that absorbs an ultraviolet ray of 320 nm or less, preferably 280 nm or less, and more preferably 250 nm or less, depending on necessity.

When the photoresponsive alignment agent of the invention contains an ultraviolet ray absorbent, the liquid crystal device can be protected from an ultraviolet ray without influence on the ultraviolet ray treatment process used for the alignment treatment since the light absorption band for the alignment of the photoresponsive molecule, which is a material having a high yellowness index, is inclined to the visible region.

The ultraviolet ray absorbent in the invention is not particularly limited and may be an organic ultraviolet ray absorbent or an inorganic ultraviolet ray absorbent, and is preferably an organic ultraviolet ray absorbent from the standpoint of the thickness and the transparency of the alignment layer and the alignment film. Examples of the ultraviolet ray absorbent include a benzoate series, a benzotriazole series, a benzophenone series, a cyclic imino ester series, a hindered amine series, and combinations thereof.

The ultraviolet ray absorbent is not particularly limited as far as it absorbs an ultraviolet ray having a shorter wavelength in the absorbance determined in the invention. Among these, a benzoate series is preferred.

Examples of the benzoate series, the benzophenone ultraviolet ray absorbent, the benzotriazole ultraviolet ray absorbent, and an acrylonitrile ultraviolet ray absorbent include 2,4-di-tert-butylphenyl 3,5-di-tert-butyl-4-hydroxybenzoate, 2-[2′-hydroxy-5′-(methacryloyloxymethyl)phenyl]-2H-benzotriazole, 2-[2′-hydroxy-5′-(methacryloyloxyethyl)phenyl]-2H-benzotriazole, 2-[2′-hydroxy-5′-(methacryloyloxypropyl)phenyl]-2H-benzotriazole, 2,2′-dihydroxy-4,4′-dimethoxybenzophenone, 2,2′,4,4′-tetrahydroxybenzophenone, 2,4-di-tert-butyl-6-(5-chlorobenzotriazol-2-yl)phenol, 2-(2′-hydroxy-3′-tert-butyl-5′-methylphenyl)-5-chlorobenzo triazole, 2-(5-chloro-(2H)-benzotriazol-2-yl)-4-methyl-6-(tert-buthl)phenol, and 2,2′-methylenebis(4-(1,1,3,3-tetramethylbutyl)-6-(2H-benzo triazol-2-yl)phenol. Examples of the cyclic imino ester ultraviolet ray absorbent include 2,2′-(1,4-phenylene)bis(4H-3,1-benzoxadin-4-one), 2-methyl-3,1-benzoxadin-4-one, 2-butyl-3,1-benzoxadin-4-one, and 2-phenyl-3,1-benzoxadin-4-one. However, the invention is not limited thereto.

The ultraviolet ray absorbent may be used solely or as a combination of two or more kinds of the ultraviolet ray absorbents. By using the combination of plural kinds thereof, ultraviolet rays of different wavelengths can be absorbed simultaneously, and thereby the ultraviolet ray absorbing effect can be further improved.

The ultraviolet ray absorbent in the invention is preferably contained in the photoresponsive alignment agent in an amount of from 0 to 5.0% by mass, more preferably contained in an amount of from 0.01 to 1.0% by mass, and further preferably contained in an amount of from 0.1 to 1.0% by mass.

When the ultraviolet ray absorbent is contained in the photoresponsive alignment agent in an amount of from 0.01 to 5.0% by mass, the photo alignment layer formed therefrom can effectively protect the liquid crystal display device from an ultraviolet ray.

In the production method of the liquid crystal display device of the invention, it is preferred that the photoresponsive alignment agent of the invention is coated on a substrate, and then the coated surface is heated to form a coated film on the substrate (step (1)).

The photoresponsive alignment agent in the invention is preferably a solvent containing the photoresponsive molecule. The photoresponsive molecule preferably contains at least one polymer selected from the group consisting of an azo derivative for the photoisomerization type, a polyimide derivative for the photodecomposition type, and a cinnamic acid derivative for the dimer type, and the organic solvent.

The photoresponsive alignment agent of the invention is coated by an offset printing method, a spin coating method, a roll coater method, or an ink-jet printing method. The substrate used may be a transparent substrate formed, for example, of glass, such as float glass and soda glass, and plastics, such as polyethylene terephthalate, polybutylene terephthalate, polyether sulfone, polycarbonate, polymethyl methacrylate, and poly(alicyclic olefin). The transparent conductive film provided on one surface of the (first) substrate may be a NESA film containing tin oxide (SnO₂), an ITO film containing indium oxide-tin oxide (In₂O₃—SnO₂), and the like. For providing a patterned transparent conductive film, such methods may be employed as a method of forming a transparent conductive film having no pattern, and then forming the pattern by photoetching, and a method of using a mask having the desired pattern on forming the transparent conductive film. In the coating of the photoresponsive alignment agent, the surface of the substrate may be subjected to a surface treatment by a known method, such as a functional silane compound and a functional titanium compound, for further improving the adhesiveness of the surface of the substrate and the transparent conductive film with the coated film.

After coating the photoresponsive alignment agent, pre-baking may be performed depending on necessity, and the pre-baking temperature in this case is preferably from 30 to 200° C. The pre-baking time is preferably from 0.25 to 10 minutes. Thereafter, a baking step is preferably performed for completely removing the solvent and depending on necessity removing the unreacted components. The baking temperature is preferably from 80 to 300° C. The baking time is preferably from 5 to 200 minutes. The thickness of the film thus formed is preferably from 0.001 to 1 m.

In the case where the polymer contained in the photoresponsive alignment agent of the invention is a polyamic acid or an imide polymer having an imide ring structure and an amic acid structure, the coated film after forming may be further heated to perform the dehydration ring-closing reaction, thereby forming an imidized film.

In the production method of the liquid crystal display device of the invention, it is preferred that the coated film containing the photoresponsive molecule (and the ultraviolet ray absorbent depending on necessity) formed on the substrate is irradiated with light (step (2)). The light, with which the coated film is irradiated, may be an ultraviolet ray or a visible ray containing light having a wavelength of from 150 to 800 nm, and is preferably an ultraviolet ray containing light having a wavelength of from 200 to 400 nm. The wavelength may be adjusted depending on the kind of the photoresponsive molecule used. Specifically, the wavelength may be 254 nm for the photoresponsive molecule for the decomposition type photo alignment layer, 313 nm for the photoresponsive molecule for the dimer type photo alignment layer, and 365 nm for the photoresponsive molecule for the isomerization type photo alignment layer.

Examples of the light source of the irradiated light include a low-pressure mercury lamp, a high-pressure mercury lamp, a deuterium lamp, a metal halide lamp, an argon resonance lamp, a xenon lamp, and an excimer laser. The ultraviolet ray of the aforementioned preferred wavelength range can be obtained by using the light source, for example, with a filter, a diffractive grating, or the like. The irradiation dose is preferably 100 J/m² or more and 100,000 J/m² or less.

Thereafter, the polymerizable liquid crystal is coated on the coated film, and after removing the solvent depending on necessity, the polymerizable liquid crystal is aligned and then cured with an ultraviolet ray or by heating. Depending on the structure of the equipment, the compensation film and the pattern retarder or the lenticular lens can be formed on the surface of the substrate of the liquid crystal display device on the side of the liquid crystal, and in this case, the pattern retarder and the lenticular lens are necessarily disposed between the polarizing plate and the observer.

The photo alignment layer of the invention will be described in detail below for the each kind of the liquid crystal layer.

### Photo Alignment Layer for Aligning Liquid Crystal Molecules of Liquid Crystal Medium

In the liquid crystal display device of the invention, the yellowness index (YI) of the first photo alignment layer or the second photo alignment layer is 0.001<YI<100, preferably 0.001<YI<50, more preferably 0.001<YI<10, further preferably 0.005<YI<10, and particularly preferably 0.01<YI<10. The yellowness index of the photo alignment layer can be obtained from the yellowness index (YIL) of the first substrate having the first photo alignment layer formed thereon or the second substrate having the second photo alignment layer formed thereon, by the method described later.

In the image display device (particularly the liquid crystal display device) of the invention, in the case where the large alignment regulation force and the short alignment treatment time are important, the yellowness index (YI) of the first photo alignment layer or the second photo alignment layer is preferably 0.01<YI<100, more preferably 0.1<YI<100, further preferably 0.5<YI<50, and still further preferably 2<YI<10. It is considered that with the YI in the range, the treatment time can be shortened due to the high absorption efficiency of the ultraviolet ray used for the alignment treatment, and the alignment of the liquid crystal molecules can be further facilitated due to the increased density of the aligned molecules formed in the alignment film. In the liquid crystal display device of the invention, in the case where the long-term reliability is important, on the other hand, the yellowness index (YI) of the first photo alignment layer or the second photo alignment layer is preferably 0.001<YI<50, more preferably 0.001<YI<10, further preferably 0.001<YI<7, and still further preferably 0.002<YI<2. It is considered that with the YI in the range, the change of the alignment film in the cell forming process and the exposure of the panel to an ultraviolet ray can be suppressed with the alignment regulation force maintained, thereby achieving the long-term reliability.

In the case where the yellowness index of the substrate having the photo alignment film formed thereon is in a range of from 0.001 to 100, the alignment property can be extremely enhanced. According thereto, in the liquid crystal display device, the alignment defect of the liquid crystal can be reduced, and the uniformity of the alignment in the thickness direction of the liquid crystal compound can be enhanced. In any case, the alignment disorder of the liquid crystal is reduced by increasing the alignment regulation force, thereby providing the high definition liquid crystal display device. It is considered that the material having a large yellowness index has a prolonged conjugation length to enhance the effect of the molecule as a mesogen, and thus the alignment property is enhanced. In the material having a large yellowness index, the light absorption band for alignment is inclined to the visible region, and therefore the ultraviolet ray absorbent can be added to the alignment layer for protecting the liquid crystal display device from an ultraviolet ray. The alignment regulation force is increased by the high liquid crystal alignment capability exhibited, and thereby the alignment defect of the liquid crystal is reduced, thereby reducing the light leakage to enhance the contrast.

The yellowness index in the invention is calculated according to JIS 7373 2006 (former JIS K7105, measurement wavelength: 380 to 780 nm, transmittance measured every 5 nm with an illuminant C lamp). Specifically, as described in the examples described later, the object to be measured is placed in a transparent cell having a light path length of 1 mm or 10 mm, and measured with a spectrophotometer (V-560, produced by JASCO Corporation). The alignment film coated on the substrate is directly mounted on the spectrophotometer and measured.

In the description herein, as the measurement method is described in the examples later, the yellowness index of the photo alignment layer itself is referred to as YI, the yellowness index of the (common and/or pixel electrode) substrate facing the color filter and the photo alignment layer is referred to as YIL, and the yellowness index of the photo alignment agent (including the photo alignment molecule and the solvent) is referred to as YIS.

In the definition of the yellowness index (YI) of the photo alignment layer itself, the measurement is difficult because of the reason that it is difficult to remove the influence of the color filter from the actual measured value of the panel, and therefore the yellowness is measured in the manner described in the example later. Specifically, the yellowness index (YIL) of the substrate that does not have the color filter formed thereon among the two substrates constituting the panel is measured before and after the formation of the alignment film, and the yellowness index YI of the alignment film is obtained from the difference thereof between before and after the formation of the alignment film. By using the method, not only the alignment film in the state where the film is actually formed on the substrate can be measured, but also even the yellowness index YI of the alignment film having constituted the panel can be measured in such a manner that the substrates are taken out from the panel, the liquid crystal attached to the substrate that does not have the color filter formed thereon is removed therefrom, and the substrate is measured for the yellowness index and then again measured for the yellowness index after removing the alignment film, and the yellowness index YI of the alignment film is estimated from the difference in yellowness index.

Accordingly, in the case where the liquid crystal display device of the invention has the color filter between the pixel electrode and the first substrate, the yellowness index (YI) obtained from the yellowness index (YIL) of the second substrate having the second alignment layer formed thereon is preferably 0.001<YI<100. In the case where the color filter is provided between the second photo alignment layer and the second substrate, on the other hand, the yellowness index (YI) obtained from the yellowness index (YIL) of the first substrate having the first alignment layer formed thereon is preferably 0.001<YI<100. The yellowness index (YI) of the first alignment layer and the second alignment layer is preferably 0.001<YI<100.

The photo alignment layer in the invention is constituted by the photo alignment film, and the average thickness of the photo alignment film is preferably from 10 to 1,000 nm, more preferably from 20 to 500 nm, and further preferably from 50 to 300 nm.

### Photo Alignment Layer for Aligning Molecules of Optical Anisotropy Layer

The yellowness index (YI) of the alignment layer used in the retardation film, such as the compensation film used for compensation of the viewing angle or the like, and the pattern retarder, and the refractive device, such as a lenticular lens, is 0.001<YI<100, preferably 0.001<YI<50, more preferably 0.001<YI<10, further preferably 0.005<YI<10, and particularly preferably 0.01<YI<10.

In the preferred range of YI of the retardation film and the refractive device, in the case where the large alignment regulation force and the short alignment treatment time are important, the yellowness index (YI) of the photo alignment layer is preferably 0.01<YI<100, more preferably 0.1<YI<100, further preferably 0.5<YI<50, and still further preferably 2<YI<10. It is considered that with the YI in the range, the treatment time can be shortened due to the high absorption efficiency of the ultraviolet ray used for the alignment treatment, and the alignment of the liquid crystal molecules can be further facilitated due to the increased density of the aligned molecules formed in the alignment film, thereby obtaining the high alignment degree and the uniformity of the alignment. In the liquid crystal display device of the invention, in the case where the luminance is important, on the other hand, the yellowness index (YI) of the alignment layer is preferably 0.001<YI<50, more preferably 0.001<YI<10, further preferably 0.001<YI<7, and still further preferably 0.002<YI<2. It is considered that with the YI in the range, the coloration of the alignment layer can be suppressed with the alignment regulation force maintained, thereby achieving the high luminance.

In the case where the yellowness index of the substrate having the alignment layer formed thereon is in a range of from 0.001 to 100, the alignment property can be extremely enhanced. According thereto, in the retardation film and the refractive device of the invention, the alignment defect of the polymerizable liquid crystal layer (which may be referred to as the optical anisotropy layer) can be reduced, and the uniformity of the alignment in the thickness direction of the liquid crystal compound can be enhanced. In any case, the alignment disorder of the liquid crystal is reduced by increasing the alignment regulation force, the alignment defect and the alignment disorder in the compensation film, the alignment disorder in the boundary region of the pattern retarder, and the alignment disorder due to the thickness of the lenticular lens are suppressed, thereby providing the high definition liquid crystal display device. It is considered that the material having a large yellowness index has a prolonged conjugation length to enhance the effect of the molecule as a mesogen, so as to enhance the alignment regulation force, and thus the alignment property of the polymerizable liquid crystal layer laminated on the alignment layer is enhanced. In the material having a large yellowness index, the light absorption band for alignment is inclined to the visible region, so as to provide a relatively high absorption efficiency of an ultraviolet ray having a relatively long wavelength, and thus by using the optical laminated material using the material as the alignment layer, in the image display device, the image display device can be protected from an ultraviolet ray having a relatively long wavelength. In the case where it is necessary to protect the image display device over the entire wavelength range including an ultraviolet ray, an ultraviolet ray absorbent may be added to the alignment layer. The alignment regulation force is increased by the high liquid crystal alignment capability exhibited, and thereby the alignment defect of the compensation film, the pattern retarder, and the lenticular lens is reduced, thereby reducing the light leakage to enhance the contrast.

The yellowness index in the invention is calculated according to JIS 7373 2006 (former JIS K7105, measurement wavelength: 380 to 780 nm, transmittance measured every 5 nm with an illuminant C lamp). Specifically, as described in the examples described later, the object to be measured is placed in a transparent cell having a light path length of 1 mm or 10 mm, and measured with a spectrophotometer (V-560, produced by JASCO Corporation). The alignment film coated on the substrate is directly mounted on the spectrophotometer and measured.

In the description herein, as the measurement method is described in the examples later, the yellowness index of the photo alignment layer itself is referred to as YI, and the yellowness index of the photo alignment agent (including the photo alignment component and the solvent) is referred to as YIS.

In the definition of the yellowness index (YI) of the photo alignment layer itself, the yellowness index is measured before and after the formation of the alignment film, and the yellowness index YI of the alignment film is obtained from the difference in yellowness index between before and after the formation of the alignment film.

The photo alignment layer in the invention is constituted by the photo alignment film, and the average thickness of the photo alignment layer is preferably from 10 to 1,000 nm, more preferably from 20 to 500 nm, and further preferably from 50 to 300 nm.

In the “photo alignment layer aligning the liquid crystal molecules of the liquid crystal medium” and also in the “photo alignment layer aligning the molecules of the optical anisotropy layer”, the image display device that has YI exceeding 100 and the photoresponsive alignment agent that has YIS exceeding 500 have a practical problem since they are colored orange and are decreased in contrast. The image display device that has YI of less than 0.001 and the photoresponsive alignment agent that has YIS of less than 0.001 have a problem that the alignment regulation force for the liquid crystal is insufficient, and alignment disorder and alignment defect are formed.

### Optical Laminated Material

The optical laminated material of the invention contains an optical anisotropy layer and a photo alignment layer as the essential components, and may have a substrate depending on necessity, and the substrate may be fixed or adhered to the image display part through a known pressure sensitive adhesive layer or adhesive layer. The order of the photo alignment layer and the optical anisotropy layer in the optical laminated material of the invention is not limited. In other words, in the case where the liquid crystal layer in the invention is the optical anisotropy layer containing at least one of the optical anisotropy molecule regulating the phase or the velocity of the transmitted light or the polymer liquid crystal, a laminated structure that contains the photo alignment layer and the optical anisotropy layer is defined as the optical laminated material. The substrate used may be the same materials as used in a liquid crystal display device and an organic EL display device, and may also be glass, ceramics, plastics, and the like. Examples of the plastic substrate include a cellulose derivative, such as cellulose, triacetyl cellulose, and diacetyl cellulose, a polycycloolefin derivative, a polyester, such as polyethylene terephthalate and polyethylene naphthalate, polyolefin, such as polypropylene and polyethylene, polycarbonate, polyvinyl alcohol, polyvinyl chloride, polyvinylidene chloride, polyamide, polyimide, polyimideamide, polystyrene, polyacrylate, polymethyl methacrylate, polyether sulfone, polyarylate, and an inorganic-organic composite material, such as a glass fiber-epoxy resin and a glass fiber-acrylic resin. The optical anisotropy layer and the alignment layer as the constitutional components of the optical laminated material will be described in detail below.

### Optical Anisotropy Layer

The optical anisotropy layer of the invention preferably contains molecules exhibiting optical anisotropy, and more preferably contains a polymer exhibiting optical anisotropy. Specifically, the component constituting the optical anisotropy layer is preferably a polymer obtained from the polymerizable liquid crystal compound described above. The optical anisotropy layer may be obtained from the polymerizable liquid crystal composition containing the polymerizable liquid crystal compound.

The average thickness of the optical anisotropy layer of the invention cannot be determined unconditionally since the necessary phase retardation varies depending on the purposes, and is approximately preferably from 0.1 to 10 μm, more preferably from 0.5 to 5 μm, and further preferably from 0.8 to 3 μm.

### Photo Alignment Layer

The photo alignment layer contained in the optical laminated material of the invention is as described above, and is omitted herein.

### Substrate

The substrate (i.e., the first substrate and/or the second substrate) used in the liquid crystal display device of the invention is preferably a transparent substrate, and the first substrate and the second substrate used may be the same as or different from each other. In the description herein, the first and the second are used for convenience sake (which is the same as the other components).

Examples of the substrate include glass or a flexible transparent material, such as plastics, and may be an opaque material, such as silicone. The transparent substrate having a transparent electrode layer can be obtained, for example, by sputtering indium tin oxide (ITO) on the transparent substrate, such as a glass plate.

The first substrate and the second substrate in the invention are not particularly limited in the material thereof as far as they are substantially transparent, and in relation to the solvent used in the photoresponsive molecule solution, are not limited in the material thereof as far as they are formed of a material that is not dissolved in the solvent, and the material used for the substrate may be the same as for the substrate of the aforementioned “optical anisotropy layer”, and thus is omitted herein.

In the case where a plastic substrate is used as the first substrate or the second substrate, a barrier film is preferably provided on the surface of the substrate. The function of the barrier film is to lower the moisture permeability of the plastic substrate, so as to enhance the reliability of the electric characteristics of the liquid crystal display device. The barrier film is not particularly limited as far as the film has high transparency and small water vapor permeability, and a thin film formed by vapor deposition, sputtering, or a chemical vapor deposition method (CVD method) using an inorganic material, such as silicon oxide, may be generally used.

In the invention, the same material may be used for the first substrate and the second substrate, and different materials may be used therefor, without any particular limitation. A glass substrate is preferably used since the liquid crystal display device produced is excellent in heat resistance and dimensional stability. A plastic substrate is preferably used since the device is suitable for the production method by the roll-to-roll method, and is suitable for reducing the weight thereof and for imparting flexibility thereto. For the purpose of imparting flatness and heat resistance, a good result may be obtained by combining a plastic substrate and a glass substrate.

The substrate in the invention may have the (photo) alignment layer in contact with the liquid crystal layer on one surface thereof, and the retardation layer formed on the other surface thereof. The “retardation layer” means a layer having a phase retardation controlling function capable of performing optical compensation to the change of retardation of light, and specifically preferably contains a retardation substrate, an (photo) alignment layer formed on one surface of the retardation substrate, and a liquid crystal composition layer formed on the surface of the (photo) alignment layer. The retardation layer may have an adhesive layer and/or a protective film formed on the other surface of the retardation substrate depending on necessity, and an adhesive layer may be formed on the surface of the liquid crystal compound layer. The retardation layer and the first substrate or the second substrate are preferably provided through the adhesive layer without the retardation substrate. Accordingly, the image display device, particularly the liquid crystal display device, of the invention may have the liquid crystal layer that is in both embodiments of the liquid crystal medium and the optical anisotropy layer. In this case, the liquid crystal display device preferably has the photo alignment layer in contact with the (driving) liquid crystal layer, and the optical laminated material on the surface of the image display part.

### EXAMPLES

The invention will be described more specifically with reference to examples below, but the scope of the invention is not limited thereto.

### Measurement Methods

### (1) Measurement Method of Yellowness Index (YIS) of Photoresponsive Alignment Material Solution

The photoresponsive alignment material was dissolved in a solvent to forma 0.2 or 3.5% by weight solution. The solution used NMP/2-butoxyethanol=1/1. In the case where it is difficult to provide a uniform solution due to the poor solubility of the photoresponsive alignment material, a minimum amount of a solvent having high solubility may be added. The solution was placed in a transparent cell having a light path length of 1 mm or 10 mm, and yellowness index was calculated by using a spectrophotometer (V-560, produced by JASCO Corporation) according to JIS 7373 (former JIS K7105). Assuming that the resulting measured value was proportional to the concentration and the light path length, the measured value was converted to the case where the measurement was performed at a concentration of the photoresponsive alignment material solution of 0.2% by mass using a cell having a light path length of 1 mm, which was designated as the yellowness index YIS.

### (2) Measurement Method of Yellowness Index (YI) of Photo Alignment Layer

The yellowness index of the substrate before producing the optical laminated material was measured as a control. Subsequently, the alignment layer was formed on the substrate under the same condition as in the production of the actual retardation film or refractive device. Specifically, the photoresponsive alignment material solution was coated and dried, and then irradiated with an ultraviolet ray. While the formation condition varied depending on the target image display device and photoresponsive alignment material, for example, the photoresponsive alignment material solution was coated on the substrate with a spin coater, and dried at 100° C. for 3 minutes to form a coated layer having a thickness of approximately 90 nm, and the substrate having the coated film formed thereon was irradiated with linear polarized light (luminance: 20 mW/cm²) of ultraviolet light (having a wavelength range with a center wavelength of 254 nm, 313 nm, or 365 nm depending on the photoresponsive alignment material) in the vertical direction for 10 seconds with a polarized light irradiation device equipped with a super-high-pressure mercury lamp, a wavelength cut filter, a band pass filter, and a polarization filter, so as to radiate energy of 200 mJ/cm². In the evaluation of YI, the coating method, the drying condition, the ultraviolet light irradiation device, the wavelength range and the irradiation energy (i.e., the irradiation intensity and the irradiation time) were the conditions, with which the liquid crystal display device was actually produced. The yellowness index of the substrate having the alignment layer formed thereon and the yellowness index of the substrate before forming the alignment layer were calculated by using a spectrophotometer (V-560, produced by JASCO Corporation) according to JIS 7373 (former JIS K7105). The difference between the yellowness index of the substrate having the alignment layer formed thereon and yellowness index of the substrate itself was designated as the yellowness index (YI) of the photo alignment layer.

### (3) Measurement Method of Yellowness Index (YIL) of Substrate and Photo Alignment Layer

In the two substrates constituting the cell, the substrate facing the substrate having the color filter formed thereon, for example, after forming the alignment layer under the condition with consideration of the characteristics of the cell, on the common electrode and/or the pixel electrode formed on the surface by the same method as above (as described in (2) “Measurement Method of Yellowness Index (YI) of Photo Alignment Layer” above), the yellowness index was calculated by using a spectrophotometer (V-560, produced by JASCO Corporation) according to JIS 7373 (former JIS K7105).

### (4) Evaluation Method of Alignment Regulation Force (Anchoring Energy)

The photoresponsive alignment material solution was coated on a glass substrate with a spin coater to provide an alignment layer having a thickness of approximately 90 nm. Subsequently, the glass substrate having the alignment layer formed thereon was irradiated with linear polarized light (luminance: 20 mW/cm²) of ultraviolet light (having a wavelength range with a center wavelength of 254 nm, 313 nm, or 365 nm depending on the photoresponsive alignment material) in the vertical direction for 10 seconds with a polarized light irradiation device equipped with a super-high-pressure mercury lamp, a wavelength cut filter, a band pass filter, and a polarization filter, so as to radiate energy of 200 mJ/cm².

Two of the glass substrates each having the photoresponsive alignment layer thus formed were prepared, and were adhered to each other in such a manner that the alignment layers faced each other with a cell gap of 10 μm, thereby providing a liquid crystal cell. At this time, the two glass substrates each having the photo alignment layer were disposed in such a manner that the vibration directions of the radiated polarized ultraviolet ray were in parallel to each other.

With the liquid crystal cell, the azimuthal anchoring energy of the photo alignment layer was measured according to the method referred to as the torque balance method (the method reported in Proceedings of Japanese Liquid Crystal Conference (2001), pp. 251-252).

The following liquid crystal composition (1) was injected to the liquid crystal cell, heated to 92° C. for 2 minutes, and cooled to room temperature. The liquid crystal cell was disposed on an optical measurement system (OMS-D14RD, produced by Chuo Precision Industrial Co., Ltd.) equipped with a white light source, a polarizer (a polarizing plate on the incident side), an analyzer (a polarizing plate on the emission side), and a detector, between the polarizer and the analyzer, and the amount of the transmitted light was detected with the detector while rotating the polarizer and the analyzer, at which the rotation angle of the polarizer and the analyzer providing the minimum value of the detected amount of light was obtained and designated as the twist angle φ₁.

Subsequently, the liquid crystal composition (1) was withdrawn from the liquid crystal cell, and instead the following liquid crystal composition (2) was injected, heated to 2° C. for 2 minutes, and then cooled to room temperature. The rotation angle of the polarizer and the analyzer providing the minimum value of the detected amount of light was obtained in the same manner as above and designated as the twist angle 42.

The azimuthal anchoring energy A was obtained by the expression (1). Herein, K₂₂ represents the twist elastic coefficient of the liquid crystal, d represents the cell gap, and p represents the helical pitch of the chiral liquid crystal.

[Math. 1]

A=2K₂₂(2 πd/p−φ₂)/d·sin(φ₂−φ₁) (1)

### (5) Evaluation Method of Contrast

The device to be measured (such as the stereoscopic image display device having a lenticular lens, the stereoscopic image display device having a pattern retarder, the liquid crystal display device having a retardation film, the liquid crystal display device, and the like described in the following examples) was disposed on an optical measurement system (OMS-D14RD, produced by Chuo Precision Industrial Co., Ltd.) equipped with a white light source, a polarizer (a polarizing plate on the incident side), an analyzer (a polarizing plate on the emission side), and a detector, between the polarizer and the analyzer, and the amount of the transmitted light was detected with the detector while rotating the polarizer and the analyzer. The contrast was defined by (contrast)=(parallel nicols luminance)/(crossed nicols luminance), and measured in a state where no voltage was applied to the liquid crystal layer.

### Preparation Example of Photoresponsive Alignment Material Solution 1

As a photoresponsive alignment material paint, a mixture of 1 part by weight of tetrasodium 3,3′-[(2,2′-disulfo-1,1′-biphenyl-4,4′-diyl)bis(azo)]bis[6-hydroxybenzoate] (trivial name: C.I. Mordant Yellow 26), 42 parts by weight of 2-butoxyethanol, 42 parts by weight of carbitol (diethylene glycol monoethyl ether), and 15 parts by weight of water was agitated at room temperature for 10 minutes to prepare a uniform solution (photoresponsive alignment material solution 1). The yellowness index (YIS) thereof was 110. The azimuthal anchoring energy thereof measured was 230 μJ/m².

### Preparation Example of Photoresponsive Alignment Material Solution 2

As a photoresponsive alignment material paint, a mixture of 3.5 parts by weight the cinnamic acid photo alignment polymer having the following structure, 48.3 parts by weight of NMP, and 48.2 parts by weight of 2-butoxyethanol was agitated at room temperature for 10 minutes to prepare a uniform solution (photoresponsive alignment material solution 2). The yellowness index (YIS) thereof was 0.01. The azimuthal anchoring energy thereof measured was 100 μJ/m².

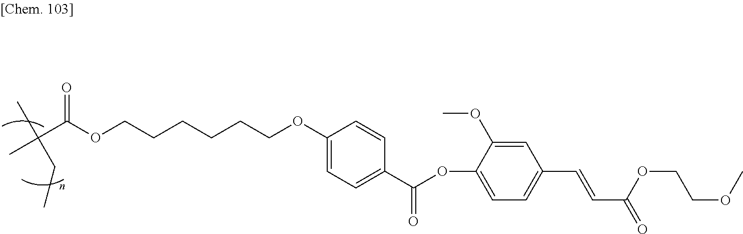

### Preparation Example of Photoresponsive Alignment Material Solution 3

As a photoresponsive alignment material paint, a mixture of 1×10⁻⁴ part by weight of tetrasodium 3,3′-[(2,2′-disulfo-1,1′-biphenyl-4,4′-diyl)bis(azo)]bis[6-hydroxybenzoate] (trivial name: C.I. Mordant Yellow 26), 42.5 parts by weight of 2-butoxyethanol, 42.5 parts by weight of carbitol, and 15 parts by weight of water was agitated at room temperature for 10 minutes to prepare a uniform solution (photoresponsive alignment material solution 3). The azimuthal anchoring energy thereof measured was 34 μJ/m².

### Preparation Example of Photoresponsive Alignment Material Solution 4

As a photoresponsive alignment material paint, a mixture of 0.04 part by weight the same cinnamic acid photo alignment polymer as in Preparation Example 2, 49.8 parts by weight of NMP, and 49.8 parts by weight of 2-butoxyethanol was agitated at room temperature for 10 minutes to prepare a uniform solution (photoresponsive alignment material solution 4). The azimuthal anchoring energy thereof measured was 23 μJ/m².

### Preparation Example of Photoresponsive Alignment Material Solution 5

As a photoresponsive alignment material paint, a mixture of 3.5 parts by weight the cinnamic acid photo alignment polymer having the following structure, 48.3 parts by weight of NMP, and 48.2 parts by weight of 2-butoxyethanol was agitated at room temperature for 10 minutes to prepare a uniform solution (photoresponsive alignment material solution 5). The yellowness index (YIS) thereof was 0.03. The azimuthal anchoring energy thereof measured was 181 μJ/m².

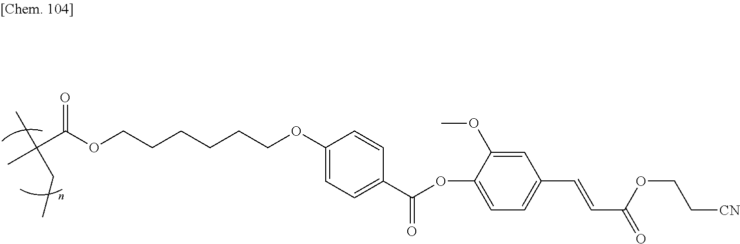

### Preparation Example of Photoresponsive Alignment Material Solution 6

As a photoresponsive alignment material paint, a mixture of 2.0 parts by weight the polyamic acid (a polyimide photo alignment polymer) and 98.0 parts by weight of NMP was agitated at room temperature for 10 minutes to prepare a uniform solution (photoresponsive alignment material solution 6). The yellowness index (YIS) thereof was 92. The azimuthal anchoring energy thereof measured was 205 μJ/m².

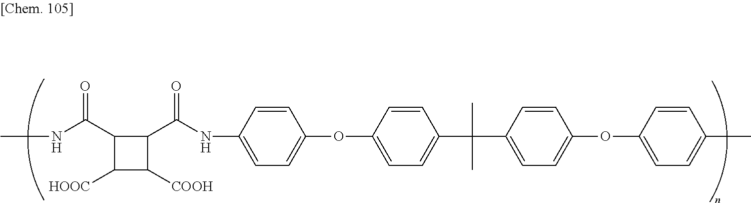

### Preparation Example of Photoresponsive Alignment Material Solution 7

As a photoresponsive alignment material paint, a mixture of 1 part by weight of C.I. Mordant Yellow 26, 2×10⁻³ part by weight of 2,4-di-tert-butylphenyl 3,5-di-tert-butyl-4-hydroxybenzoate (ultraviolet ray absorbent), 42 parts by weight of 2-butoxyethanol, 42 parts by weight of carbitol (diethylene glycol monoethyl ether), and 15 parts by weight of water was agitated at room temperature for 10 minutes to prepare a uniform solution (photoresponsive alignment material solution 7). The yellowness index (YIS) thereof was 130. The azimuthal anchoring energy thereof measured was 210 μJ/m².

### Example 1

### Stereoscopic Image Display Device Having Lenticular Lens

A transparent electrode was formed on a first glass substrate, and a black matrix (BM) was formed on a second glass substrate, and then a red colored composition was coated as a color filter to a thickness of 2 μm by spin coating. After drying at 70° C. for 20 minutes, the coated film was subjected to pattern exposure in a stripe form with an ultraviolet ray through a photomask with an exposure device equipped with a super-high-pressure mercury lamp. The coated film was subjected to spray development with an alkali developer solution for 90 seconds, rinsed with ion exchanged water, and air-dried. The coated film was subjected to post-baking in a clean oven at 230° C. for 30 minutes, so as to form red pixels as the colored layer in a stripe form on the transparent substrate. Similarly, a green colored composition was coated to a thickness of 2 μm by spin coating, dried, and exposed with an exposure device and developed at positions deviated from the red pixels to form a colored layer in a stripe form as green pixels adjacent to the red pixels. Furthermore, a blue colored composition was coated to a thickness of 2 μm by spin coating to form blue pixels adjacent to the red pixels and the green pixels. Consequently, a color filter having the pixels in a stripe form for three colors, red, green, and blue, on the transparent substrate was obtained.

Subsequently, the photoresponsive alignment material solution 1 was filtered with a 0.2 micron membrane filter, then coated on both the substrates with a spin coater at a rotation number of 1,800 rpm, and dried at 100° C. for 3 minutes, so as to form a coated film having a thickness of 90 nm on the substrate. The visual observation of the coated film thus formed confirmed that a flat film was formed. The film thus formed was irradiated with linear polarized light (luminance: 20 mW/cm²) of ultraviolet light (wavelength: 365 nm) in the vertical direction for 10 seconds with a polarized light irradiation device equipped with a super-high-pressure mercury lamp, a wavelength cut filter, a band pass filter, and a polarization filter, so as to radiate energy of 200 mJ/cm², thereby providing a photo alignment layer.

A sealant was filled in a dispenser syringe, and after subjecting to a defoaming treatment, the sealant was coated with the dispenser on the first substrate on the side of the alignment layer to draw a rectangular frame. In the state where the sealant was not cure, microdroplets of the following liquid crystal composition 1 were coated dropwise over the entire surface within the frame on the first substrate, and immediately thereafter the second substrate was adhered thereto under vacuum of 5 Pa with a vacuum adhering device. The drawing condition and the gap between the substrates were adjusted in such a manner that after releasing the vacuum, the line width of the collapsed sealant was approximately 1.2 mm, in which 0.3 mm overlapped the BM. Immediately thereafter, the sealant was heat-cured by a heat treatment at 120° C. for 1 hour, thereby producing an IPS type liquid crystal display device (1) (d_{gap}=4.0 μm). The composition and the property values of the liquid crystal composition (1) are shown below.

### Liquid Crystal Composition (1)

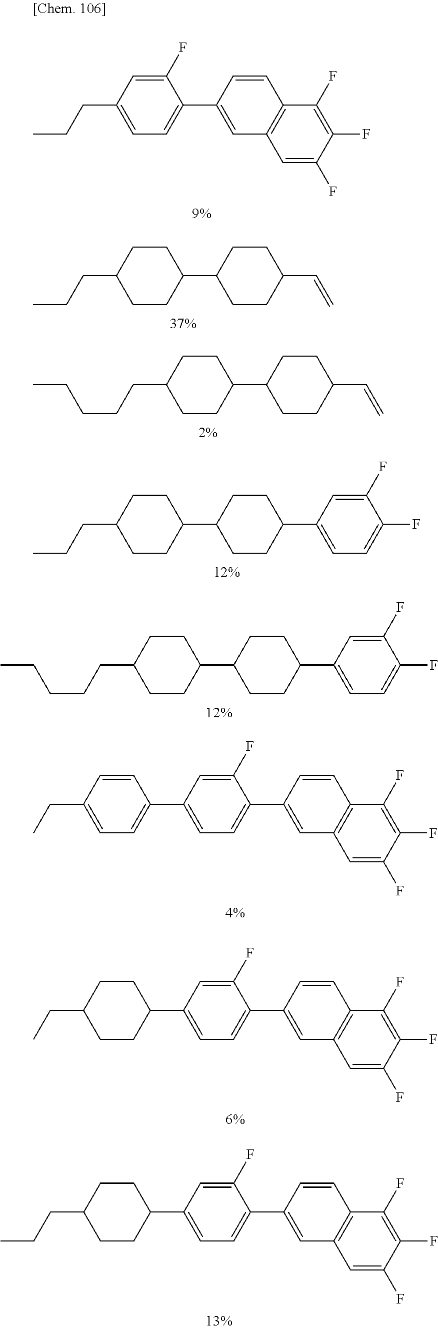

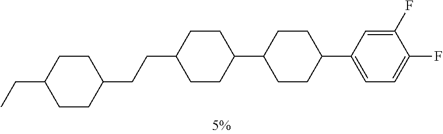 [SMILES: CCC1CCC(CCC2CCC(C3CCC(c4ccc(F)c(F)c4)CC3)CC2)CC1]

The liquid crystal composition (1) had a nematic-isotropic liquid phase transfer temperature of 85.6° C., ne (extraordinary light refractive index at a wavelength of 589 nm) of 1.596, no (extraordinary refractive index at a wavelength of 589 nm) of 1.491, a dielectric anisotropy of +7.0, K₂₂ of 7.4 pN.

The compound represented by the following formula was added in an amount of 0.25% by mass to the liquid crystal composition (1) to prepare a liquid crystal composition (2). The pitch measured was 40.40 μm.

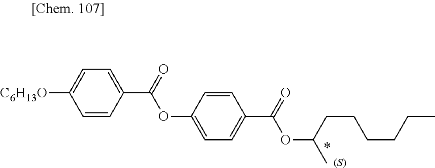

The photoresponsive alignment material solution 1 was coated on a glass substrate having a thickness of 0.7 mm by a spin coating method, and dried at 100° C. for 3 minutes to form a coated film having a thickness of 90 nm on the substrate. The visual observation of the coated film thus formed confirmed that a flat film was formed. The film thus formed was irradiated with linear polarized light (luminance: 20 mW/cm²) of ultraviolet light (wavelength: 365 nm) in the vertical direction for 10 seconds with a polarized light irradiation device equipped with a super-high-pressure mercury lamp, a wavelength cut filter, a band pass filter, and a polarization filter, so as to radiate energy of 200 mJ/cm², thereby providing a photo alignment layer. A photo alignment layer was similarly formed on a transparent resin mold for a lenticular lens.

The following birefringence material (1) in the state heated to 55° C. was coated on the glass substrate having the photo alignment layer obtained above, by a spin coating method. The transparent resin mold having been subjected to the alignment treatment was pressed on the resulting coated film, which was then cooled to room temperature. At this time, the substrate having been subjected to the alignment treatment and the mold were disposed in such a manner that the alignment direction of the substrate was in parallel to the alignment direction of the mold. Thereafter, the substrate was irradiated with an ultraviolet ray at an intensity of 40 mW/cm² for 25 seconds by using a high-pressure mercury lamp, so as to provide a lenticular lens (1). The lenticular lens (1) had no defect and had good alignment property. The lenticular lens (1) was laminated on the IPS type liquid crystal display device (1), thereby providing a stereoscopic image display device.

The contrast of the stereoscopic image display device measured was 135. The yellowness index (YI) of the alignment layer formed on the glass substrate was 6.1. As a result, the stereoscopic image display device had larger contrast and less amounts of defect, alignment disorder, and light leakage than the stereoscopic image display devices of Comparative Examples 1 and 2, and thus was a high definition liquid crystal display device.

### Birefringence Material (1)

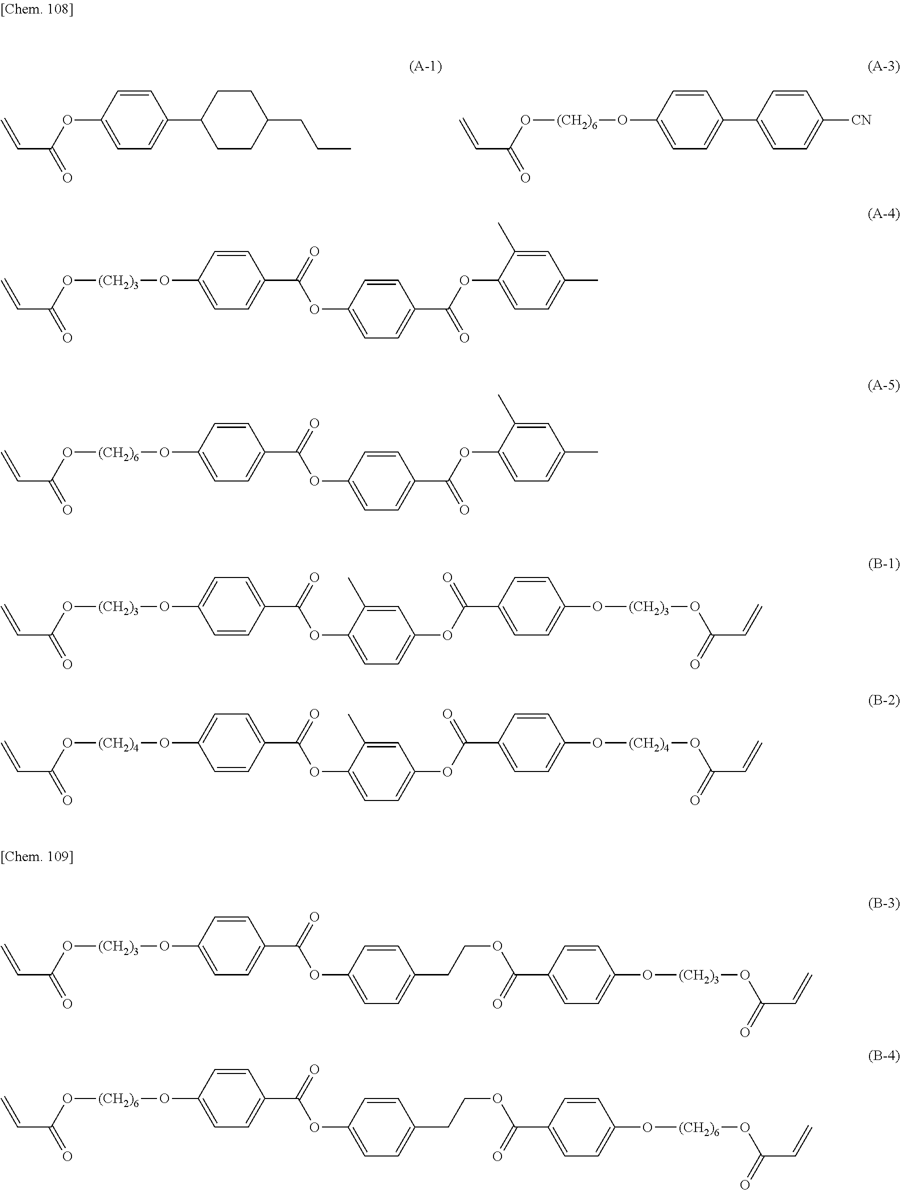

Darocure TPO (C-1)

p-Methoxyphenol (D-1)

Butyl acrylate (E-1) (produced by Toagosei Co., Ltd.)

Irganox 1076 (E-2) (produced by BASF AG)

The compositional ratios of the compounds (% by mass) are shown in the following table.

TABLE 1

| A-1 | A-3 | A-4 | A-5 | B-1 | B-2 | B-3 | B-4 | C-1 | D-1 | E-1 | E-2 |
|---|---|---|---|---|---|---|---|---|---|---|---|
| 10 | 15 | 10 | 10 | 15 | 15 | 10 | 10 | 0.1 | 0.1 | 5 | 0.2 |

The birefringence material (1) in the invention had a transition temperature from a solid phase to a liquid crystal phase of −27° C. and a transition temperature from a liquid crystal phase to a liquid phase of 70° C.

### Comparative Example 1

### Stereoscopic Image Display Device Having Lenticular Lens

An IPS type stereoscopic image display device was produced in the same manner as in Example 1, except that the photoresponsive alignment material solution 3 was used instead of the photoresponsive alignment material solution 1.

The yellowness index (YI) of the alignment layer formed on the glass substrate of the lenticular lens laminated in the stereoscopic image display device was 6.7×10⁻⁴. The contrast of the display device measured was 76.

### Example 2

### Stereoscopic Image Display Device Having Lenticular Lens

An IPS type stereoscopic image display device was produced in the same manner as in Example 1 using the IPS type liquid crystal display device (1) as similar to Example 1, except that the photoresponsive alignment material solution 2 was used as the material for the alignment layer formed on the glass substrate instead of the photoresponsive alignment material solution 1. The thickness of the alignment layer on the glass substrate was 290 nm.

The contrast of the stereoscopic image display device measured was 110. The yellowness index (YI) of the alignment layer formed on the glass substrate of the lenticular lens was 2.0×10⁻³. As a result, the stereoscopic image display device had larger contrast and less amounts of defect, alignment disorder, and light leakage than the stereoscopic image display devices of Comparative Examples 1 and 2, and thus was a high definition liquid crystal display device.

### Comparative Example 2

### Stereoscopic Image Display Device Having Lenticular Lens

An IPS type stereoscopic image display device was produced in the same manner as in Example 1 using the IPS type liquid crystal display device (1) as similar to Example 1, except that the photoresponsive alignment material solution 4 was used as the material for the photo alignment layer formed on the glass substrate instead of the photoresponsive alignment material solution 1. The contrast of the display device measured was 64. The yellowness index (YI) of the photo alignment layer formed on the glass substrate having the transparent electrode was 4×10⁻⁵.

### Example 3

### Stereoscopic Image Display Device Having Lenticular Lens

An IPS type stereoscopic image display device was produced in the same manner as in Example 1 using the IPS type liquid crystal display device (1) as similar to Example 1, except that the photoresponsive alignment material solution 5 was used as the material for the photo alignment layer formed on the glass substrate instead of the photoresponsive alignment material solution 1. The thickness of the alignment layer on the glass substrate was 290 nm.

The contrast of the stereoscopic image display device measured was 127. The yellowness index (YI) of the photo alignment layer formed on the glass substrate of the lenticular lens was 5×10⁻³. As a result, the stereoscopic image display device had larger contrast and less amounts of defect, alignment disorder, and light leakage than the stereoscopic image display devices of the comparative examples, and thus was a high definition liquid crystal display device.

### Example 4

### Stereoscopic Image Display Device Having Lenticular Lens

An IPS type stereoscopic image display device was produced in the same manner as in Example 1 using the IPS type liquid crystal display device (1) as similar to Example 1, except that the photoresponsive alignment material solution 6 was used in the production of the lenticular lens as the material for the photo alignment layer formed on the glass substrate instead of the photoresponsive alignment material solution 1, and after the formation of the coated film with a spin coater, the coated film was subjected to a heat treatment at 80° C. for 5 minutes and at 250° C. for 1 hour, and for the irradiation condition of ultraviolet light on the coated film, the coated film was irradiated with a polarized ultraviolet ray having a wavelength of 254 nm to 2,000 mJ/cm². The thickness of the alignment layer on the glass substrate was 160 nm.

The contrast of the stereoscopic image display device measured was 130. The yellowness index (YI) of the photo alignment layer formed on the glass substrate of the lenticular lens was 4.3.

As a result, the stereoscopic image display device had larger contrast and less amounts of defect, alignment disorder, and light leakage than the stereoscopic image display devices of the comparative examples, and thus was a high definition liquid crystal display device.

### Example 5

### Stereoscopic Image Display Device Having Lenticular Lens

An IPS type stereoscopic image display device was produced in the same manner as in Example 1 using the IPS type liquid crystal display device (1) as similar to Example 1, except that the photoresponsive alignment material solution 7 was used in the production of the lenticular lens as the material for the photo alignment layer formed on the glass substrate instead of the photoresponsive alignment material solution 1. The thickness of the alignment layer on the glass substrate was 90 nm. The contrast of the stereoscopic image display device measured was 133.

The yellowness index (YI) of the photo alignment layer formed on the glass substrate of the lenticular lens was 6.9.

As a result, the stereoscopic image display device had larger contrast and less amounts of defect, alignment disorder, and light leakage than the stereoscopic image display devices of Comparative Examples 1 and 2, and thus was a high definition liquid crystal display device. No change of the contrast was found before and after the curing of the sealant with an ultraviolet ray and heat in the production process of the device, and thus the deterioration due to light was suppressed and prevented.

### Example 6

### Stereoscopic Image Display Device Having Pattern Retarder

The photoresponsive alignment material solution 1 was coated on a glass substrate having a thickness of 0.7 mm by a spin coating method, and dried at 100° C. for 3 minutes to form a coated film having a thickness of 90 nm on the substrate. The visual observation of the coated film thus formed confirmed that a flat film was formed. The film thus formed was irradiated with linear polarized light (luminance: 20 mW/cm²) of ultraviolet light (wavelength: 365 nm) in the vertical direction for 10 seconds with a polarized light irradiation device equipped with a super-high-pressure mercury lamp, a wavelength cut filter, a band pass filter, and a polarization filter, so as to radiate energy of 200 mJ/cm², thereby providing a photo alignment layer. At this time, the film was irradiated twice through a photomask with ultraviolet rays having polarization directions different from each other by 90°, which were in the form of a stripe adjacent to each other.

The birefringence material (1) in the state heated to 55° C. was coated on the glass substrate having the photo alignment layer obtained above, by a spin coating method, and then cooled to room temperature. Thereafter, the coated film was irradiated with an ultraviolet ray at an intensity of 40 mW/cm² for 25 seconds with a high-pressure mercury lamp, so as to provide a pattern retarder having phase retardation functioning as a ¼ wavelength plate with stripe patterns having alignment directions different from each other by 90°. The pattern retarder had no defect and had good alignment property. The pattern retarder was laminated on the IPS type liquid crystal display device (1) described in Example 1, thereby providing a stereoscopic image display device.

The contrast of the stereoscopic image display device measured was 148. The yellowness index (YI) of the photo alignment layer formed on the glass substrate was 6.1. As a result, the stereoscopic image display device had larger contrast, less amounts of defect, alignment disorder, and light leakage, and particularly less alignment disorder in the boundary region between the patterns having alignment directions different from each other, than the stereoscopic image display devices of Comparative Examples 3 and 4, and thus was a high definition liquid crystal display device.

### Example 7

### Stereoscopic Image Display Device Having Pattern Retarder

An IPS type stereoscopic image display device was produced in the same manner as in Example 6 using the IPS type liquid crystal display device (1) as similar to Example 6, except that the photoresponsive alignment material solution 2 was used in the production of the pattern retarder instead of the photoresponsive alignment material solution 1. The thickness of the alignment layer on the glass substrate used in the pattern retarder was 290 nm.

The contrast of the stereoscopic image display device measured was 123. The yellowness index (YI) of the photo alignment layer formed on the glass substrate of the pattern retarder was 2×10⁻³. As a result, the stereoscopic image display device had larger contrast, less amounts of defect, alignment disorder, and light leakage, and particularly less alignment disorder in the boundary region between the patterns having alignment directions different from each other, than the stereoscopic image display devices of Comparative Examples 3 and 4, and thus was a high definition liquid crystal display device.

### Comparative Example 3

### Stereoscopic Image Display Device Having Pattern Retarder

An IPS type stereoscopic image display device was produced in the same manner as in Example 6 using the IPS type liquid crystal display device (1) as similar to Example 6, except that the photoresponsive alignment material solution 3 was used in the production of the pattern retarder instead of the photoresponsive alignment material solution 1. The contrast of the image display device measured was 79. The yellowness index (YI) of the alignment layer formed on the glass substrate of the pattern retarder was 6.7×10⁻⁴.

### Comparative Example 4

### Stereoscopic Image Display Device Having Pattern Retarder

An IPS type stereoscopic image display device was produced in the same manner as in Example 6 using the IPS type liquid crystal display device (1) as similar to Example 6, except that the photoresponsive alignment material solution 4 was used in the production of the pattern retarder instead of the photoresponsive alignment material solution 1. The contrast of the image display device measured was 68. The yellowness index (YI) of the alignment layer formed on the glass substrate of the pattern retarder was 4×10⁻⁵.

### Example 8

### Stereoscopic Image Display Device Having Pattern Retarder

An IPS type stereoscopic image display device was produced in the same manner as in Example 6 using the IPS type liquid crystal display device (1) as similar to Example 6, except that the photoresponsive alignment material solution 5 was used in the production of the pattern retarder instead of the photoresponsive alignment material solution 1. The thickness of the alignment layer on the glass substrate used in the pattern retarder was 290 nm.

The contrast of the stereoscopic image display device measured was 140. The yellowness index (YI) of the photo alignment layer formed on the glass substrate of the pattern retarder was 5×10⁻³.

As a result, the stereoscopic image display device had larger contrast, less amounts of defect, alignment disorder, and light leakage, and particularly less alignment disorder in the boundary region between the patterns having alignment directions different from each other, than the stereoscopic image display devices of Comparative Examples 3 and 4, and thus was a high definition liquid crystal display device.

### Example 9

### Stereoscopic Image Display Device Having Pattern Retarder

An IPS type stereoscopic image display device was produced in the same manner as in Example 6 using the IPS type liquid crystal display device (1) as similar to Example 6, except that the photoresponsive alignment material solution 6 was used in the production of the pattern retarder instead of the photoresponsive alignment material solution 1, and after the formation of the coated film with a spin coater, the coated film was subjected to a heat treatment at 80° C. for 5 minutes and at 250° C. for 1 hour, and for the irradiation condition of ultraviolet light on the coated film, the coated film was irradiated with a polarized ultraviolet ray having a wavelength of 254 nm to 2,000 mJ/cm². The thickness of the alignment layer on the glass substrate used in the pattern retarder was 160 nm.

The contrast of the stereoscopic image display device measured was 145. The yellowness index (YI) of the photo alignment layer formed on the glass substrate of the pattern retarder was 4.3.

As a result, the stereoscopic image display device had larger contrast, less amounts of defect, alignment disorder, and light leakage, and particularly less alignment disorder in the boundary region between the patterns having alignment directions different from each other, than the stereoscopic image display devices of Comparative Examples 3 and 4, and thus was a high definition liquid crystal display device.

### Example 10

### Stereoscopic Image Display Device Having Pattern Retarder

An IPS type stereoscopic image display device was produced in the same manner as in Example 1 using the IPS type liquid crystal display device (1) as similar to Example 6, except that the photoresponsive alignment material solution 7 was used in the production of the pattern retarder instead of the photoresponsive alignment material solution 1. The thickness of the alignment layer on the glass substrate used in the pattern retarder was 90 nm. The contrast of the stereoscopic image display device measured was 147.

The yellowness index (YI) of the photo alignment layer formed on the glass substrate of the pattern retarder was 6.9. As a result, the stereoscopic image display device had larger contrast, less amounts of defect, alignment disorder, and light leakage, and particularly less alignment disorder in the boundary region between the patterns having alignment directions different from each other, than the stereoscopic image display devices of Comparative Examples 3 and 4, and thus was a high definition liquid crystal display device.

No change of the contrast was found before and after the curing of the sealant with an ultraviolet ray and heat in the production process of the device, and thus the deterioration due to light was suppressed and prevented.

### Example 11

### Liquid Crystal Display Device Having Retardation Film

The photoresponsive alignment material solution 1 was coated on a TAC (triacetyl cellulose) substrate having a thickness of 80 μm by a spin coating method, and dried at 80° C. for 5 minutes to form a coated film having a thickness of 90 nm on the substrate. The visual observation of the coated film thus formed confirmed that a flat film was formed. The film thus formed was irradiated with linear polarized light (luminance: 20 mW/cm²) of ultraviolet light (wavelength: 365 nm) in the vertical direction for 10 seconds with a polarized light irradiation device equipped with a super-high-pressure mercury lamp, a wavelength cut filter, a band pass filter, and a polarization filter, so as to radiate energy of 200 mJ/cm², thereby providing a photo alignment layer.

The birefringence material (1) in the state heated to 55° C. was coated on the TAC substrate having the photo alignment layer obtained above, by a spin coating method, and then cooled to room temperature. Thereafter, the coated film was irradiated with an ultraviolet ray at an intensity of 40 mW/cm² for 25 seconds with a high-pressure mercury lamp, so as to provide a retardation film. The retardation film had no defect and had good alignment property. The retardation film was laminated on the IPS type liquid crystal display device (1) described in Example 1, thereby providing a liquid crystal display device.

The contrast of the liquid crystal display device measured was 152. The yellowness index (YI) of the alignment layer formed on the TAC substrate was 6.1. As a result, the liquid crystal display device had larger contrast and less amounts of defect, alignment disorder, and light leakage than the stereoscopic image display device of Comparative Example 5, and thus was a high definition liquid crystal display device.

The liquid crystal display device was irradiated with a non-polarized ultraviolet ray at an intensity of 40 mW/cm² for 125 seconds with a high-pressure mercury lamp. The contrast of the liquid crystal display device after the irradiation was 146. The drastic decrease of the contrast as in Comparative Example 5 was not found.

### Comparative Example 5

### Liquid Crystal Display Device Having Retardation Film

An IPS type liquid crystal display device was produced in the same manner as in Example 11, except that the photoresponsive alignment material solution 3 was used instead of the photoresponsive alignment material solution 1.

The yellowness index (YI) of the alignment layer formed on the TAC substrate of the retardation film was 6.7×10⁻⁴. The contrast of the display device measured was 81.

The liquid crystal display device was irradiated with a non-polarized ultraviolet ray at an intensity of 40 mW/cm² for 125 seconds with a high-pressure mercury lamp. The contrast of the liquid crystal display device after the irradiation was drastically decreased to 38.

### Example 12

### Liquid Crystal Display Device Having Retardation Film

An IPS type liquid crystal display device was produced in the same manner as in Example 11, except that the photoresponsive alignment material solution 7 was used instead of the photoresponsive alignment material solution 1. The contrast of the liquid crystal display device measured was 149.

The yellowness index (YI) of the photo alignment layer formed on the TAC substrate of the retardation film was 6.9.

The liquid crystal display device was irradiated with a non-polarized ultraviolet ray at an intensity of 40 mW/cm² for 125 seconds with a high-pressure mercury lamp. The contrast of the liquid crystal display device after the irradiation was 145. The drastic decrease of the contrast as in Comparative Example 5 was not found.

As a result, the stereoscopic image display device had larger contrast and less amounts of defect, alignment disorder, and light leakage than the stereoscopic image display device of the comparative example, and thus was a high definition liquid crystal display device. No change of the contrast was found before and after the curing of the sealant with an ultraviolet ray and heat in the production process of the device, only a slight change of the contrast occurred by the intentional irradiation of the device with an ultraviolet ray, and thus the deterioration due to light was suppressed and prevented.

### Example 13

### Liquid Crystal Display Device

A transparent electrode was formed on a first glass substrate, and a black matrix (BM) was formed on a second glass substrate, and then a red colored composition was coated as a color filter to a thickness of 2 μm by spin coating. After drying at 70° C. for 20 minutes, the coated film was subjected to pattern exposure in a stripe form with an ultraviolet ray through a photomask with an exposure device equipped with a super-high-pressure mercury lamp. The coated film was subjected to spray development with an alkali developer solution for 90 seconds, rinsed with ion exchanged water, and air-dried. The coated film was subjected to post-baking in a clean oven at 230° C. for 30 minutes, so as to form red pixels as the colored layer in a stripe form on the transparent substrate. Similarly, a green colored composition was coated to a thickness of 2 μm by spin coating, dried, and exposed with an exposure device and developed at positions deviated from the red pixels to form a colored layer in a stripe form as green pixels adjacent to the red pixels. Furthermore, a blue colored composition was coated to a thickness of 2 μm by spin coating to form blue pixels adjacent to the red pixels and the green pixels. Consequently, a color filter having the pixels in a stripe form for three colors, red, green, and blue, on the transparent substrate was obtained.

Subsequently, the photoresponsive alignment material solution 1 was filtered with a 0.2 micron membrane filter, then coated on both the substrates with a spin coater at a rotation number of 1,800 rpm, and dried at 100° C. for 3 minutes, so as to form a coated film having a thickness of 90 nm on the substrate. The visual observation of the coated film thus formed confirmed that a flat film was formed. The film thus formed was irradiated with linear polarized light (luminance: 20 mW/cm²) of ultraviolet light (wavelength: 365 nm) in the vertical direction for 10 seconds with a polarized light irradiation device equipped with a super-high-pressure mercury lamp, a wavelength cut filter, a band pass filter, and a polarization filter, so as to radiate energy of 200 mJ/cm², thereby providing a photo alignment layer.

A sealant was filled in a dispenser syringe, and after subjecting to a defoaming treatment, the sealant was coated with the dispenser on the first substrate on the side of the alignment layer to draw a rectangular frame. In the state where the sealant was not cure, microdroplets of the following liquid crystal composition 1 were coated dropwise over the entire surface within the frame on the first substrate, and immediately thereafter the second substrate was adhered thereto under vacuum of 5 Pa with a vacuum adhering device. The drawing condition and the gap between the substrates were adjusted in such a manner that after releasing the vacuum, the line width of the collapsed sealant was approximately 1.2 mm, in which 0.3 mm overlapped the BM. Immediately thereafter, the sealant was heat-cured by a heat treatment at 120° C. for 1 hour, thereby producing an IPS type liquid crystal display device (d_{gap}=4.0 μm). The composition and the property values of the liquid crystal composition 1 are shown below.

### Liquid Crystal Composition 1

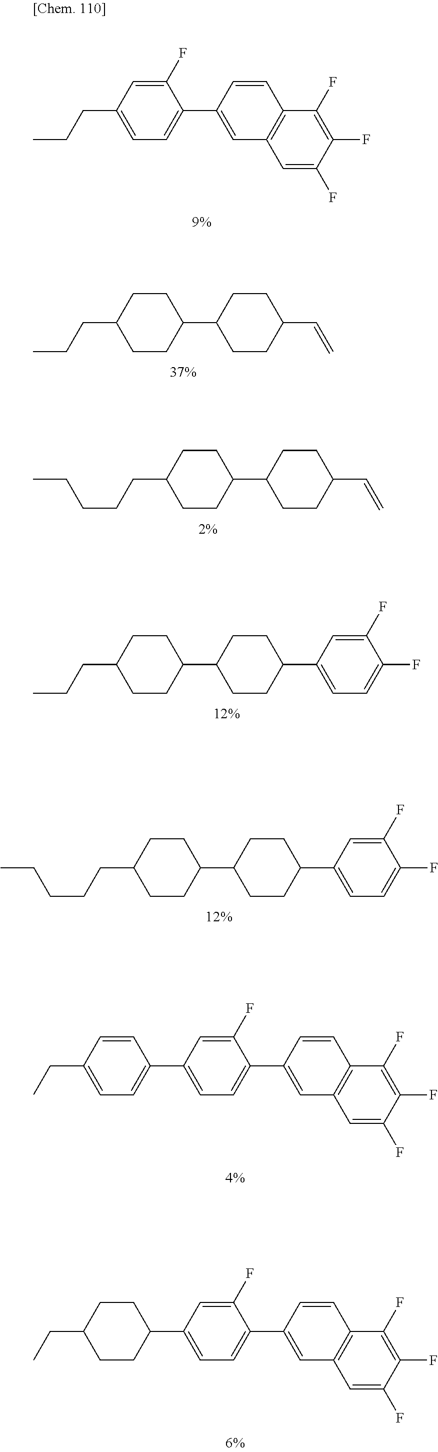

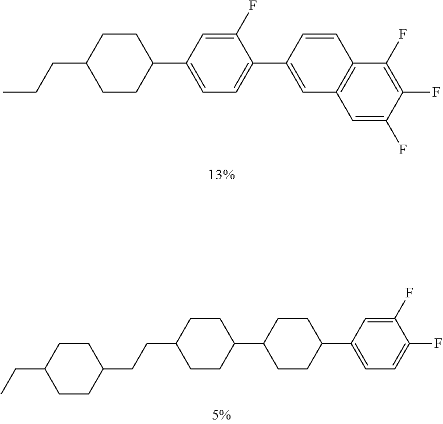 [SMILES: CCCC1CCC(c2ccc(-c3ccc4c(F)c(F)c(F)cc4c3)c(F)c2)CC1 ; CCC1CCC(CCC2CCC(C3CCC(c4ccc(F)c(F)c4)CC3)CC2)CC1]

The liquid crystal composition (1) had a nematic-isotropic liquid phase transfer temperature of 85.6° C., ne (extraordinary light refractive index at a wavelength of 589 nm) of 1.596, no (extraordinary refractive index at a wavelength of 589 nm) of 1.491, a dielectric anisotropy of +7.0, K₂₂ of 7.4 pN.

The contrast of the liquid crystal display device measured was 156. The yellowness index (YI) of the alignment layer formed on the glass substrate having the transparent electrode of the liquid crystal display device was 6.1. As a result, the liquid crystal display device had larger contrast, less amounts of defect, alignment disorder, and light leakage, and less alignment disorder at the edge of the seal, than the stereoscopic image display devices of the comparative examples, and thus was a high definition liquid crystal display device.

### Comparative Example 6

### Liquid Crystal Display Device

An IPS type liquid crystal display device was produced in the same manner as in Example 13, except that the photoresponsive alignment material solution 3 was used instead of the photoresponsive alignment material solution 1.

The yellowness index (YI) of the alignment layer formed on the glass substrate having the transparent electrode of the liquid crystal display device was 6.7×10⁻¹. The contrast of the display device measured was 87.

### Example 14

### Liquid Crystal Display Device

An IPS type liquid crystal display device was produced in the same manner as in Example 13, except that the photoresponsive alignment material solution 2 was used instead of the photoresponsive alignment material solution 1. The thickness of the alignment film was 290 nm. The contrast of the display device measured was 131.

The yellowness index (YI) of the alignment layer formed on the glass substrate having the transparent electrode of the liquid crystal display device was 2×10⁻³.

As a result, the liquid crystal display device had larger contrast, less amounts of defect, alignment disorder, and light leakage, and less alignment disorder at the edge of the seal, than the stereoscopic image display devices of the comparative examples, and thus was a high definition liquid crystal display device.

### Comparative Example 7

### Liquid Crystal Display Device

An IPS type liquid crystal display device was produced in the same manner as in Example 13, except that the photoresponsive alignment material solution 4 was used instead of the photoresponsive alignment material solution 1. The contrast of the display device measured was 76. The yellowness index (YI) of the photo alignment layer formed on the glass substrate having the transparent electrode of the liquid crystal display device was 4×10⁻⁵.

### Example 15

### Liquid Crystal Display Device

An IPS type liquid crystal display device was produced in the same manner as in Example 13, except that the photoresponsive alignment material solution 5 was used instead of the photoresponsive alignment material solution 1. The thickness of the alignment film was 290 nm.

The contrast of the display device measured was 148.

The yellowness index (YI) of the photo alignment layer formed on the glass substrate having the transparent electrode of the liquid crystal display device was 5×10⁻³. As a result, the liquid crystal display device had larger contrast, less amounts of defect, alignment disorder, and light leakage, and less alignment disorder at the edge of the seal, than the stereoscopic image display devices of the comparative examples, and thus was a high definition liquid crystal display device.

### Example 16

### Liquid Crystal Display Device

An IPS type liquid crystal display device was produced in the same manner as in Example 13, except that the photoresponsive alignment material solution 6 was used instead of the photoresponsive alignment material solution 1, and after the formation of the coated film with a spin coater, the coated film was subjected to a heat treatment at 80° C. for 5 minutes and at 250° C. for 1 hour, and for the irradiation condition of ultraviolet light on the coated film, the coated film was irradiated with a polarized ultraviolet ray having a wavelength of 254 nm to 2,000 mJ/cm². The thickness of the alignment layer was 160 nm.

The contrast of the display device measured was 153.

The yellowness index (YI) of the photo alignment layer formed on the glass substrate having the transparent electrode of the liquid crystal display device was 4.3. As a result, the liquid crystal display device had larger contrast, less amounts of defect, alignment disorder, and light leakage, and less alignment disorder at the edge of the seal, than the stereoscopic image display devices of the comparative examples, and thus was a high definition liquid crystal display device.

### Example 17

### Liquid Crystal Display Device

An IPS type liquid crystal display device was produced in the same manner as in Example 13, except that the photoresponsive alignment material solution 7 was used instead of the photoresponsive alignment material solution 1. The thickness of the alignment film was 90 nm. The contrast of the display device measured was 155.

The yellowness index (YI) of the photo alignment layer formed on the glass substrate having the transparent electrode of the liquid crystal display device was 7.1. As a result, the liquid crystal display device had larger contrast, less amounts of defect, alignment disorder, and light leakage, and less alignment disorder at the edge of the seal, than the stereoscopic image display devices of the comparative examples, and thus was a high definition liquid crystal display device. No change of the contrast was found before and after the curing of the sealant with an ultraviolet ray and heat in the production process of the device, and thus the deterioration due to light was suppressed and prevented.

1. An image display device comprising an image display part containing a liquid crystal layer containing a liquid crystal compound which regulates a phase or a velocity of transmitted light, and a photo alignment layer which is in contact with the liquid crystal layer and regulates alignment of liquid crystal molecules contained in the liquid crystal compound,
the photo alignment layer having a yellowness index (YI) of 0.001<YI<100.

2. The image display device according to claim 1, wherein the liquid crystal layer containing a liquid crystal compound is at least one selected from the group consisting of a liquid crystal mediumn capable of being controlled in alignment with an external field, an optical anisotropy molecule obtained by curing a polymerizable liquid crystal compound, and a polymer liquid crystal capable of undergoing phase transition.

3. The image display device according to claim 2, wherein the image display device has an optical laminated material which is light transmissive and is provided in the image display part,
the optical laminated material contains an optical anisotropy layer containing at least one of the optical anisotropy molecule which regulates a phase or a velocity of light passing through the optical laminated material, and the polymer liquid crystal, and
the photo alignment layer which aligns the optical anisotropy molecule and is in contact with the optical anisotropy layer, and
the optical anisotropy layer and the alignment layer each have a yellowness index (YI) of 0.001<YI<100.

4. The image display device according to claim 3, wherein the optical laminated material further has a polarizing plate.

5. The image display device according to claim 4, wherein the optical laminated material is disposed between the polarizing plate and the image display part.

6. The image display device according to claim 4, wherein the polarizing plate is provided on the side of the image display part with respect to the optical laminated material.

7. The image display device according to claim 2, wherein the image display device has the image display part that contains a first substrate having a first photo alignment layer formed on a surface thereof,
a second substrate having a second photo alignment layer formed on a surface thereof, disposed to face the first alignment layer with a space from the first photo alignment layer,
a liquid crystal layer containing a liquid crystal medium capable of being controlled in alignment with an external field, filled between the first substrate and the second substrate in such a manner that the liquid crystal layer is in contact with the first photo alignment layer and the second photo alignment layer, and
an electrode layer containing an active device and a pixel electrode, between the first photo alignment layer and the first substrate, in which
the first photo alignment layer or the second photo alignment layer has a yellowness index (YI) of 0.001<YI<100.

8. The image display device according to claim 7, wherein the image display device further contains a color filter between the pixel electrode and the first substrate or between the second photo alignment layer and the second substrate.

9. The image display device according to claim 7, wherein the photo alignment layer has an average thickness of from 0.01 to 1 μm.

10. The image display device according to claim 7, wherein the image display device contains an active device, a pixel electrode, and a common electrode between the first photo alignment layer and the first substrate, and the liquid crystal layer undergoes homogeneous alignment.

11. The image display device according to claim 7, wherein the image display device further contains a common electrode between the second substrate and the second photo alignment layer.

12. The image display device according to claim 7, wherein the pixel electrode is in the form of a comb, and a common electrode, an insulating layer, and the pixel electrode are laminated in this order on the first substrate.

13. The image display device according to claim 7, wherein the pixel electrode is in the form of a comb, and the pixel electrode, an insulating layer, and a common electrode are laminated in this order on the first substrate.

14. The image display device according to claim 8, wherein in the case where the color filter is disposed between the pixel electrode and the first substrate, the second alignment layer has a yellowness index (YI) of 0.001<YI<100.

15. The image display device according to claim 8, wherein in the case where the color filter is disposed between the second photo alignment layer and the second substrate, the first alignment layer has a yellowness index (YI) of 0.001<YI<100.

16. A photoresponsive liquid crystal alignment agent comprising a solvent component and a photo alignment component undergoing alignment in a direction substantially perpendicular or in parallel to the polarization axis through isomerization in response to light, and having a yellowness index (YIS) of 0.001<YIS<500.

17. The photoresponsive liquid crystal alignment agent according to claim 16, wherein the photoresponsive liquid crystal alignment agent contains the photo alignment component in an amount of from 0.1 to 10.0% by mass.
